(19) United States
(12) Patent Application Publication
(10) Pub. No.: US 2026/0039630 A1
(43) Pub. Date: Feb. 5, 2026

(54) ZERO TRUST PACKET ROUTING AGGREGATION AND LOG INGESTION

(71) Applicant: Oracle International Corporation, Redwood Shores, CA (US)

(72) Inventors: Madhav Ashok Kelkar, Leander, TX (US); Dmitry Erastov, New York, NY (US); Thomas James Andrews, Seattle, WA (US); Girish Nagaraja, Sammamish, WA (US); Martinus Petrus Lambertus van den Dungen, Snohomish, WA (US); Norka Beatriz Lucena Mogollon, Kirkland, WA (US); Ritesh Kumari, Brampton (CA); Mark Garrick Thurston, Austin, TX (US)

(73) Assignee: Oracle International Corporation, Redwood Shores, CA (US)

(21) Appl. No.: 19/285,381

(22) Filed: Jul. 30, 2025

Related U.S. Application Data
(60) Provisional application No. 63/677,800, filed on Jul. 31, 2024.
(60) Provisional application No. 63/677,963, filed on Jul. 31, 2024.
(60) Provisional application No. 63/691,217, filed on Sep. 5, 2024.

(51) Int. Cl. H04L 9/40; H04L 43/045; H04L 43/062

(52) U.S. Cl. CPC H04L 63/0254; H04L 43/045; H04L 43/062; H04L 63/20

(57) ABSTRACT

Techniques are described for visualizing enforcement of ZPR policy. A method includes aggregating log data associated with a flow of traffic within one or more networks; accessing rules associated with a policy that specifies how the flow of traffic is enforced between enforcement points within the one or more networks, wherein the policy includes one or more layer 4 rules and one or more layer 7 rules; determining, based on the rules associated with the policy, an enforcement of flow of traffic; generating a visualization of the enforcement of the flow of traffic between different enforcement points; and presenting the visualization for display within a user interface.

### CROSS REFERENCES TO RELATED APPLICATIONS

This application claims priority to U.S. Provisional Patent Application No. 63/677,800 entitled “Zero Trust Packet Routing Log Ingestions,” filed on Jul. 31, 2024, and U.S. Provisional Patent Application No. 63/691,217 entitled “Zero Trust Packet Routing Aggregation Service,” filed on Sep. 5, 2024, and U.S. Provisional Patent Application No. 63/677,963 entitled “Zero Trust Packet Routing Visualization,” filed on Jul. 31, 2024 the entire disclosures of which are hereby incorporated by reference for all purposes.

### BACKGROUND

Cloud computing environments are large and complex systems that include many different components and related products/services. Protecting data that travels to/from these cloud computing environments, as well as data that travels within a cloud computing environment can be challenging. Today, skilled network administrators/create a lot of rules and different policies in an attempt to protect their data and networks. Even with all of the different rules and policies, one simple misconfiguration of a network rule/policy can expose the sensitive data of a company to the public. Causing further challenges, is that rules and polices are designed and created for enforcing rules/polices at each of the different layers of a network stack. Still further, after creating and deploying the rules, a significant amount of time and money may be used to keep these rules up to date based on changing networks/requirements.

### BRIEF SUMMARY

The present disclosure relates generally to log ingestion, aggregation, and visualizations relating to zero trust packet routing. More particularly, a zero trust access (ZTA) service includes one or more services that allow visualization of the enforcement of one or more zero trust packet routing (ZPR) policies. According to some examples, the ZTA service includes an aggregation service and a visualization service. Generally, the visualization service uses ingested log data that is aggregated by the aggregation service to be visualized to who the policy impact of one or more ZPR policies. The ingested log data may include log data represents a flow of network traffic between different enforcement points (EPS) that can apply one or more rules associated with one or more ZPR policies. In some examples, the log data includes flow logs that represent network traffic at L4 enforcement points, and event logs that represent network traffic at L7 enforcement points. Various embodiments are described herein to illustrate various features. These embodiments include various methods, systems, non-transitory computer-readable storage media storing programs, code, or instructions executable by one or more processors, and the like.

At least one embodiment is directed to a computer-implemented method for a zero-trust packet routing policy architecture to perform zero trust packet routing operations in one or more networks, the method comprising: aggregating log data associated with a flow of traffic within one or more networks; accessing rules associated with a policy that specifies how the flow of traffic is enforced between enforcement points within the one or more networks, wherein the policy includes one or more layer 4 rules and one or more layer 7 rules; determining, based on the rules associated with the policy, an enforcement of flow of traffic; generating a visualization of an enforcement of the flow of traffic between different enforcement points; and presenting the visualization for display within a user interface.

Another embodiment is directed to a computing device comprising one or more processors and instructions that, when executed by the one or more processors, cause the computing device to perform any suitable combination of the method(s) disclosed herein. Still another embodiment is directed to a non-transitory computer-readable medium storing computer-executable instructions that, when executed by one or more processors of a computing cluster, cause the computing cluster to perform any suitable combination of the method(s) disclosed herein.

The foregoing, together with other features and embodiments will become more apparent upon referring to the following specification, claims, and accompanying drawings.

### BRIEF DESCRIPTION OF THE DRAWINGS

To easily identify the discussion of any particular element or act, the most significant digit or digits in a reference number refer to the figure number in which that element is first introduced.

FIG. 1 is a high-level diagram of a distributed environment showing a virtual or overlay cloud network hosted by a cloud service provider infrastructure according to certain embodiments.

FIG. 2 depicts a simplified architectural diagram of the physical components in the physical network within cloud services provider infrastructure (CSPI) according to certain embodiments.

FIG. 3 shows an example arrangement within CSPI where a host machine is connected to multiple network virtualization devices (NVDs) according to certain embodiments.

FIG. 4 depicts connectivity between a host machine and an NVD for providing I/O virtualization for supporting multitenancy according to certain embodiments.

FIG. 5 depicts a simplified block diagram of a physical network provided by a CSPI according to certain embodiments.

FIG. 6 is a simplified block diagram of an environment illustrating using enforcement points to enforce network policies/rules in one or more networks, according to certain embodiments.

FIG. 7 is a simplified block diagram of an environment illustrating a zero-trust access (ZTA) service interacting with control plane(s) and data plane(s), according to certain embodiments.

FIG. 8 is a simplified block diagram of an environment illustrating a ZPR platform that includes an aggregation service for ingesting and aggregating log data from different sources and a visualization service for providing visualizations of the aggregated data, according to certain embodiments.

FIG. 9 is a simplified block diagram of an environment illustrating an aggregation service that aggregates log data received from different sources, according to certain embodiments.

FIG. 10A is a simplified diagram of a graphical user interface for visualizing enforcement of ZPR policy by a visualization service, according to certain embodiments.

FIG. 10B is a simplified diagram of a graphical user interface for visualizing enforcement of ZPR policy by a visualization service, according to certain embodiments.

FIG. 11 illustrates an example method for ingesting and aggregating log data from different sources, according to aspects.

FIG. 12 illustrates an example method for visualizing ZPR enforcement, according to aspects.

FIG. 13 illustrates a zero-trust network, according to certain embodiments.

FIG. 14 is a simplified block diagram of an environment illustrating two enforcement points enforcing rules associated with a ZPR policy, according to certain embodiments.

FIG. 15 is a simplified block diagram of an environment illustrating accessing a cloud-based service from a virtual network (e.g., a tenancy) using ZPR policy, according to certain embodiments.

FIG. 16 is a simplified block diagram of an environment illustrating protecting data using ZPR, according to certain embodiments.

FIG. 17 is a simplified block diagram of an environment illustrating protecting data using ZPR, according to certain embodiments.

FIG. 18 is a simplified block diagram of an environment including an enforcement point to enforce network policies/rules in one or more networks, according to certain embodiments.

FIG. 19 is a simplified diagram of a syntax for defining ZPR polices using ZPL, according to certain embodiments.

FIG. 20 is a simplified diagram of a syntax for defining ZPR polices using ZPL, according to certain embodiments.

FIG. 21 is a is a simplified diagram that illustrates different components that can be included in a policy statement using ZPL, according to certain embodiments.

FIG. 22 illustrates an example method for preparing resources for enforcement of ZPR policy, according to aspects.

FIG. 23 illustrates an example method for using ZPL for zero trust packet routing, according to aspects.

FIG. 24 illustrates an example method for performing ZPR at a sending EP, according to aspects.

FIG. 25 illustrates an example method for performing ZPR at a receiving EP, according to aspects.

FIG. 26 illustrates an example method for evaluating ZPL policy statements and other policy statements, according to aspects.

FIG. 27 is a block diagram illustrating an example pattern of an IaaS architecture, according to at least one embodiment.

FIG. 28 is a block diagram illustrating another example pattern of an IaaS architecture, according to at least one embodiment.

FIG. 29 is a block diagram illustrating another example pattern of an IaaS architecture, according to at least one embodiment.

FIG. 30 is a block diagram illustrating another example pattern of an IaaS architecture, according to at least one embodiment.

FIG. 31 is a block diagram illustrating an example computer system, according to at least one embodiment.

### DETAILED DESCRIPTION

Described herein are techniques related to log ingestion, aggregation, and visualizations relating to zero trust packet routing. A Zero Trust Packet Routing (ZPR) architecture protects sensitive data from exfiltration by enabling customers to write intent-based, security policies that humans can read, audit, and understand. The ZPR platform translates intent and distributes policy throughout the network and enforces it at different enforcement points. The ZPR architecture includes a zero trust access (ZTA) service that includes different services focused on ZPR functionality.

In some configurations, the ZTA service includes one or more services that allow visualization of the enforcement of one or more ZPR policies. According to some examples, the ZTA service includes an aggregation service and a visualization service. Generally, the visualization service uses ingested log data that is aggregated by the aggregation service to be visualized to who the policy impact of one or more ZPR policies. The ingested log data may include log data represents a flow of network traffic between different enforcement points (EPs) that can apply one or more rules associated with one or more ZPR policies. In some examples, the log data includes flow logs that represent network traffic at L4 enforcement points, and event logs that represent network traffic at L7 enforcement points.

The ZPR visualization service uses log data aggregated by the aggregation service. A customer can use the visualization service to not only see a visualization of how ZPR policies would be enforced within a network using an audit mode, but a customer can also see how the ZPR policies are actually being enforced in an enforcement mode. According to some configuration, the visualization service generates a graphical user interface (GUI) that when displayed shows the impact of the enforcement of one or more ZPR policies. For example, the aggregated data can show where a communication of data is allowed by the policy and show where another communication is not allowed by the policy.

When a customer creates or updates ZPR policies in an existing infrastructure, those changes can make a big impact. To avoid disrupting existing infra, a customer can use an “audit mode” that allows the flow of traffic to continue regardless of whether the ZPR policy is violated or not violated. While in audit mode, the visualization service may provide an indication/alert of the violation of ZPR policy. The customer can also use an enforce mode that enforces the ZPR policies, which may block the movement of data while in the audit mode. As an example, the user may specify to use the audit mode to determine how the flow of data within the one or more networks would be affected. In this way, a user may create/update one or more ZPR policies without having to worry about the impact of enforcing the one or more ZPR policies. Instead, the user can use the visualization service to understand the impact of ZPR policies.

In some configurations, the visualizer can provide a policy and tags view and a recent activity view. The policy and tags view displays ZPR policies and associated tags that are derived from ZPR policy and tag configuration. The recent activity view presents an aggregated view of recent activities. To show the recent activity view, data is ingested from the different enforcement points using a log ingestion engine and then aggregated by the aggregation service and displayed using the visualization service so that a customer can understand how the flow of traffic in the context of ZPR policies.

The techniques described herein provide many advantages over current techniques. For examples, the visualization service can provide a comprehensive view of tags and ZPR policies configured within the system as well as display enforcement information related to the flow of traffic in one or more networks that are protected by ZPR policies. The techniques described herein allow customers to comprehend policy statements visually and data flows swiftly, facilitating the identification of risks and understanding the implications of toggling tags to enforcement mode. The visualization service allows customers to observe actual communications based on tag and policy configuration for a specific period. It can provide insights in how actual communication is happening in real-time or near real-time.

Instead of being restricted to perimeter-based security and defining and creating rules that are difficult to maintain, techniques described herein allow users to create data-centric, intent-based policies using a zero-trust packet routing (ZPR) policy language (ZPL) statements that are enforced using a ZPR architecture at different enforcement points within one or more networks. According to some configurations, ZPL is used to define the policy statements that specifies who/what (e.g., users, computing resources) can access data and where that data is allowed to travel throughout one or more networks,

As will be described in more detail below, users are able to define ZPR policies via high level network ZPL statements that define how network traffic can flow within one or more networks. Using techniques described herein, a zero-trust packet routing (ZPR) architecture enforces the defined ZPR policy including between nodes and pods of containerized environments. In some configurations, ZPL statements can be enforced for traffic that flows within a K8s node and/or for traffic that flows between different K8s nodes.

Generally, the ZPR design includes: users can add ZPR Tags to VNICs with unique identifiers; users can specify ZPR Policies (using ZPR Policy Language) to specify what entities can talk to each other (e.g., by using ZPR Tags); and one or more enforcement points (e.g., SmartNICs and/or some other component/device) ensure that the traffic that flows from/to/within a node follows the ZPR Policy.

In this solution, data is obtained from the different enforcement points (EPs) (e.g., IDDP, networking, OKE, . . . ) that are performing ZPR policy evaluations. The data obtained from the different EPs can include additional fields that relate to the ZPR evaluations. For example, some of the fields include ZprEvaluatedTenancies, ZprAuditDebugContext, ZprEnforceDebugContext, ZprAuditPermissionGrantedBy, ZprAuditPermissionDeniedBy, ZprEnforceAuthorizedPermissions, ZprAuditAuthorizedPermissions, ZprRequestedPermissions, and a timestamp field used for ordering the ZPR evaluations. In some examples, the aggregation service aggregates ZPR event logs that include Flow Logs (from L4 evaluation) and Auth Event Logs (from L7 evaluation) from networking and OKE sources and authentication event logs that represent authentication requests at L7 enforcement points that are emitted by IDDP and local auth clients.

Log records can also be obtained from ZPR policy evaluations that are written to object storage with metadata information relating to the ZPR policy evaluations. The logs include many different fields that are added to the logs that relate to ZPR evaluations. For example, some of the fields include ZprEvaluatedTenancies, ZprAuditDebugContext, ZprEnforceDebugContext. ZprAuditPermissionGrantedBy, ZprAuditPermissionDeniedBy,
ZprEnforceAuthorizedPermissions, ZprAuditAuthorizedPermissions, ZprRequestedPermissions, and a timestamp field used for ordering the ZPR evaluations. Logs are not duplicated for ZPR customers. Instead, the ZPR logs are separated based on the ZPR fields in the logs.

In some examples, the ZPR architecture uses a zero-trust software-defined network that operates on top of an existing cloud infrastructure, enabling secure and policy-driven communication between clients, services, and other resources. The ZPR architecture implements zero-trust principles, directed at ensuring that network interactions are authenticated, authorized, and encrypted to enhance security and access control. In some examples, the networks can span multiple environments, including public clouds, private data centers, and on-premises locations, providing a flexible and secure network foundation for various applications and services.

In contrast to prior techniques for protecting networks, the ZPR architecture, and the use of ZPL, includes protections that are designed to not be violated due to new network equipment being added, data sources being misconfigured, or new policy being written. ZPL policy statements are focused on allowing/denying resources (users, compute instances, . . . ) to other resources. As an example, policy statements can be as simple as “Allow ‘red’ hosts to read ‘blue’ data”, “Allow ‘biz-analysts’ users to use buckets in ‘Analysis’ compartments”, “Allow ‘Business-Analyst’ users on ‘HR-Apps’ hosts to read ‘HR-App-Data’ data over corp-internal network” allows Business-Analyst users on the HR-Apps hosts to read any resource with HR-App-Data tag.

According to some configurations, enforcement of a policy created using ZPL protects against infiltration to the internet (and even from untagged clients) at the network layer. In some examples, ZPL policy and it is evaluated first so it can't be overridden by are enforced before other IAM or networking policy so that the ZPL policy can't be overridden. ZPL also supports deny statements that assist in enabling delegation of duties. For example, a policy statement using ZPL may deny access which cannot be overridden by other ZPL, IAM, or other networking policy. Other network security techniques, such as Network Access Protection (NAP) and Identity and Access Management (IAM policy) are not able to do this today.

ZPL provides a syntax that is succinct and is easily readable as a sentence.

According to some configurations, the syntax focuses on having a<tag>before base names (e.g., subject, <hosts>, <network>, . . . ). For example, policy statements created using ZPL can follow the syntax “(allow | deny)<tag><subject>with <attribute>on<tag>hosts with <tag> to <verb><tag><resource-type>with <attribute>over <tag><network>with <tag>where <where clause>”. The (allow | deny) specifies whether to allow access or deny access to a resource. The <tag> is used to identify the data, the resources, and users. The <subject> is the principal making the call (e.g., users, dynamic-groups, resource-principal, . . . ). The hosts is a key word for the originating device of the call (e.g., a compute-instance or function). The <Verb> is a meta-verb allowed (e.g., send-receive). The <resource-type> is the resource being accessed (e.g., storage bucket, database). The <network> is a keyword to restrict the access over only certain gateways (e.g., service gateways (SGW), internet gateways (IGW), . . . ).

As will be discussed in more detail below, policy can be written using ZPL that controls data flows by the examination of the tags of users, hosts, targets (e.g., storage buckets, databases, . . . ), and/or the network. In some configurations, attributes can also be specified to further control data flows within one or more networks. For example, attributes of the data, source, hosts, users, targets, the network (e.g. require mTLS).

Generally, any resource can be tagged with one or more tags. For example, a user, a group of users, a computing resource, a group of computing resources, a storage device, a group of storage devices, data, and the like. In some configurations, the <attribute> are used with the <subject> and <resource-type> and are evaluated at L7. According to some examples, in addition to using tags to control access to data, ZPL can be used to control access to untagged data. In this way, even without tagging data (e.g., within a tenancy), that data can be protected against being accessed from outside of that tenancy.

Instead of a policy being evaluated at a single location, the ZPR architecture includes enforcement points (“EPs”) evaluate the policy at different locations along the route between the source and target associated with packets being transmitted. In some configurations, smartNICs and gateways are used as enforcement points. Other devices (physical and/or virtual) can also be used. According to some configurations, some EPs (e.g., smartNICs) are configured to perform L4 processing, and other EPs (e.g., gateways) are configured to perform L4 and/or L7 processing. In other configurations, the EPs can be configured to perform processing at other network layers (e.g., L1-L7).

In some examples, the enforcement points are located at/near the source (e.g., checks the hosts tags), at all/portion of the network hops (e.g., checks the network tags), and at the target, such as a service/application (e.g., full evaluation of all tags, attributes and context variables). Generally, when packets are transmitted, the enforcement points associated with the networking data plane evaluate the ingress or egress rules associated with the policy. In this way, packets are not transmitted from an enforcement point until the rules are evaluated by the enforcement point and the enforcement point determines that the transmission is authorized by the policy.

In some configurations, each EP within the network(s) is associated with an “Origin ID” that uniquely identifies the EP. One or more tags can also be associated with the EPs. According to some examples, a virtual cloud network (VCN) Control Plane (DSCP) assigns Origin IDs to each VNIC and Gateway in the network. The VNICs and Gateways tag packets with an Origin ID at the first hop to indicate the source of the packet. In some configurations, if a packet traverses a gateway along the path, the gateway tags the packet with the gateway tag to identify the classification of intermediate network hops. If packets are destined to a service, the Origin ID and the intermediate hop classification can be forwarded to the service to do perform final access validation.

According to some configurations, a ZTA service includes a rules engine and a distribution engine. The rules engine is configured to interpret the ZPL and generate rules for the different EPs to enforce. In some examples, the rules engine can also generate a mapping for each enforcement point that can be accessed by the enforcement engine to determine what rules to apply for different packets. According to some configurations, the distribution engine distributes the rules and/or mappings to each EP. The mappings are used by the EP to determine what rules to apply when a packet is received at the EP. At each network hop, the EPs perform the rules received from the distribution engine to ensure packets are only forwarded along allowed paths. Further, unlike existing network security policy, the ZPR architecture allows for specification of tenancy wide policy that can cross network and regional boundaries.

In some configurations, the syntax and references within a policy can be analyzed to detect errors even before a policy is tested/enforced. According to some examples, individual policy statements include an identifier so that information can be returned during debugging. The identifier can be shown in a user interface, such as a graphical user interface, and/or displayed with verbose error reporting. Further, according to some configurations, creating policy using ZPL includes robust debugging tools and visualizations. For example, a debug mode can be used to log verbose information about what policy statements (e.g., IAM, Networking, or ZPR) are failing a call, as well as other information about the statements. In some configurations, new policies and/or policy statements can be tested within a network environment using an alert mode before enforcing the policies.

### Example Virtual Networking Architecture

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed—to one or more cloud resources associated with the account.

As noted above, infrastructure as a service (IaaS) is one particular type of cloud computing service. In an IaaS model, the CSP provides infrastructure (referred to as cloud services provider infrastructure or CSPI) that can be used by customers to build their own customizable networks and deploy customer resources. The customer's resources and networks are thus hosted in a distributed environment by infrastructure provided by a CSP. This is different from traditional computing, where the customer's resources and networks are hosted by infrastructure provided by the customer.

The CSPI may comprise interconnected high-performance compute resources including various host machines, memory resources, and network resources that form a physical network, which is also referred to as a substrate network or an underlay network. The resources in CSPI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CSPI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)), Virtual Extensible LAN (VXLAN-IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

For IaaS, the infrastructure (CSPI) provided by a CSP can be configured to provide virtualized computing resources over a public network (e.g., the Internet). In an IaaS model, a cloud computing services provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance. CSPI provides infrastructure and a set of complementary cloud services that enable customers to build and run a wide range of applications and services in a highly available hosted distributed environment. CSPI offers high-performance compute resources and capabilities and storage capacity in a flexible virtual network that is securely accessible from various networked locations such as from a customer's on-premises network. When a customer subscribes to or registers for an IaaS service provided by a CSP, the tenancy created for that customer is a secure and isolated partition within the CSPI where the customer can create, organize, and administer their cloud resources.

Customers can build their own virtual networks using compute, memory, and networking resources provided by CSPI. One or more customer resources or workloads, such as compute instances, can be deployed on these virtual networks. For example, a customer can use resources provided by CSPI to build one or multiple customizable and private virtual network(s) referred to as virtual cloud networks (VCNs). A customer can deploy one or more customer resources, such as compute instances, on a customer VCN. Compute instances can take the form of virtual machines, bare metal instances, and the like. The CSPI thus provides infrastructure and a set of complementary cloud services that enable customers to build and run a wide range of applications and services in a highly available virtual hosted environment. The customer does not manage or control the underlying physical resources provided by CSPI but has control over operating systems, storage, and deployed applications; and possibly limited control of select networking components (e.g., firewalls).

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) serves a single customer or tenant. In a multi-tenancy architecture, a software or a hardware component serves multiple customers or tenants. Thus, in a multi-tenancy architecture, CSPI resources are shared between multiple customers or tenants. In a multi-tenancy situation, precautions are taken and safeguards put in place within CSPI to ensure that each tenant's data is isolated and remains invisible to other tenants.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CSPI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that is represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CSPI is physically hosted in one or more data centers in one or more regions around the world. The CSPI may include components in the physical or substrate network and virtualized components (e.g., virtual networks, compute instances, virtual machines, etc.) that are in a virtual network built on top of the physical network components. In certain embodiments, the CSPI is organized and hosted in realms, regions and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSPI resources are divided among regions such that each region has its own independent subset of CSPI resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., virtual cloud networks (VCNs), load balancing resources, connections to on-premise networks), database resources; edge networking resources (e.g., DNS); and access management and monitoring resources, and others. Each region generally has multiple paths connecting it to other regions in the realm.

Generally, an application is deployed in a region (i.e., deployed on infrastructure associated with that region) where it is most heavily used, because using nearby resources is faster than using distant resources. Applications can also be deployed in different regions for various reasons, such as redundancy to mitigate the risk of region-wide events such as large weather systems or earthquakes, to meet varying requirements for legal jurisdictions, tax domains, and other business or social criteria, and the like.

The data centers within a region can be further organized and subdivided into availability domains (ADs). An availability domain may correspond to one or more data centers located within a region. A region can be composed of one or more availability domains. In such a distributed environment, CSPI resources are either region-specific, such as a virtual cloud network (VCN), or availability domain-specific, such as a compute instance.

ADs within a region are isolated from each other, fault tolerant, and are configured such that they are very unlikely to fail simultaneously. This is achieved by the ADs not sharing critical infrastructure resources such as networking, physical cables, cable paths, cable entry points, etc., such that a failure at one AD within a region is unlikely to impact the availability of the other ADs within the same region. The ADs within the same region may be connected to each other by a low latency, high bandwidth network, which makes it possible to provide high-availability connectivity to other networks (e.g., the Internet, customers' on-premise networks, etc.) and to build replicated systems in multiple ADs for both high-availability and disaster recovery. Cloud services use multiple ADs to ensure high availability and to protect against resource failure. As the infrastructure provided by the IaaS provider grows, more regions and ADs may be added with additional capacity. Traffic between availability domains is usually encrypted.

In certain embodiments, regions are grouped into realms. A realm is a logical collection of regions. Realms are isolated from each other and do not share any data. Regions in the same realm may communicate with each other, but regions in different realms cannot. A customer's tenancy or account with the CSP exists in a single realm and can be spread across one or more regions that belong to that realm. Typically, when a customer subscribes to an IaaS service, a tenancy or account is created for that customer in the customer-specified region (referred to as the “home” region) within a realm. A customer can extend the customer's tenancy across one or more other regions within the realm. A customer cannot access regions that are not in the realm where the customer's tenancy exists.

An IaaS provider can provide multiple realms, each realm catered to a particular set of customers or users. For example, a commercial realm may be provided for commercial customers. As another example, a realm may be provided for a specific country for customers within that country. As yet another example, a government realm may be provided for a government, and the like. For example, the government realm may be catered for a specific government and may have a heightened level of security than a commercial realm. For example, Oracle Cloud Infrastructure (OCI) currently offers a realm for commercial regions and two realms (e.g., FedRAMP authorized and IL5 authorized) for government cloud regions.

In certain embodiments, an AD can be subdivided into one or more fault domains. A fault domain is a grouping of infrastructure resources within an AD to provide anti-affinity. Fault domains allow for the distribution of compute instances such that the instances are not on the same physical hardware within a single AD. This is known as anti-affinity. A fault domain refers to a set of hardware components (computers, switches, and more) that share a single point of failure. A compute pool is logically divided up into fault domains. Due to this, a hardware failure or compute hardware maintenance event that affects one fault domain does not affect instances in other fault domains. Depending on the embodiment, the number of fault domains for each AD may vary. For instance, in certain embodiments each AD contains three fault domains. A fault domain acts as a logical data center within an AD.

When a customer subscribes to an IaaS service, resources from CSPI are provisioned for the customer and associated with the customer's tenancy. The customer can use these provisioned resources to build private networks and deploy resources on these networks. The customer networks that are hosted in the cloud by the CSPI are referred to as virtual cloud networks (VCNs). A customer can set up one or more virtual cloud networks (VCNs) using CSPI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with public accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints.

The CSP may provide various services using the CSPI. In some instances, customers of CSPI may themselves act like service providers and provide services using CSPI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints.

In certain embodiments, a service provider may expose a service via an endpoint (sometimes referred to as a service endpoint) for the service. Customers of the service can then use this service endpoint to access the service. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general, a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

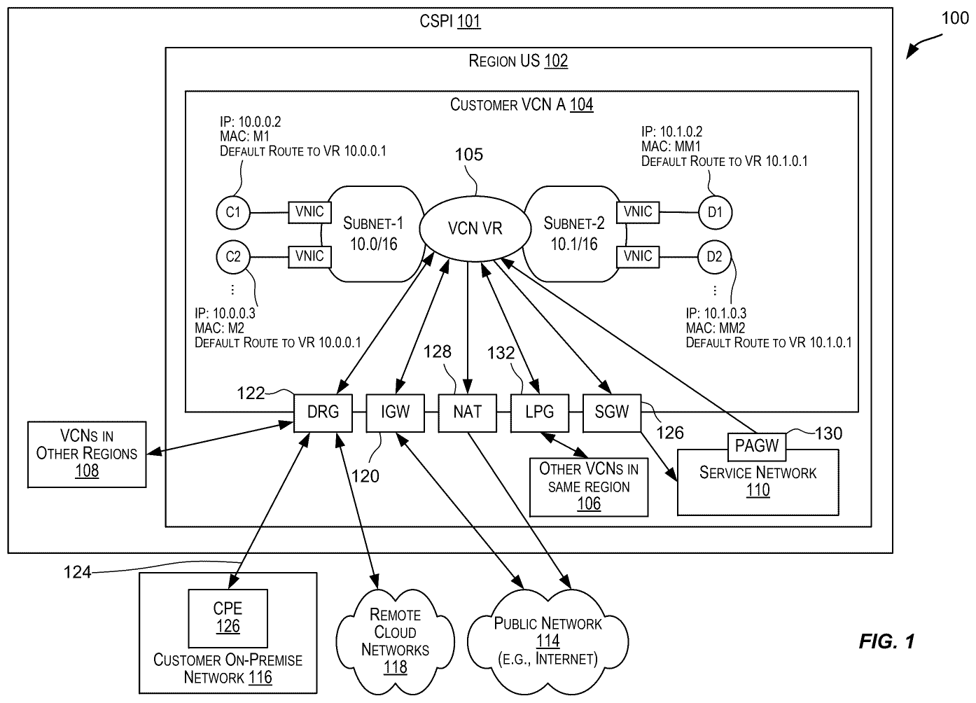

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 1. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about: the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

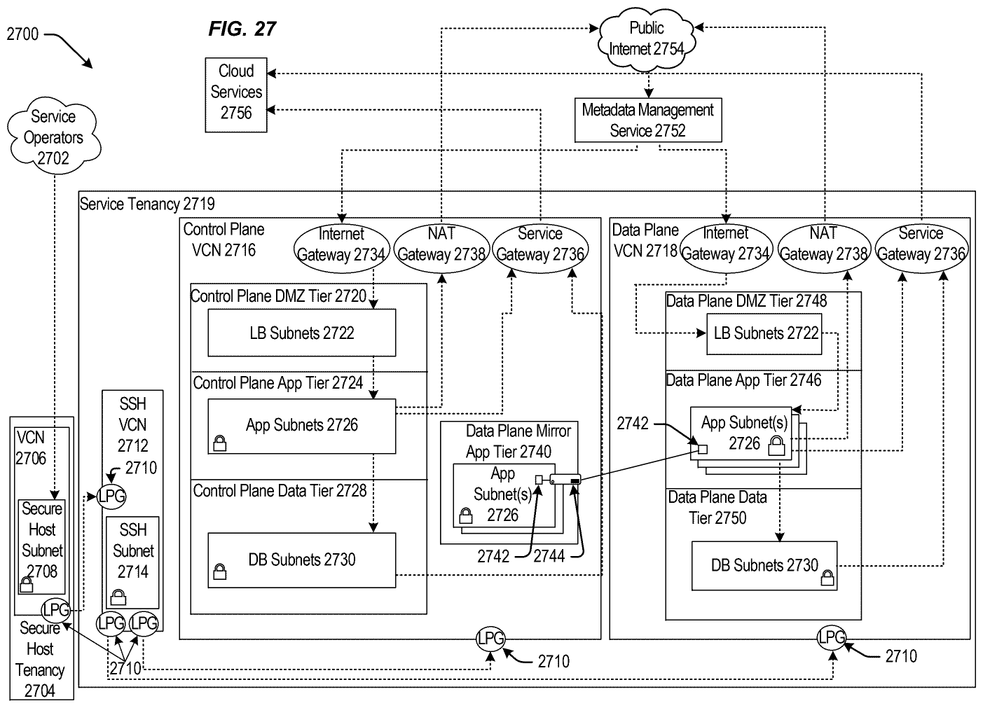

In certain embodiments, the creation of VCNs and subnets are handled by a VCN Control Plane (CP) and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane. Examples of a VCN Control Plane are also depicted in FIGS. 27, 28, 29, and 30 (see references 2716, 2816, 2916, and 3016) and described below.

A customer may create one or more VCNs using resources hosted by CSPI. A compute instance deployed on a customer VCN may communicate with different endpoints. These endpoints can include endpoints that are hosted by CSPI and endpoints outside CSPI.

Various different architectures for implementing cloud-based service using CSPI are depicted in FIGS. 1, 2, 3, 4, 5, and are described below. FIG. 1 is a high level diagram of a distributed environment 100 showing an overlay or customer VCN hosted by CSPI according to certain embodiments. The distributed environment depicted in FIG. 1 includes multiple components in the overlay network. Distributed environment 100 depicted in FIG. 1 is merely an example and is not intended to unduly limit the scope of claimed embodiments. Many variations, alternatives, and modifications are possible. For example, in some implementations, the distributed environment depicted in FIG. 1 may have more or fewer systems or components than those shown in FIG. 1, may combine two or more systems, or may have a different configuration or arrangement of systems.

As shown in the example depicted in FIG. 1, distributed environment 100 comprises CSPI 101 that provides services and resources that customers can subscribe to and use to build their virtual cloud networks (VCNs). In certain embodiments, CSPI 101 offers IaaS services to subscribing customers. The data centers within CSPI 101 may be organized into one or more regions. One example region “Region US” 102 is shown in FIG. 1. A customer has configured a customer VCN 104 for region 102. The customer may deploy various compute instances on VCN 104, where the compute instances may include virtual machines or bare metal instances. Examples of instances include applications, database, load balancers, and the like.

In the embodiment depicted in FIG. 1, customer VCN 104 comprises two subnets, namely, “Subnet-1” and “Subnet-2”, each subnet with its own CIDR IP address range. In FIG. 1, the overlay IP address range for Subnet-1 is 10.0/16 and the address range for Subnet-2 is 10.1/16. A VCN Virtual Router 105 represents a logical gateway for the VCN that enables communications between subnets of the VCN 104, and with other endpoints outside the VCN. VCN VR 105 is configured to route traffic between VNICs in VCN 104 and gateways associated with VCN 104. VCN VR 105 provides a port for each subnet of VCN 104. For example, VR 105 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CSPI 101. A compute instance participates in a subnet via a VNIC associated with the compute instance. For example, as shown in FIG. 1, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 1, compute instance C1 has an overlay IP address of 10.0.0.2 and a MAC address of M1, while compute instance C2 has a private overlay IP address of 10.0.0.3 and a MAC address of M2. Each compute instance in Subnet-1, including compute instances C1 and C2, has a default route to VCN VR 105 using IP address 10.0.0.1, which is the IP address for a port of VCN VR 105 for Subnet-1.

Subnet-2 can have multiple compute instances deployed on it, including virtual machine instances and/or bare metal instances. For example, as shown in FIG. 1, compute instances D1 and D2 are part of Subnet-2 via VNICs associated with the respective compute instances. In the embodiment depicted in FIG. 1, compute instance D1 has an overlay IP address of 10.1.0.2 and a MAC address of MM1, while compute instance D2 has an private overlay IP address of 10.1.0.3 and a MAC address of MM2. Each compute instance in Subnet-2, including compute instances D1 and D2, has a default route to VCN VR 105 using IP address 10.1.0.1, which is the IP address for a port of VCN VR 105 for Subnet-2.

VCN A 104 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 104 can communicate with various different endpoints. These endpoints may include endpoints that are hosted by CSPI 200 and endpoints outside CSPI 200. Endpoints that are hosted by CSPI 101 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 106 or 110, communications between a compute instance in Subnet-1 and an endpoint in service network 110 in the same region); or an endpoint in a VCN in a different region (e.g., communications between a compute instance in Subnet-1 and an endpoint in a VCN in a different region 108). A compute instance in a subnet hosted by CSPI 101 may also communicate with endpoints that are not hosted by CSPI 101 (i.e., are outside CSPI 101). These outside endpoints include endpoints in the customer's on-premise network 116, endpoints within other remote cloud hosted networks 118, public endpoints 114 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 1 wants to send a packet to compute instance D1 in Subnet-2, the packet is first processed by the VNIC associated with compute instance C1. The VNIC associated with compute instance C1 is configured to route the packet to the VCN VR 105 using default route or port 10.0.0.1 of the VCN VR. VCN VR 105 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 104 to an endpoint that is outside VCN 104, the communication is facilitated by the VNIC associated with the source compute instance, VCN VR 105, and gateways associated with VCN 104. One or more types of gateways may be associated with VCN 104. A gateway is an interface between a VCN and another endpoint, where the another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 104. The packet may be first processed by the VNIC associated with source compute instance C1. The VNIC processing determines that the destination for the packet is outside the Subnet-1 of C1. The VNIC associated with C1 may forward the packet to VCN VR 105 for VCN 104. VCN VR 105 then processes the packet and as part of the processing, based upon the destination for the packet, determines a particular gateway associated with VCN 104 as the next hop for the packet. VCN VR 105 may then forward the packet to the particular identified gateway. For example, if the destination is an endpoint within the customer's on-premise network, then the packet may be forwarded by VCN VR 105 to Dynamic Routing Gateway (DRG) gateway 122 configured for VCN 104. The packet may then be forwarded from the gateway to a next hop to facilitate communication of the packet to it final intended destination.

Various different types of gateways may be configured for a VCN. Examples of gateways that may be configured for a VCN are depicted in FIG. 1 and described below. Examples of gateways associated with a VCN are also depicted in FIGS. 27, 28, 29, and 30 (for example, gateways referenced by reference numbers 2734, 2736, 2738, 2834, 2836, 2838, 2934, 2936, 2938, 3034, 3036, and 3038) and described below. As shown in the embodiment depicted in FIG. 1, a Dynamic Routing Gateway (DRG) 122 may be added to or be associated with customer VCN 104 and provides a path for private network traffic communication between customer VCN 104 and another endpoint, where the another endpoint can be the customer's on-premise network 116, a VCN 108 in a different region of CSPI 101, or other remote cloud networks 118 not hosted by CSPI 101. Customer on-premise network 116 may be a customer network or a customer data center built using the customer's resources. Access to customer on-premise network 116 is generally very restricted. For a customer that has both a customer on-premise network 116 and one or more VCNs 104 deployed or hosted in the cloud by CSPI 101, the customer may want their on-premise network 116 and their cloud-based VCN 104 to be able to communicate with each other. This enables a customer to build an extended hybrid environment encompassing the customer's VCN 104 hosted by CSPI 101 and their on-premises network 116. DRG 122 enables this communication. To enable such communications, a communication channel 124 is set up where one endpoint of the channel is in customer on-premise network 116 and the other endpoint is in CSPI 101 and connected to customer VCN 104. Communication channel 124 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 116 that forms one end point for communication channel 124 is referred to as the customer premise equipment (CPE), such as CPE 126 depicted in FIG. 1. On the CSPI 101 side, the endpoint may be a host machine executing DRG 122.

In certain embodiments, a Remote Peering Connection (RPC) can be added to a DRG, which allows a customer to peer one VCN with another VCN in a different region. Using such an RPC, customer VCN 104 can use DRG 122 to connect with a VCN 108 in another region. DRG 122 may also be used to communicate with other remote cloud networks 118, not hosted by CSPI 101 such as a Microsoft Azure cloud, Amazon AWS cloud, and others.

As shown in FIG. 1, an Internet Gateway (IGW) 120 may be configured for customer VCN 104 the enables a compute instance on VCN 104 to communicate with public endpoints 114 accessible over a public network such as the Internet. IGW 120 is a gateway that connects a VCN to a public network such as the Internet. IGW 120 enables a public subnet (where the resources in the public subnet have public overlay IP addresses) within a VCN, such as VCN 104, direct access to public endpoints 112 on a public network 114 such as the Internet. Using IGW 120, connections can be initiated from a subnet within VCN 104 or from the Internet.

A Network Address Translation (NAT) gateway 128 can be configured for customer's VCN 104 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 104, with private access to public endpoints on the Internet. In NAT gateways, connections can be initiated only from the private subnet to the public Internet and not from the Internet to the private subnet.

In certain embodiments, a Service Gateway (SGW) 126 can be configured for customer VCN 104 and provides a path for private network traffic between VCN 104 and supported services endpoints in a service network 110. In certain embodiments, service network 110 may be provided by the CSP and may provide various services. An example of such a service network is Oracle's Services Network, which provides various services that can be used by customers. For example, a compute instance (e.g., a database system) in a private subnet of customer VCN 104 can back up data to a service endpoint (e.g., Object Storage) without needing public IP addresses or access to the Internet. In certain embodiments, a VCN can have only one SGW, and connections can only be initiated from a subnet within the VCN and not from service network 110. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 126 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 132 is a gateway that can be added to customer VCN 104 and enables VCN 104 to peer with another VCN in the same region. Peering means that the VCNs communicate using private IP addresses, without the traffic traversing a public network such as the Internet or without routing the traffic through the customer's on-premises network 116. In preferred embodiments, a VCN has a separate LPG for each peering it establishes. Local Peering or VCN Peering is a common practice used to establish network connectivity between different applications or infrastructure management functions.

Service providers, such as providers of services in service network 110, may provide access to services using different access models. According to a public access model, services may be exposed as public endpoints that are publicly accessible by compute instance in a customer VCN via a public network such as the Internet and or may be privately accessible via SGW 126. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 130 is a gateway resource that can be attached to a service provider VCN (e.g., a VCN in service network 110) that acts as an ingress/egress point for all traffic from/to customer subnet private endpoints. PAGW 130 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 130 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 132 and the PE in the customer's VCN.

A customer can control routing in a VCN at the subnet level, so the customer can specify which subnets in the customer's VCN, such as VCN 104, use each gateway. A VCN's route tables are used to decide if traffic is allowed out of a VCN through a particular gateway. For example, in a particular instance, a route table for a public subnet within customer VCN 104 may send non-local traffic through IGW 120. The route table for a private subnet within the same customer VCN 104 may send traffic destined for CSP services through SGW 126. All remaining traffic may be sent via the NAT gateway 128. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked and the response is automatically allowed without an explicit security list rule for the response traffic) or stateless.

Access from a customer VCN (i.e., by a resource or compute instance deployed on VCN 104) can be categorized as public access, private access, or dedicated access. Public access refers to an access model where a public IP address or a NAT is used to access a public endpoint. Private access enables customer workloads in VCN 104 with private IP addresses (e.g., resources in a private subnet) to access services without traversing a public network such as the Internet. In certain embodiments, CSPI 101 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CSPI may offer dedicated public access using technologies such as FastConnect public peering where customer on-premises instances can access one or more services in a customer VCN using a FastConnect connection and without traversing a public network such as the Internet. CSPI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CSPI and its services. FastConnect provides an easy, elastic, and economical way to create a dedicated and private connection with higher bandwidth options and a more reliable and consistent networking experience when compared to Internet-based connections.

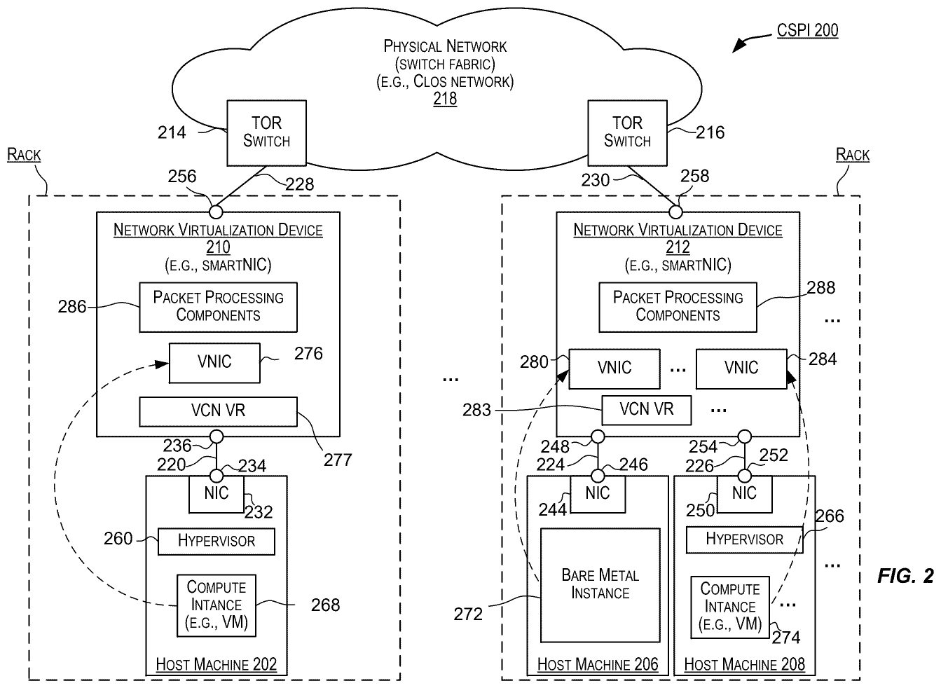

FIG. 1 and the accompanying description above describes various virtualized components in an example virtual network. As described above, the virtual network is built on the underlying physical or substrate network. FIG. 2 depicts a simplified architectural diagram of the physical components in the physical network within CSPI 200 that provide the underlay for the virtual network according to certain embodiments. As shown, CSPI 200 provides a distributed environment comprising components and resources (e.g., compute, memory, and networking resources) provided by a cloud service provider (CSP). These components and resources are used to provide cloud services (e.g., IaaS services) to subscribing customers, i.e., customers that have subscribed to one or more services provided by the CSP. Based upon the services subscribed to by a customer, a subset of resources (e.g., compute, memory, and networking resources) of CSPI 200 are provisioned for the customer. Customers can then build their own cloud-based (i.e., CSPI-hosted) customizable and private virtual networks using physical compute, memory, and networking resources provided by CSPI 200. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CSPI 200 provides infrastructure and a set of complementary cloud services that enable customers to build and run a wide range of applications and services in a highly available hosted environment.

In the example embodiment depicted in FIG. 2, the physical components of CSPI 200 include one or more physical host machines or physical servers (e.g., 202, 206, 208), network virtualization devices (NVDs) (e.g., 210, 212), top-of-rack (TOR) switches (e.g., 214, 216), and a physical network (e.g., 218), and switches in physical network 218. The physical host machines or servers may host and execute various compute instances that participate in one or more subnets of a VCN. The compute instances may include virtual machine instances, and bare metal instances. For example, the various compute instances depicted in FIG. 1 may be hosted by the physical host machines depicted in FIG. 2. The virtual machine compute instances in a VCN may be executed by one host machine or by multiple different host machines. The physical host machines may also host virtual host machines, container-based hosts or functions, and the like. The VNICs and VCN VR depicted in FIG. 1 may be executed by the NVDs depicted in FIG. 2. The gateways depicted in FIG. 1 may be executed by the host machines and/or by the NVDs depicted in FIG. 2.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 2, host machines 202 and 208 execute hypervisors 260 and 266, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 2, hypervisor 260 may sit on top of the OS of host machine 202 and enables the computing resources (e.g., processing, memory, and networking resources) of host machine 202 to be shared between compute instances (e.g., virtual machines) executed by host machine 202. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 2 may have the same or different types of hypervisors.

A compute instance can be a virtual machine instance or a bare metal instance. In FIG. 2, compute instances 268 on host machine 202 and 274 on host machine 208 are examples of virtual machine instances. Host machine 206 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 2, host machine 202 executes a virtual machine compute instance 268 that is associated with VNIC 276, and VNIC 276 is executed by NVD 210 connected to host machine 202. As another example, bare metal instance 272 hosted by host machine 206 is associated with VNIC 280 that is executed by NVD 212 connected to host machine 206. As yet another example, VNIC 284 is associated with compute instance 274 executed by host machine 208, and VNIC 284 is executed by NVD 212 connected to host machine 208.

For compute instances hosted by a host machine, an NVD connected to that host machine also executes VCN VRs corresponding to VCNs of which the compute instances are members. For example, in the embodiment depicted in FIG. 2, NVD 210 executes VCN VR 277 corresponding to the VCN of which compute instance 268 is a member. NVD 212 may also execute one or more VCN VRs 283 corresponding to VCNs corresponding to the compute instances hosted by host machines 206 and 208.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 2, host machine 202 is connected to NVD 210 using link 220 that extends between a port 234 provided by a NIC 232 of host machine 202 and between a port 236 of NVD 210. Host machine 206 is connected to NVD 212 using link 224 that extends between a port 246 provided by a NIC 244 of host machine 206 and between a port 248 of NVD 212. Host machine 208 is connected to NVD 212 using link 226 that extends between a port 252 provided by a NIC 250 of host machine 208 and between a port 254 of NVD 212.

The NVDs are in turn connected via communication links to top-of-the-rack (TOR) switches, which are connected to physical network 218 (also referred to as the switch fabric). In certain embodiments, the links between a host machine and an NVD, and between an NVD and a TOR switch are Ethernet links. For example, in FIG. 2, NVDs 210 and 212 are connected to TOR switches 214 and 216, respectively, using links 228 and 230. In certain embodiments, the links 220, 224, 226, 228, and 230 are Ethernet links. The collection of host machines and NVDs that are connected to a TOR is sometimes referred to as a rack.

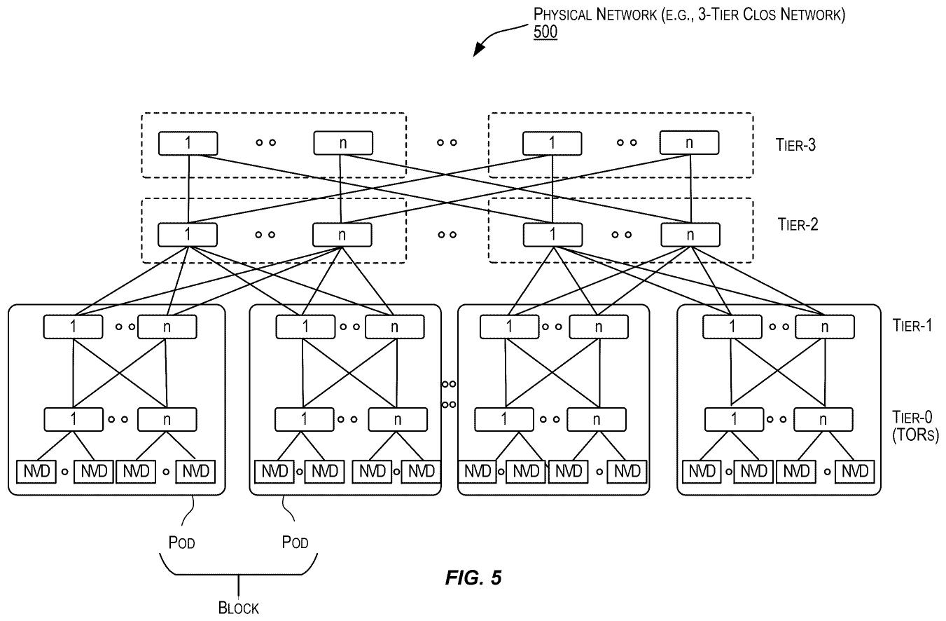

Physical network 218 provides a communication fabric that enables TOR switches to communicate with each other. Physical network 218 can be a multi-tiered network. In certain implementations, physical network 218 is a multi-tiered Clos network of switches, with TOR switches 214 and 216 representing the leaf level nodes of the multi-tiered and multi-node physical switching network 218. Different Clos network configurations are possible including but not limited to a 2-tier network, a 3-tier network, a 4-tier network, a 5-tier network, and in general a “n”-tiered network. An example of a Clos network is depicted in FIG. 5 and described below.

Various different connection configurations are possible between host machines and NVDs such as one-to-one configuration, many-to-one configuration, one-to-many configuration, and others. In a one-to-one configuration implementation, each host machine is connected to its own separate NVD. For example, in FIG. 2, host machine 202 is connected to NVD 210 via NIC 232 of host machine 202. In a many-to-one configuration, multiple host machines are connected to one NVD. For example, in FIG. 2, host machines 206 and 208 are connected to the same NVD 212 via NICs 244 and 250, respectively.

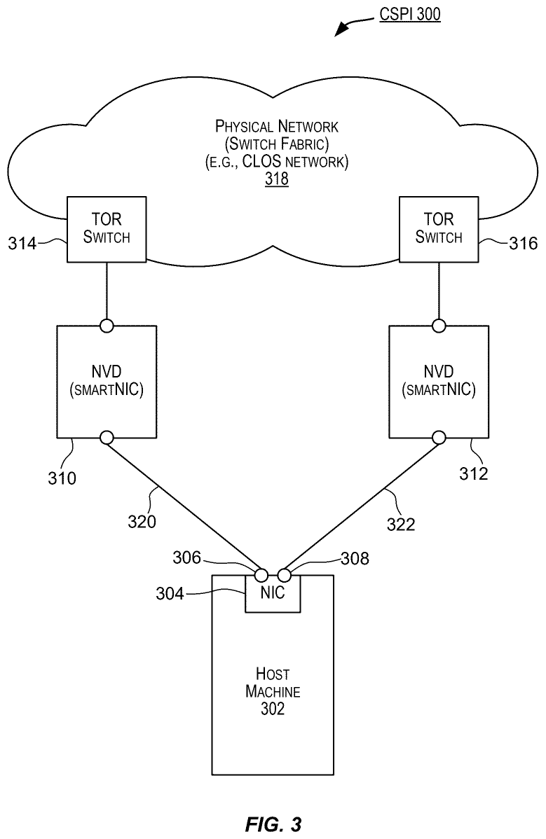

In a one-to-many configuration, one host machine is connected to multiple NVDs. FIG. 3 shows an example within CSPI 300 where a host machine is connected to multiple NVDs. As shown in FIG. 3, host machine 302 comprises a network interface card (NIC) 304 that includes multiple ports 306 and 308. Host machine 300 is connected to a first NVD 310 via port 306 and link 320 and connected to a second NVD 312 via port 308 and link 322. Ports 306 and 308 may be Ethernet ports and the links 320 and 322 between host machine 302 and NVDs 310 and 312 may be Ethernet links. NVD 310 is in turn connected to a first TOR switch 314 and NVD 312 is connected to a second TOR switch 316. The links between NVDs 310 and 312, and TOR switches 314 and 316 may be Ethernet links. TOR switches 314 and 316 represent the Tier-0 switching devices in multi-tiered physical network 318.

The arrangement depicted in FIG. 3 provides two separate physical network paths to and from physical switch network 318 to host machine 302: a first path traversing TOR switch 314 to NVD 310 to host machine 302, and a second path traversing TOR switch 316 to NVD 312 to host machine 302. The separate paths provide for enhanced availability (referred to as high availability) of host machine 302. If there are problems in one of the paths (e.g., a link in one of the paths goes down) or devices (e.g., a particular NVD is not functioning), then the other path may be used for communications to/from host machine 302.

In the configuration depicted in FIG. 3, the host machine is connected to two different NVDs using two different ports provided by a NIC of the host machine. In other embodiments, a host machine may include multiple NICs that enable connectivity of the host machine to multiple NVDs.

Referring back to FIG. 2, an NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by the one or more processing units of the NVD.

An NVD may be implemented in various different forms. For example, in certain embodiments, an NVD is implemented as an interface card referred to as a smartNIC or an intelligent NIC with an embedded processor onboard. A smartNIC is a separate device from the NICs on the host machines. In FIG. 2, the NVDs 210 and 212 may be implemented as smartNICs that are connected to host machines 202, and host machines 206 and 208, respectively.

A smartNIC is however just one example of an NVD implementation. Various other implementations are possible. For example, in some other implementations, an NVD or one or more functions performed by the NVD may be incorporated into or performed by one or more host machines, one or more TOR switches, and other components of CSPI 200. For example, an NVD may be embodied in a host machine where the functions performed by an NVD are performed by the host machine. As another example, an NVD may be part of a TOR switch or a TOR switch may be configured to perform functions performed by an NVD that enables the TOR switch to perform various complex packet transformations that are used for a public cloud. A TOR that performs the functions of an NVD is sometimes referred to as a smart TOR. In yet other implementations, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In certain embodiments, such as when implemented as a smartNIC as shown in FIG. 2, an NVD may comprise multiple physical ports that enable it to be connected to one or more host machines and to one or more TOR switches. A port on an NVD can be classified as a host-facing port (also referred to as a “south port”) or a network-facing or TOR-facing port (also referred to as a “north port”). A host-facing port of an NVD is a port that is used to connect the NVD to a host machine. Examples of host-facing ports in FIG. 2 include port 236 on NVD 210, and ports 248 and 254 on NVD 212. A network-facing port of an NVD is a port that is used to connect the NVD to a TOR switch. Examples of network-facing ports in FIG. 2 include port 256 on NVD 210, and port 258 on NVD 212. As shown in FIG. 2, NVD 210 is connected to TOR switch 214 using link 228 that extends from port 256 of NVD 210 to the TOR switch 214. Likewise, NVD 212 is connected to TOR switch 216 using link 230 that extends from port 258 of NVD 212 to the TOR switch 216.

An NVD receives packets and frames from a host machine (e.g., packets and frames generated by a compute instance hosted by the host machine) via a host-facing port and, after performing the necessary packet processing, may forward the packets and frames to a TOR switch via a network-facing port of the NVD. An NVD may receive packets and frames from a TOR switch via a network-facing port of the NVD and, after performing the necessary packet processing, may forward the packets and frames to a host machine via a host-facing port of the NVD.

In certain embodiments, there may be multiple ports and associated links between an NVD and a TOR switch. These ports and links may be aggregated to form a link aggregator group of multiple ports or links (referred to as a LAG). Link aggregation allows multiple physical links between two end-points (e.g., between an NVD and a TOR switch) to be treated as a single logical link. All the physical links in a given LAG may operate in full-duplex mode at the same speed. LAGs help increase the bandwidth and reliability of the connection between two endpoints. If one of the physical links in the LAG goes down, traffic is dynamically and transparently reassigned to one of the other physical links in the LAG. The aggregated physical links deliver higher bandwidth than each individual link. The multiple ports associated with a LAG are treated as a single logical port. Traffic can be load-balanced across the multiple physical links of a LAG. One or more LAGs may be configured between two endpoints. The two endpoints may be between an NVD and a TOR switch, between a host machine and an NVD, and the like.

An NVD implements or performs network virtualization functions. These functions are performed by software/firmware executed by the NVD. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, an NVD is configured to execute a packet processing pipeline for processing the packet and determining how the packet is to be forwarded or routed. As part of this packet processing pipeline, the NVD may execute one or more virtual functions associated with the overlay network such as executing VNICs associated with compute instances in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions.

In certain embodiments, the packet processing data path in an NVD may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines.

An NVD may perform both control plane and data plane functions corresponding to a control plane and a data plane of a VCN. Examples of a VCN Control Plane are also depicted in FIGS. 27, 28, 29, and 30 (see references 2716, 2816, 2916, and 3016) and described below. Examples of a VCN Data Plane are depicted in FIGS. 27, 28, 29, and 30 (see references 2718, 2818, 2918, and 3018) and described below. The control plane functions include functions used for configuring a network (e.g., setting up routes and route tables, configuring VNICs, etc.) that controls how data is to be forwarded. In certain embodiments, a VCN Control Plane is provided that computes all the overlay-to-substrate mappings centrally and publishes them to the NVDs and to the virtual network edge devices such as various gateways such as the DRG, the SGW, the IGW, etc. Firewall rules may also be published using the same mechanism. In certain embodiments, an NVD only gets the mappings that are relevant for that NVD. The data plane functions include functions for the actual routing/forwarding of a packet based upon configuration set up using control plane. A VCN data plane is implemented by encapsulating the customer's network packets before they traverse the substrate network. The encapsulation/decapsulation functionality is implemented on the NVDs. In certain embodiments, an NVD is configured to intercept all network packets in and out of host machines and perform network virtualization functions.

As indicated above, an NVD executes various virtualization functions including VNICs and VCN VRs. An NVD may execute VNICs associated with the compute instances hosted by one or more host machines connected to the VNIC. For example, as depicted in FIG. 2. NVD 210 executes the functionality for VNIC 276 that is associated with compute instance 268 hosted by host machine 202 connected to NVD 210. As another example, NVD 212 executes VNIC 280 that is associated with bare metal compute instance 272 hosted by host machine 206, and executes VNIC 284 that is associated with compute instance 274 hosted by host machine 208. A host machine may host compute instances belonging to different VCNs, which belong to different customers, and the NVD connected to the host machine may execute the VNICs (i.e., execute VNICs-relate functionality) corresponding to the compute instances.

An NVD also executes VCN Virtual Routers corresponding to the VCNs of the compute instances. For example, in the embodiment depicted in FIG. 2, NVD 210 executes VCN VR 277 corresponding to the VCN to which compute instance 268 belongs. NVD 212 executes one or more VCN VRs 283 corresponding to one or more VCNs to which compute instances hosted by host machines 206 and 208 belong. In certain embodiments, the VCN VR corresponding to that VCN is executed by all the NVDs connected to host machines that host at least one compute instance belonging to that VCN. If a host machine hosts compute instances belonging to different VCNs, an NVD connected to that host machine may execute VCN VRs corresponding to those different VCNs.

In addition to VNICs and VCN VRs, an NVD may execute various software (e.g., daemons) and include one or more hardware components that facilitate the various network virtualization functions performed by the NVD. For purposes of simplicity, these various components are grouped together as “packet processing components” shown in FIG. 2. For example, NVD 210 comprises packet processing components 286 and NVD 212 comprises packet processing components 288. For example, the packet processing components for an NVD may include a packet processor that is configured to interact with the NVD's ports and hardware interfaces to monitor all packets received by and communicated using the NVD and store network information. The network information may, for example, include network flow information identifying different network flows handled by the NVD and per flow information (e.g., per flow statistics). In certain embodiments, network flows information may be stored on a per VNIC basis. The packet processor may perform packet-by-packet manipulations as well as implement stateful NAT and L4 firewall (FW). As another example, the packet processing components may include a replication agent that is configured to replicate information stored by the NVD to one or more different replication target stores. As yet another example, the packet processing components may include a logging agent that is configured to perform logging functions for the NVD. The packet processing components may also include software for monitoring the performance and health of the NVD and, also possibly of monitoring the state and health of other components connected to the NVD.

FIG. 1 shows the components of an example virtual or overlay network including a VCN, subnets within the VCN, compute instances deployed on subnets, VNICs associated with the compute instances, a VR for a VCN, and a set of gateways configured for the VCN. The overlay components depicted in FIG. 1 may be executed or hosted by one or more of the physical components depicted in FIG. 2. For example, the compute instances in a VCN may be executed or hosted by one or more host machines depicted in FIG. 2. For a compute instance hosted by a host machine, the VNIC associated with that compute instance is typically executed by an NVD connected to that host machine (i.e., the VNIC functionality is provided by the NVD connected to that host machine). The VCN VR function for a VCN is executed by all the NVDs that are connected to host machines hosting or executing the compute instances that are part of that VCN. The gateways associated with a VCN may be executed by one or more different types of NVDs. For example, certain gateways may be executed by smartNICs, while others may be executed by one or more host machines or other implementations of NVDs.

As described above, a compute instance in a customer VCN may communicate with various different endpoints, where the endpoints can be within the same subnet as the source compute instance, in a different subnet but within the same VCN as the source compute instance, or with an endpoint that is outside the VCN of the source compute instance. These communications are facilitated using VNICs associated with the compute instances, the VCN VRs, and the gateways associated with the VCNs.

For communications between two compute instances on the same subnet in a VCN, the communication is facilitated using VNICs associated with the source and destination compute instances. The source and destination compute instances may be hosted by the same host machine or by different host machines. A packet originating from a source compute instance may be forwarded from a host machine hosting the source compute instance to an NVD connected to that host machine. On the NVD, the packet is processed using a packet processing pipeline, which can include execution of the VNIC associated with the source compute instance. Since the destination endpoint for the packet is within the same subnet, execution of the VNIC associated with the source compute instance results in the packet being forwarded to an NVD executing the VNIC associated with the destination compute instance, which then processes and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs). The VNICs may use routing/forwarding tables stored by the NVD to determine the next hop for the packet.

For a packet to be communicated from a compute instance in a subnet to an endpoint in a different subnet in the same VCN, the packet originating from the source compute instance is communicated from the host machine hosting the source compute instance to the NVD connected to that host machine. On the NVD, the packet is processed using a packet processing pipeline, which can include execution of one or more VNICs, and the VR associated with the VCN. For example, as part of the packet processing pipeline, the NVD executes or invokes functionality corresponding to the VNIC (also referred to as executes the VNIC) associated with source compute instance. The functionality performed by the VNIC may include looking at the VLAN tag on the packet. Since the packet's destination is outside the subnet, the VCN VR functionality is next invoked and executed by the NVD. The VCN VR then routes the packet to the NVD executing the VNIC associated with the destination compute instance. The VNIC associated with the destination compute instance then processes the packet and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs).

If the destination for the packet is outside the VCN of the source compute instance, then the packet originating from the source compute instance is communicated from the host machine hosting the source compute instance to the NVD connected to that host machine. The NVD executes the VNIC associated with the source compute instance. Since the destination end point of the packet is outside the VCN, the packet is then processed by the VCN VR for that VCN. The NVD invokes the VCN VR functionality, which may result in the packet being forwarded to an NVD executing the appropriate gateway associated with the VCN. For example, if the destination is an endpoint within the customer's on-premise network, then the packet may be forwarded by the VCN VR to the NVD executing the DRG gateway configured for the VCN. The VCN VR may be executed on the same NVD as the NVD executing the VNIC associated with the source compute instance or by a different NVD. The gateway may be executed by an NVD, which may be a smartNIC, a host machine, or other NVD implementation. The packet is then processed by the gateway and forwarded to a next hop that facilitates communication of the packet to its intended destination endpoint. For example, in the embodiment depicted in FIG. 2, a packet originating from compute instance 268 may be communicated from host machine 202 to NVD 210 over link 220 (using NIC 232). On NVD 210, VNIC 276 is invoked since it is the VNIC associated with source compute instance 268. VNIC 276 is configured to examine the encapsulated information in the packet, and determine a next hop for forwarding the packet with the goal of facilitating communication of the packet to its intended destination endpoint, and then forward the packet to the determined next hop.

A compute instance deployed on a VCN can communicate with various different endpoints. These endpoints may include endpoints that are hosted by CSPI 200 and endpoints outside CSPI 200. Endpoints hosted by CSPI 200 may include instances in the same VCN or other VCNs, which may be the customer's VCNs, or VCNs not belonging to the customer. Communications between endpoints hosted by CSPI 200 may be performed over physical network 218. A compute instance may also communicate with endpoints that are not hosted by CSPI 200, or are outside CSPI 200. Examples of these endpoints include endpoints within a customer's on-premise network or data center, or public endpoints accessible over a public network such as the Internet. Communications with endpoints outside CSPI 200 may be performed over public networks (e.g., the Internet) (not shown in FIG. 2) or private networks (not shown in FIG. 2) using various communication protocols.

The architecture of CSPI 200 depicted in FIG. 2 is merely an example and is not intended to be limiting. Variations, alternatives, and modifications are possible in alternative embodiments. For example, in some implementations, CSPI 200 may have more or fewer systems or components than those shown in FIG. 2, may combine two or more systems, or may have a different configuration or arrangement of systems. The systems, subsystems, and other components depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

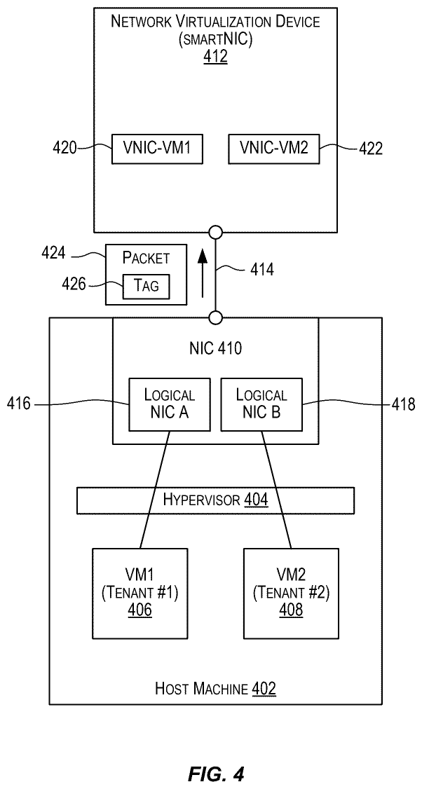

FIG. 4 depicts connectivity between a host machine and an NVD for providing I/O virtualization for supporting multitenancy according to certain embodiments. As depicted in FIG. 4, host machine 402 executes a hypervisor 404 that provides a virtualized environment. Host machine 402 executes two virtual machine instances, VM1 406 belonging to customer/tenant #1 and VM2 408 belonging to customer/tenant #2. Host machine 402 comprises a physical NIC 410 that is connected to an NVD 412 via link 414. Each of the compute instances is attached to a VNIC that is executed by NVD 412. In the embodiment in FIG. 4. VM1 406 is attached to VNIC-VM1 420 and VM2 408 is attached to VNIC-VM2 422.

As shown in FIG. 4, NIC 410 comprises two logical NICs, logical NIC A 416 and logical NIC B 418. Each virtual machine is attached to and configured to work with its own logical NIC. For example. VM1 406 is attached to logical NIC A 416 and VM2 408 is attached to logical NIC B 418. Even though host machine 402 comprises only one physical NIC 410 that is shared by the multiple tenants, due to the logical NICs, each tenant's virtual machine believes they have their own host machine and NIC.

In certain embodiments, each logical NIC is assigned its own VLAN ID. Thus, a specific VLAN ID is assigned to logical NIC A 416 for Tenant #1 and a separate VLAN ID is assigned to logical NIC B 418 for Tenant #2. When a packet is communicated from VM1 406, a tag assigned to Tenant #1 is attached to the packet by the hypervisor and the packet is then communicated from host machine 402 to NVD 412 over link 414. In a similar manner, when a packet is communicated from VM2 408, a tag assigned to Tenant #2 is attached to the packet by the hypervisor and the packet is then communicated from host machine 402 to NVD 412 over link 414. Accordingly, a packet 424 communicated from host machine 402 to NVD 412 has an associated tag 426 that identifies a specific tenant and associated VM. On the NVD, for a packet 424 received from host machine 402, the tag 426 associated with the packet is used to determine whether the packet is to be processed by VNIC-VM1 420 or by VNIC-VM2 422. The packet is then processed by the corresponding VNIC. The configuration depicted in FIG. 4 enables each tenant's compute instance to believe that they own their own host machine and NIC. The setup depicted in FIG. 4 provides for I/O virtualization for supporting multi-tenancy.

FIG. 5 depicts a simplified block diagram of a physical network 500 according to certain embodiments. The embodiment depicted in FIG. 5 is structured as a Clos network. A Clos network is a particular type of network topology designed to provide connection redundancy while maintaining high bisection bandwidth and maximum resource utilization. A Clos network is a type of non-blocking, multistage or multi-tiered switching network, where the number of stages or tiers can be two, three, four, five, etc. The embodiment depicted in FIG. 5 is a 3-tiered network comprising tiers 1, 2, and 3. The TOR switches 504 represent Tier-0 switches in the Clos network. One or more NVDs are connected to the TOR switches. Tier-0 switches are also referred to as edge devices of the physical network. The Tier-0 switches are connected to Tier-1 switches, which are also referred to as leaf switches. In the embodiment depicted in FIG. 5, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 500 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0- switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
ocid1.<RESOURCE TYPE>.<REALM>.[REGION] [.FUTURE USE].<UNIQUE ID>
where,
ocid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

### ZPR Architecture, ZPL, and Zero Trust Packet Routing

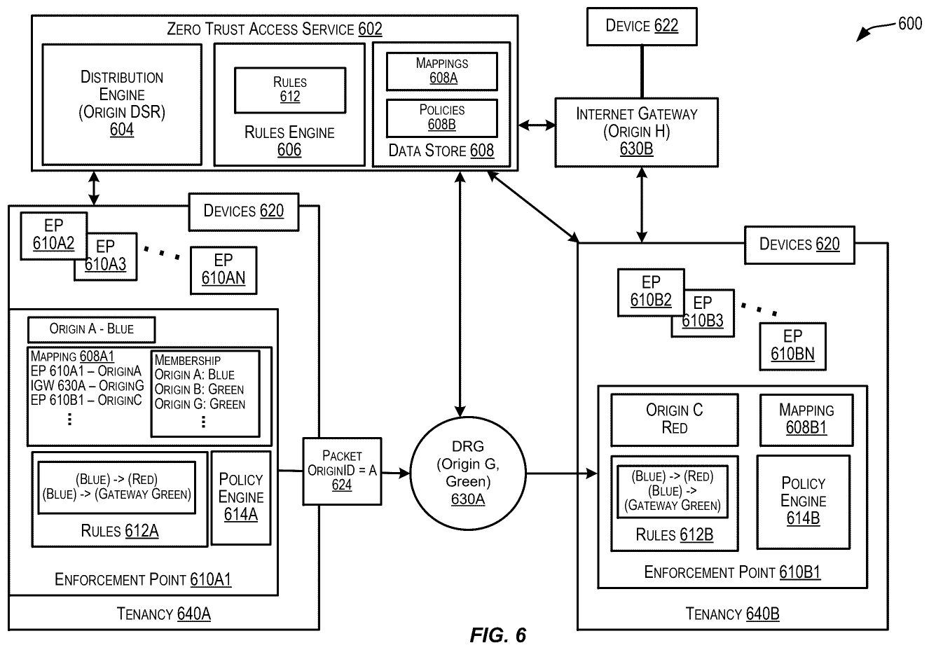

FIG. 6 is a simplified block diagram of an environment 600 illustrating using enforcement points 610 to enforce network policies/rules in one or more networks, according to certain embodiments. Environment 600 comprises multiple systems communicatively coupled to each other. The systems in FIG. 6 include zero trust access (ZTA) service 602, enforcement points 610 (e.g., EPs 610A1-610AN, EPs 610B1-610BN, gateways 630), computing devices 620, gateways 630, tenancy 640A, and tenancy 640B.

ZTA service 602 includes distribution engine 604, rules engine 606 and data store 608. While distribution engine 604, rules engine 606 and data store 608 are illustrated as part of the ZTA service 602, one or more of these components may be external from the ZTA service 602. The computing devices 620, which may be referred to herein as “servers 620”, or “server computing devices 620” can include hypervisors (HVs) (not shown) that can host virtual machines (VMs).

Environment 600 depicted in FIG. 6 is merely an example and is not intended to unduly limit the scope of claimed embodiments. Many variations, alternatives, and modifications are possible. For example, in some implementations, environment 600 may have more or fewer systems or components than those shown in FIG. 6, may combine two or more systems, or may have a different configuration or arrangement of systems. The systems, subsystems, and other components depicted in FIG. 6 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

In the embodiments depicted in FIG. 6, novel techniques are described to define policy using ZPL and performing zero trust packet routing using a ZPR architecture through one or more networks. As briefly discussed above, after creating a policy using ZPL, the policy is enforced throughout the network(s) by EPs, such as EPs 610 and gateways 630 that are distributed at different network points throughout one or more networks. In some examples, a user does not need to specify what devices/components are used to enforce the policy, or where those devices are located. Instead, ZTA service 602, or some other component can deploy and/or instruct different EPs 610 already located within the network to enforce the policy. In some examples, EP functionality 610 can be deployed with all or a portion of network devices that are involved in the transport of data within one or more networks. For example, EP 610 can be deployed with gateways 630, smart network interface cards (smart NICs), gateways 630, as well as other types of network devices/components.

In some configurations, the ZTA service 602 communicates with the different enforcement points 610 within the network. According to some examples, the ZTA service 602 provides rules 612 to different EPs 610 indicating what policies/rules to enforce. Individual EPs 610 can also communicate with ZTA service 602 to request policies from policies/rules 608B, store data within recorded data 608A, provide resource data (e.g., CPU, storage, . . . ), and the like. In some configurations, different EPs 610 may perform different rules/evaluations. For example, tags and attributes (e.g. name) can be evaluated at layer 4 by smartNIC EPs, and L7 attributes (including but not limited to: Path, Request Cookies, Request header, URL query, Request Method, Country/Region, Source IP addresses, Target IP address) can be evaluated at a target service or an egress proxy (e.g, a gateway).

As discussed herein, virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. For example, in certain embodiments, an NVD is implemented as an interface card referred to as a smartNIC or an intelligent NIC with an embedded processor onboard. A smartNIC is a separate device from the NICs on the host machines, such as computing devices 620 that host instances. According to some configurations, smartNICs within the network include functionality to operate as an EP 610. Other NVDs may also include EP 610. For example, in some other implementations, an NVD or one or more functions performed by the NVD may be incorporated into or performed by one or more computing devices 620, one or more TOR switches, and other components of CSPI. For instance, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In some examples, upon receiving a packet, an EP 610 can be configured to execute a packet processing pipeline for processing the packet and determining how the packet is to be processed. As part of this packet processing pipeline, EP 610 may execute one or more virtual functions such as the encapsulation and decapsulation of packets, the identification of an Origin ID, and the like, to facilitate processing the policies/rules, as well as other functions. In some configurations, the packet processing data path in a device that includes EP 610 may comprise multiple packet pipelines, each composed of a series of packet transformation stages. According to some examples, upon receiving a packet, the packet may be processed in a linear fashion, one stage after another, until the packet is either dropped, or sent out over an interface associated with the EP 610.

The gateways 630 illustrated in FIG. 6 can be any type of gateway, such as but not limited to dynamic routing gateways (DRGs), internet gateways (IGWs), network address translation (NAT) gateways, local peering gateways (LPGs), service gateways (SGWs), and the like. A DRG acts as a virtual router, providing a path for traffic between your on-premises networks and VCNs, can also be used to route traffic between VCNs. An IGW enables a compute instance on VCN to communicate with public endpoints accessible over a public network such as the Internet. A NAT gateway can be configured for customer's VCN that enables cloud resources in the customer's VCN, which do not have dedicated public overlay IP addresses, access to the Internet and it does so without exposing those resources to direct incoming Internet connections (e.g., L4-L7 connections). An LPG is a gateway that can be added to a VCN and enables the VCN to peer with another VCN in the same region. A SGW can be configured for a VCN and provides a path for private network traffic between the VCN and supported services endpoints in a service network.

In the embodiments depicted in FIG. 6, the ZTA service 602 is configured to oversee, configure, monitor, and maintain a zero-trust network infrastructure. In some examples, the zero-trust network is a software-defined network that operates on top of an existing cloud infrastructure (SEE FIGS. 1-5, and 27-30 for further details) that enables secure and policy-driven communication between resources of the network (e.g., clients, services, . . . ). According to some examples, the ZTA service 602 implements zero-trust principles to help ensure that network interactions are authenticated, authorized, and encrypted to enhance security and access control. Zero-Trust networks can span multiple environments, including public clouds, private data centers, and on-premises locations, providing a flexible and secure network foundation for various applications and services.

According to some configurations, enforcement of policies is facilitated by enhancements to virtual node packet processing. In some examples, an “Origin ID” that indicates the source of the packet is added to a packet (e.g., by the first EP in a network path that sends the packet) before that packet is transmitted. According to some configurations, the ZTA service 602 collaborates with the Data Security Control Plane (DSCP) to assign Origin IDs to each of the EPs 610 in the network. The ZTA service 602 can also provide Origin IDs other resources (e.g., Gateway and Identity Data Planes) to enable their evaluation of ZPR policy.

The Origin ID is carried with that packet as it travels through the network until it reaches the destination. According to some configurations, the Origin ID is used by each of the enforcement points 610 to determine the rules 612 to apply to the packet before that packet is transmitted to the next hop in the network path to the destination. According to some examples, ZPL integrates with existing policy languages (IAM, NSG, NAP, etc.) by deferring to existing IAM and NSG policy statements when evaluated. In some configurations, ZPL can defer to existing networking policy (web application firewall (WAF), network security groups (NSGs) and firewall (FW) rules).

According to some configurations, the rules engine 606 determines the rules (e.g., L4, L7 rules) to enforce at the enforcement points 610 and gateways 630 based on the policies 608B. As briefly discussed above, ZPL policy statements are focused on allowing resources (users, compute instances, . . . ) that are tagged to access data that is also tagged. In some examples, the rules engine 606 determines the Origin IDs for the different EPs 610 and determines what EPs are authorized to send/receive data from different EPs 610 within one or more networks. After determining the rules 612, the distribution engine 604 provides the rules associated with the policies to the enforcement points 610 within the network. Unlike existing network security policy, ZPR allows for specification of tenancy wide policy that can cross network and regional boundaries. In some examples, the ZTA service 602 provides the Origin IDs within one network to the other networks which may be used in enforcement of a policy.

According to some configurations, the rules 612 are stored by the ZTA service 602 in a binary decision diagram (BDD). In some examples, the VCN Data Plane (not shown) creates a new BDD instance to store the data security rules. The BDD can be consulted when a packet is received at an enforcement point to determine whether to allow/deny the packet. As briefly discussed, when in audit mode, a deny in the BDD may still allow the packet to be transmitted with additional logging and metrics. The BDD can have multiple termination possibilities. A miss in the BDD means the packet is denied. A match on a deny rule in the BDD results in the packet being denied. In other examples, a match on an override rule results in accepting the packet regardless of another decision.

In some examples, an EP 610, such as a smartNIC, may have limited information about the packet. For instance, the EP 610 may only know information about the immediate next hop. According to some configurations, packets are allowed through gateways that are allowed as a next hop to any resource. In some examples, an additional rule is generated by the rules engine 606 that masks off destination groups for every rule that includes an intermediate hop list. For example, a rule that specifies “Allow red to send-receive to blue over network green” would cause an additional rule “Allow red to send-receive to <any>over network green” to be generated by the rules engine 606. A packet that has a next hop of a gateway 630 will get run with zeroed out destination groups in the lookup key. On the ingress path, the origin ID of the packet and the network Origin ID can be added by gateways 630 to fill in the full lookup key.

According to some configurations, an EP 610 determines whether a packet is authorized to be transmitted/received based on the Origin IDs associated with the sender/receiver, as well as the value(s) of the tagged resources. As briefly discussed above, resources and/or data can be tagged either manually and/or automatically. For example, a key: value pair can be used to tag resources.

According to some examples, automated tagging can be performed to discover and tag data, such as sensitive data. Sensitive data needs to be protected and adhere to compliance frameworks such as PCI DSS (Payment Card Industry Data Security Standard), HIPAA (Health Insurance Portability and Accountability Act), and GDPR (General Data Protection Regulation). In many cases, organizations will initially understand where sensitive data is located when they create new greenfield applications, projects, and the like. Over time, however, this sensitive data moves for legitimate purposes (e.g., business analytics, software migrations, and new development projects) making it difficult to protect this data using prior techniques.

In some examples, a default tag can be applied to resources within a specified perimeter (e.g., within a tenancy) such that no tagged data is allowed to leave the perimeter unless allowed by the policy. For instance, “allow users on hosts to access no-ZPR-tag data over all networks” is an L4 policy statement that allows any user (whose groups have zero or more ZPR tags), regardless of host to only access (permissions granted by IAM policy) non-ZPR tagged over any network gateway (e.g., (IGW, NATGW, . . . ). Since tags can be scoped to a perimters (unless explicitly shared), this prevents exfiltration of data from within the perimeters to other perimeters and the internet.

In the example of FIG. 6, the policy could be expressed using ZPL as “Allow network-actors blue to communicate through green with network-actors blue”. The rule (Blue)-> (Red) indicated in rules 612A determined from rules engine 606 allows network-actors (e.g., instances, hosts, . . . ) that are tagged “blue” to send/receive packets to endpoints that are tagged “red”. In this example, enforcement point 610A 1 performs an egress check to determine if the EP 610B1 is “red” and if traffic is allowed to flow through “green”. In this case, EP 610A1 determines that the rule is satisfied, and to transmit packet 624A to DRG 630A. EP 610A1 may also inject the Origin ID: A into the packet 624A to identify its origin. The DRG 630A is a gateway EP that determines whether the sender of packet 624A is “blue”, whether the receiver of the packet 624A is “red” and if the gateway 630A that is “green” is authorized to transmit the packet. DRG 630A determines that the transmission of the packet 624A is authorized and transmits packet 624A to EP 610B1. DRG 630A may also inject the identification of “green” into the packet 624A to identify that the packet 624A travelled through a “green” gateway. Upon receiving the packet at EP 610B, an ingress check is performed to determine if the packet traveled through an authorized path. In this case, EP 610B1 determined that the packet was authorized to travel between the different endpoints and can receive the packet 624A.

According to some configurations, policies and/or policy statements can be tested within a network environment using an alert mode without enforcing the policies and/or policy statements. For example, a user may create a statement such as “allow color:red network-agent to use color:red buckets”. To test this statement, the statement can be specified as Allow ALERT-MODE any (enforce.color:red, alert.color:red) host to use any (enforce.color:red, alert.color:red) buckets. To enforce this statement, the statement can be specified as “Allow enforce.color:red host to use enforce.color:red buckets”.

In some configurations, smartNICs and gateways are used as enforcement points 610. Other devices (physical and/or virtual) can also be used. Generally, when packets are transmitted, the enforcement points 610 associated with the networking data plane evaluate the ingress or egress rules associated with the policy. In this way, packets are not transmitted from an enforcement point 610 until the rules are evaluated by the enforcement point and the enforcement point determines that the transmission is authorized by the policy. Instead of a policy being evaluated at a single location, the enforcement points evaluate the policy at many different locations along the route between the source and target associated with the packet. For example, the enforcement points include the source (e.g., checks the hosts tags), at all/portion of the network hops (e.g., checks the network tags), and at the target, such as a service/application (e.g., full evaluation of all tags, attributes and context variables).

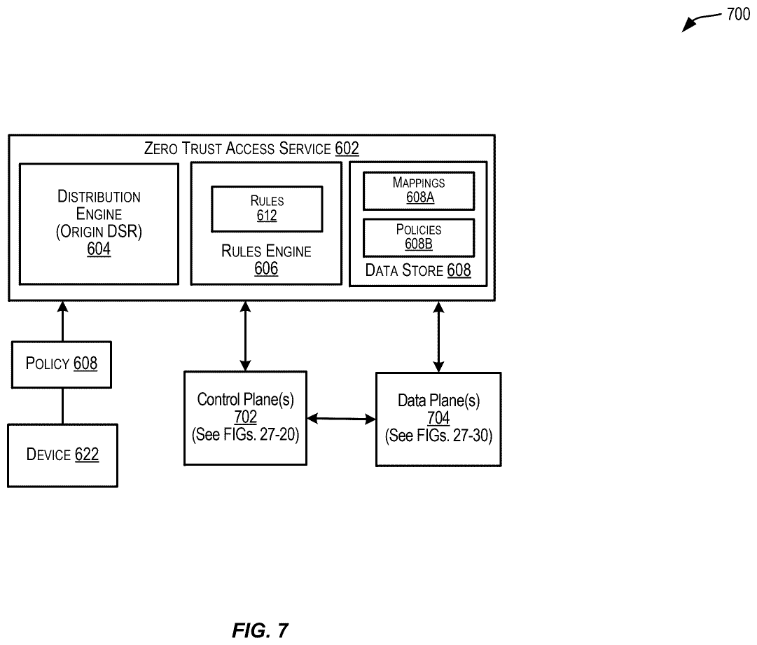

FIG. 7 is a simplified block diagram of an environment 700 illustrating ZTA service 602 interacting with control plane(s) and data plane(s), according to certain embodiments. Environment 700 comprises multiple systems communicatively coupled to each other. The systems in FIG. 7 include ZTA 602, device 622, control plane(s) 702, and data plane(s) 704.

Environment 700 depicted in FIG. 7 is merely an example and is not intended to unduly limit the scope of claimed embodiments. Many variations, alternatives, and modifications are possible. For example, in some implementations, environment 700 may have more or fewer systems or components than those shown in FIG. 7, may combine two or more systems, or may have a different configuration or arrangement of systems. The systems, subsystems, and other components depicted in FIG. 7 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

As discussed above, the rules engine 606 accesses a ZPR policy 608 from a user associated with device 622 and generates rules 612. The distribution engine 604 propagates the rules 612 to the control plane across different regions (not shown). In some configurations, the control plane distributes this data to the various Data Planes. In some configurations, the control plane(s) 702 (See FIGS. 27-30 below) propagate the rules 612 from the ZTA Service 602 to data plane(s) 704. According to some examples, a control plane 702 is maps resources with their associated tags (e.g., EP 610C is mapped to tags “red”, “authorized”, . . . ). In some configurations, the distribution engine 604 propagates rules 612 to different regions (not illustrated).

As briefly discussed above, in some configurations, the control plane 702 assigns an Origin ID to resources that have been tagged. For resources within the network(s) that are not visible to control plane 702, a user can define a resource that can be associated with an Origin ID. In some examples, the presence of an Origin ID within a packet can be used to signal if an EP 610 is subject to ZPR policy evaluation. Generally, an Origin ID is present if the EP has been tagged with a ZPR label.

### Zero Trust Packet Routing Aggregation and Log Ingestion

In some examples, the ZTA service includes services focused on a visibility aspect of ZPR functionality. According to some configurations, the ZTA service ingests information from different systems that enforce ZPR policies and creates an aggregated view of activity across different infrastructure parts based on ingested data.

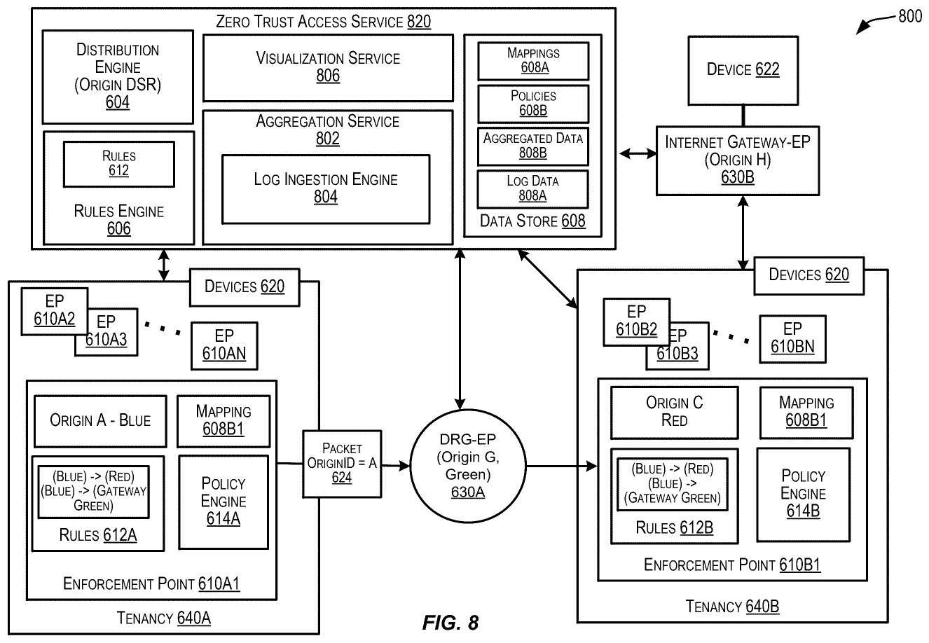

FIG. 8 is a simplified block diagram of an environment 800 illustrating a ZTA service 820 that includes an aggregation service 802 for ingesting and aggregating log data from different sources and a visualization service 806 for providing visualizations of the aggregated data, according to certain embodiments. Environment 800 comprises multiple systems communicatively coupled to each other. The systems in FIG. 8 include zero trust access (ZTA) service 820, enforcement points 610 (e.g., EPs 610A1-610AN, EPs 610B1-610BN, gateways 630), computing devices 620, gateways 630, tenancy 640A, and tenancy 640B.

ZTA service 820 includes distribution engine 604, rules engine 606, data store 608, aggregation service 802 that includes a log ingestion engine 804, and visualization service 806. While distribution engine 604, rules engine 606, data store 608, aggregation service 802, log ingestion engine 804, and visualization service 806 are illustrated as part of the ZTA service 820, one or more of these components may be external from the ZTA service 820. The computing devices 620, which may be referred to herein as “servers 620”, or “server computing devices 620” can include hypervisors (HVs) (not shown) that can host virtual machines (VMs).

Environment 800 depicted in FIG. 8 is merely an example and is not intended to unduly limit the scope of claimed embodiments. Many variations, alternatives, and modifications are possible. For example, in some implementations, environment 800 may have more or fewer systems or components than those shown in FIG. 8, may combine two or more systems, or may have a different configuration or arrangement of systems. The systems, subsystems, and other components depicted in FIG. 8 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

In the embodiments depicted in FIG. 8, novel techniques are described to aggregate log data received from different sources using log ingestion engine 804 and aggregation service 802. The visualization service 806 can provide one or more visualizations. As briefly discussed above, after creating a policy using ZPL, the policy can be enforced throughout the network(s) by EPs, such as EPs 610 and gateways 630 that are distributed at different network points throughout one or more networks.

In some configurations, the ZTA service 820 communicates with the different enforcement points 610 within the network. According to some examples, the ZTA service 820 provides rules 612 to different EPs 610 indicating what policies/rules to enforce. Individual EPs 610 can also communicate with ZTA service 820 to request policies from policies/rules 608B, store data within recorded data 608A, provide resource data (e.g., CPU, storage, . . . ), and the like. In some configurations, the EPs 610 and other enforcement points, can provide log data 808A to the ZTA service 820 that can be ingested by the aggregation service 802.

According to some examples, different EPs 610 may perform different rules/evaluations. For example, tags and attributes (e.g. name) can be evaluated at layer 4 by smartNIC EPs, and L7 attributes (including but not limited to: Path, Request Cookies, Request header, URL query, Request Method, Country/Region, Source IP addresses, Target IP address) can be evaluated at a target service or an egress proxy (e.g, a gateway). For example, as packets are routed through a network, each node within a network can enforce, at Layer 4 and/or Layer 7, ZPR policy defined using ZPL.

As discussed briefly above, the aggregation service 802 receives data, such as log data, via the log ingestion engine 804, that was generated/obtained from different points within the network enforcing one or more ZPR policies. In some cases, the log data 808A can be obtained from one or more data stores, such as from data store 608. In other examples, the log data 808A can be obtained directly from enforcement points within the network, such as from EPs 610.

In some cases, the log ingestion engine 804 receives/accesses log data 808A that may include data such as but not limited to event logs and flow logs. The event logs may include data associated with EPs 610 that perform L7 evaulation. The flow logs may include data associated with EPs that perform L4 evaluation. Stated another way, a flow log represents network traffic at L4 enforcement points, and event logs represent network traffic at L7 enforcement points.

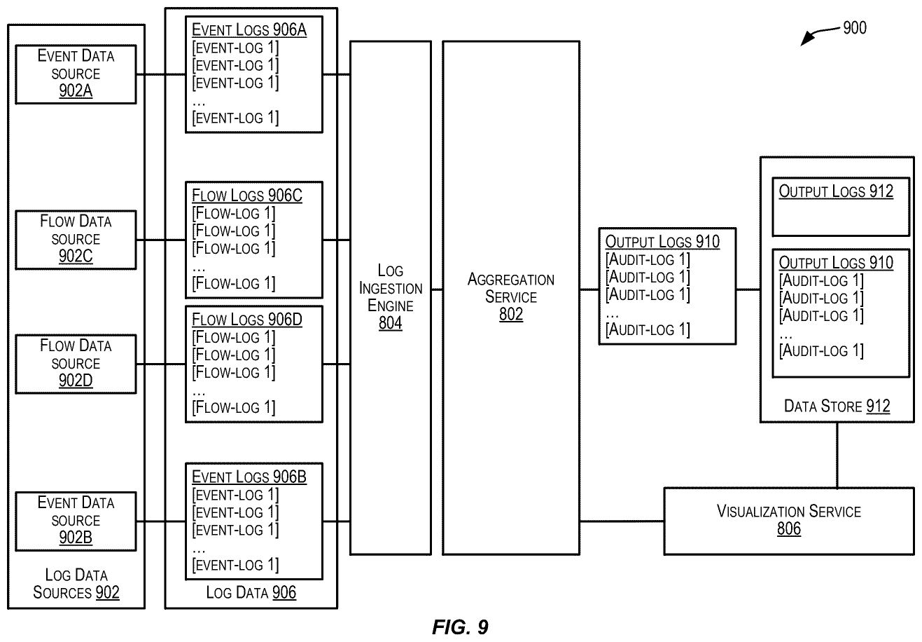

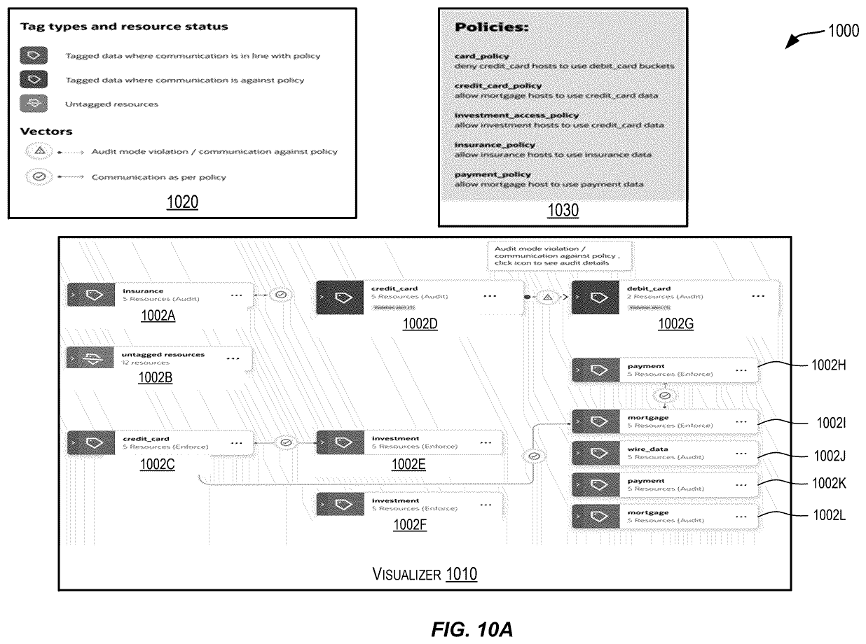

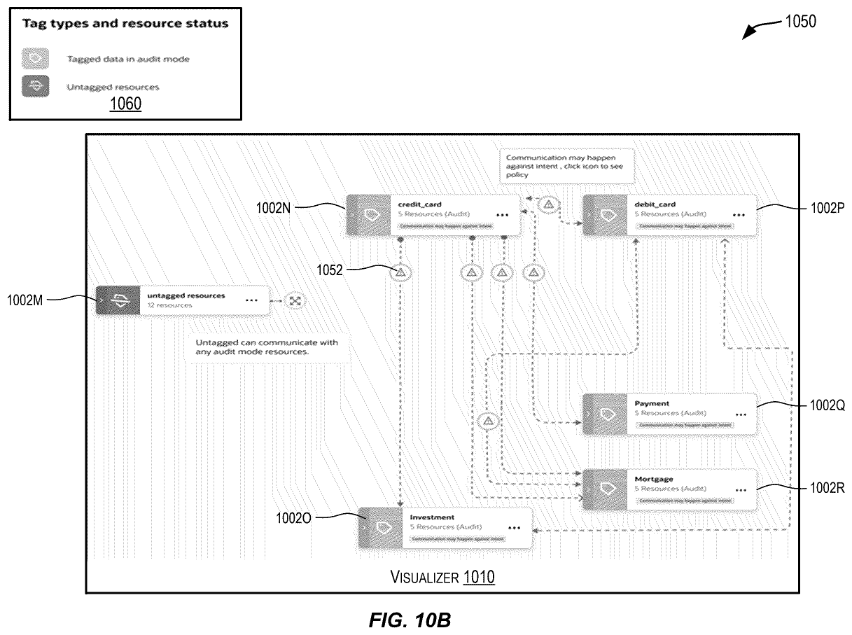

After ingesting the different log data using the log ingestion engine 804, the aggregation service 802 can generate output logs, such as output logs 910 illustrated in FIG. 9. The visualization service 806 uses the output logs to produce one or more visualizations, such as illustrated by FIG. 10A and FIG. 10B. Generally, as will be described in more detail with regard to FIG. 9, the output logs are aggregated logs received from the different sources. In the example of FIG. 8, the policy could be expressed using ZPL as “Allow network-actors blue to communicate through green with network-actors blue”. The rule (Blue)-> (Red) indicated in rules 612A determined from rules engine 606 allows network-actors (e.g., instances, hosts, . . . ) that are tagged “blue” to send/receive packets to endpoints that are tagged “red”. In this example, enforcement point 610A1 performs an egress check to determine if the EP 610B1 is “red” and if traffic is allowed to flow through “green”. In this case, EP 610A1 determines that the rule is satisfied, and to transmit packet 624A to DRG 630A. EP 610A1 may also inject the Origin ID: A into the packet 624A to identify its origin.

The DRG 630A is a gateway EP that determines whether the sender of packet 624A is “blue”, whether the receiver of the packet 624A is “red” and if the gateway 630A that is “green” is authorized to transmit the packet. DRG 630A determines that the transmission of the packet 624A is authorized and transmits packet 624A to EP 610B1. DRG 630A may also inject the identification of “green” into the packet 624A to identify that the packet 624A travelled through a “green” gateway. Upon receiving the packet at EP 610B, an ingress check is performed to determine if the packet traveled through an authorized path. In this case, EP 610B 1 determined that the packet was authorized to travel between the different endpoints and can receive the packet 624A.

In some configurations, the log ingestion engine 802 ingests log data from different data sources, such as but not limited to the identity dataplane (IDDP), IDDP FAT client, networking, container engine for Kubernetes, and the like. According to some examples, the aggregation service 802 calculates aggregations on the log data 808A for the visualization service 806 to visualize policy impact within a user interface, such as a graphical user interface (GUI).

To avoid creating unintended consequences of enforcing a new ZPR policy and/or an updated ZPR policy without testing, a user may select an audit mode to determine how the new ZPR policy and/or an update ZPR policy would be enforced. As discussed above, the audit mode does not enforce ZPR policy but can be used as a dry-run mode for ZPR policies that generates alerts about potential violations in communication patterns (See FIGS. 10A-10B).

Using the audit mode, policies and/or policy statements can be tested within a network environment without enforcing the policies and/or policy statements. For example, a user may create a statement such as “allow color:red network-agent to use color:red buckets”. To test this statement, the statement can be tagged with an identifier (e.g., AUD1T, ALERT-MODE), such as Allow AUD1T any (enforce.color:red, alert.color:red) host to use any (enforce.color:red, alert.color:red) buckets. To enforce this statement, the audit identifier tag can be removed from the statement and be specified as “Allow enforce.color:red host to use enforce.color:red buckets”.

To test enforcement of a ZPR policy, a user can select the audit mode, which in some examples tags policy statements associated with the ZPR policy as being associated with audit mode. The ZTA service 602 may then determine how the ZPR policies would be enforced. For example, when a policy rule is evaluated by an EP 610, log data can be stored that indicates an action that would occur if in audit mode and/or did occur when in enforcement mode. The visualization service 806 can be used to visually understand the impact that a ZPR policy has on the flow of traffic through one or more networks.

In some examples, the visualization service 806 provides different views that are selectable by a user. For instance, the visualization service 806 may provide a policy and tags view and a recent activity view. The policy and tags view can display ZPR policies and tags as a static view that is derived by the ZTA service 602 from ZPR policy and tag configuration. The recent activity view displays an aggregated view of recent activities as determined from the aggregated data collected from various EPs such as IDDP, networking, and the like.

FIG. 9 is a simplified block diagram of an environment 900 illustrating aggregation service that aggregates log data received from different sources, according to certain embodiments. Environment 900 comprises multiple systems communicatively coupled to each other. The systems in FIG. 9 include a log ingestion engine 804, an aggregation service 802, and a visualization service 806. The log ingestion engine 804, the aggregation service 802, and the visualization service 806 can execute on computing devices (not shown) that can host virtual machines (VMs) and/or containers (e.g., K8s). Environment 900 comprises multiple systems communicatively coupled to each other. The systems in FIG. 9 may be part of the zero-trust environment 800 illustrated in FIG. 8.

As discussed briefly above, the aggregation service 802 receives data, such as log data via the log ingestion engine 804, that was generated/obtained from different points within the network enforcing one or more ZPR policies. In some cases, the log data 808A illustrated in FIG. 8 can be obtained from one or more data sources, such as event data sources 902 that provide event logs 906 and flow data sources 902 that provide flow logs 908. The event logs 906 may include data associated with EPs 610 that perform L7 evaluation. The flow logs 908 may include data associated with EPs 610 that perform L4 evaluation. Stated another way, a flow log represents network traffic at L4 enforcement points, and event logs represent network traffic at L7 enforcement points.

In some configurations, the log data 906 comes from different log data sources 902, such as but not limited to the Identity Dataplane (IDDP), IDDP FAT client, networking, Container Engine for Kubernetes, and the like. IN some examples, the IDDP service and IDDP FAT client generate raw debug context logs for application level (L7) and the networking and Kubernetes data are network level (L4) data sources that produce aggregated data based on a defined schema.

The following table outlines exemplary fields that can be included in log data 906, such as log data associated with IDDP ZPR logs.

| Log Field Name | Description | Usage |
|---|---|---|
| ZprEvaluatedTenancies | List of tenancy ids for | This field can be used |
| | which ZPR policies were | to select tenancies that |
| | evaluated in a request. | include ZPR polices that |
| | | were evaluated. |
| | | This field is used to |
| | | separate ZPR logs from |
| | | IDDP logs without ZPR. |
| ZprAuditDebugContext, | Contains information for | Used to identify |
| ZprEnforceDebugContext | policy evaluation in | entities involved in |
| | multiple fields. | request, such as |
| | | tenancies, ZPR tags, |
| | | resources etc. Entity |
| | | information is then |
| | | used to compute |
| | | aggregations for |
| | | visualization. |
| ZprAuditPermissionGrantedBy, | Contains information about | The policy statement id |
| ZprAuditPermissionDeniedBy | ZPR policy statement IDs | can be used to look up |
| ZprEnforcePermissionGrantedBy, | which actively | policy information for |
| ZprEnforcePermissionDeniedBy | granted/denied permission. | visualization. These |
| | These may come from | statements represent |
| | different evaluation scope | the arrow in recent |
| | (host/network/principal/ | activity view. |
| | target). Values in these | |
| | fields, plus ZPR debug | |
| | context fields can be used | |
| | by aggregation service to | |
| | produce aggregations for | |
| | visualizer. | |
| ZprEnforceAuthorizedPermissions, | Contains a list of | Used for computing |
| ZprAuditAuthorizedPermissions | permissions granted for | aggregation for request |
| | enforce and audit mode | outcome. For example, |
| | respectively. | can derive if |
| | There can be two sets of | none/all/some |
| | permissions - one for audit | permissions were |
| | and one for enforce mode | authorized based on |
| | of evaluation. | requested permissions. |
| ZprRequestedPermissions | contains a list of | |
| | permissions requested. | |
| request timestamp | present in debugContext | Used for chronological |
| | fields | ordering in |
| | | aggregations. |

In some configurations, the log data received from the system can be augmented with ZPR information by the log ingestion engine 804, the aggregation service 802, or some other component or device. In some examples, the ZPR information can include the above ZPR fields, that can be added to log data, such as IDDP Logs.

### Flow Log Input Schema

The following is an example flow log input schema associated with LA enforcement points.

| Property | Type | Description |
|---|---|---|
| compartmentId | String | Compartment of the ZPR event |
| sourceOriginId | String | The packet's OriginID |
| sourceTags | String | Mapped from SourceLabelIDs by Flow |
| | | Log Service |
| | | Comma separated, lower_case, sorted |
| | | in alphabetical order, i.e. |
| | | color:red |
| | | color:green, color:red |
| destinationOriginId | String | Destination's OriginID |
| destinationPort | String | Destination's Port |
| destinationTags | String | Mapped from DestinationLabelIDs by |
| | | Flow Log Service |
| | | Comma separated, lower_case, sorted |
| | | in alphabetical order, i.e. |
| | | color:red |
| | | color:green, color:red |
| zprPolicyStatementId | String | Unique Identity for the ZPR policy |
| | | statement which was evaluated |
| networkType | String | Network type on which traffic is |
| | | traversing |
| action | String | ALLOW, DENY |
| mode | String | AUDIT, ENFORCE |
| evalCount | Integer | Number of times the ZPRPolicyState- |
| | | mentId was evaluated in given |
| | | interval |
| startTime | Long | Start time of the capture window in |
| | | Unix epoch seconds |
| endTime | Long | End time of the capture window in |
| | | Unix epoch seconds |
| version | String | Schema version |
| status | String | Status of data capture window |

### Event Log Input Schema

The following is an example event log input schema associated with L7 enforcement points.

| Property | Type | Description |
|---|---|---|
| zprEvaluatedTenancies | List<String> | List of ZPR-enabled tenancy |
| | | ids in a given request. |
| zprAuditDebugContext | String | Representation of Debug |
| | | Context model for audit mode |
| zprEnforceDebugContext | String | Representation of Debug |
| | | Context model for enforce |
| | | mode |
| zprAuditPermissionGrantedBy | List<String> | List of zprPolicyStatementIds |
| | | and contexts that grant |
| | | permission in audit mode for |
| | | that scope of the ZPR event |
| | | Each entry is a hyphen- |
| | | delimited string |
| | | showing action, mode, |
| | | compartment, |
| | | permission, unique id. |
| zprAuditPermissionDeniedBy | List<String> | List of zprPolicyStatementIds |
| | | that deny permission in audit |
| | | mode for that scope of the |
| | | ZPR event |
| | | Each entry is a hyphen- |
| | | delimited string |
| | | showing action, mode, |
| | | compartment, |
| | | permission, unique id. |
| zprEnforcePermissionGrantedBy | List<String> | List of zprPolicyStatementIds |
| | | that grant permission in |
| | | enforce mode for that scope |
| | | of the ZPR event |
| | | Each entry is a hyphen- |
| | | delimited string |
| | | showing action, mode, |
| | | compartment, |
| | | permission, unique id. |
| zprEnforcePermissionDeniedBy | List<String> | List of zprPolicyStatementIds |
| | | that deny permission in |
| | | enforce mode for that scope |
| | | of the ZPR event |
| | | Each entry is a hyphen- |
| | | delimited string |
| | | showing action, mode, |
| | | compartment, |
| | | permission, unique id. |
| zprRequestedPermissions | List<String> | List of permissions needed to |
| | | reach destination (i.e. |
| | | BUCKET_INSPECT) |
| zprAuditAuthorizedPermissions | List<String> | List of permissions authorized |
| | | for destination in audit mode |
| zprEnforceAuthorizedPermissions | List<String> | List of permissions authorized |
| | | for destination in enforce mode |
| debugContext.requesterId | String | Id of original requestor |
| debugContext.requesterType | String | Type of original requestor |
| debugContext.principalId | String | Id of requesting principal |
| debugContext.principalType | String | Type of requesting principal |
| debugContext.principalTenancyId | String | Tenancy Id of requesting |
| | | principal |
| debugContext.targetTenancyId | String | Tenancy Id of target resource |
| debugContext.targetCompartmentId | String | Compartment Id of target |
| | | resource |
| debugContext.targetResourceId | String | Id of target resource (may not |
| | | be present) |
| debugContext.principalTags | Map<String, | ZPR-tags of request principal |
| | Map<String, | |
| | Object>> | |
| debugContext.hostTags | Map<String, | ZPR-tags of host |
| | Map<String, | |
| | Object>> | |
| debugContext.networkTags | Map<String, | ZPR-tags of network path |
| | Map<String, | |
| | Object>> | |
| debugContext.compartmentTags | Map<String, | ZPR-tags of location in zpr |
| | Map<String, | policy statement |
| | Object>> | |
| debugContext.targetTags | Map<String, | ZPR-tags of target resource |
| | Map<String, | |
| | Object>> | |
| debugContext.requestTime | Date | Timestamp of policy |
| | | enforcement |

In some examples, the aggregation service 802 groups the logs into different groupings, such as an L4 grouping and an L7 grouping. The L4 logs can be grouped by the following properties of flow logs: zprPolicyStatementId, action, mode, and compartmentId. The L7 logs can be grouped by the following properties of event logs:
zprAuditPermissionGrantedBy; zprAuditPermissionDeniedBy; zprEnforcePermissionGrantedBy; and zprEnforcePermissionDeniedBy. The L7 grouping can use the zprEvaluatedTenancies property on a log, and determine the associated multi-part policy statement data for each tenancy/compartment by collecting values from the four permission properties where the tenancy is present, and grouping on the unique combination of properties outlined above.

### JSON Skeleton of IDDP Log

The following is an example JSON skeleton of an IDDP log.

JSON skeleton of IDDP Log
{
“msg”: {
“ZprEvaluatedTenancies”: [
“ocid1,ocid2”
],
“ZprAuditDebugContext”: “{\“request.principal.group.tag.oracle-tags.createdon\”:[\“2026-02-
07t17:11:15.352z\”,\“2026-02-18t10:46:50.647z\”,\“2026-02-03t23:09:28.498z\”,\“2026-02-
18t10:26:52.038z\”],\“request.dynamicgroup.id\”:[\“ocid1.dynamicgroup.region1..aaaaaaaayu3t4
3ah234egxdv2raavjf5myr43nn4jr7po6wlin6cl2ww3sya\”,\“ocid1.dynamicgroup.region1..aaaaaaa
ahfhmo2x3gwa54smipob6paxlc7suhmanjm5x3ntukyisk3feevwa\”,\“ocid1.dynamicgroup.region1
..aaaaaaaad3p6a5tos7x3g3xxwupnihma5j3xya7qfa5xodm746qp3jjyhiza\”,\“ocid1.dynamicgroup.
region1..aaaaaaaa3gxibu4yoahcipla3zxlo7tgawqsm3rnmij6i4uvlqvktifjdyka\”],\“target.resource.c
ompartment.tag.dp-test.test-ct-tag-
ns\”:[\“true\”],\“request.domain.name\”:[\“default\”,\“testdomain01\”],\“request.utc-
timestamp.time-of-
day\”:[\“86247581\”],\“request.domain.id\”:[\“ocid1.domain.region1..aaaaaaaa2gxbiffrte5nbo34z
h4ba3xvss4axxyr7qxg4oq7swpwgpdnazva\”,\“ocid1.domain.region1..aaaaaaaaficovtccskvqkp5g
b4kgup4t3xq23unkdsmutohe56tfe4wqtdga\”],\“request.utc-timestamp.day-of-
week\”:[\“thursday\”],\“request.networksource.ipaddr\”:[\“172.24.72.226\”],\“request.principal.do
main.tag.oracle-tags.createdon\”:[\“2026-02-
03t16:55:40.652z\”],\“target.compartment.id\”:[\“ocid1.tenancy.region1..aaaaaaaagyea2mtsppyg6
3nj6mcubnd56hgbzvpquackp7gcwoy5yqqrepyq\”],\“operation.association.reviewed\”:[\“true\”],\
“request.principal.group.tag.oracle-
tags.createdby\”:[\“user@email.com\”],\“request.instance.compartment.id\”:[\“ocid1.compartmen
t.dev..ooooooocomp\”],\“request.networksource.type\”:[\“public\”],\“request.utc-timestamp.day-
of-month\”:[\“28\”],\“request.utc-timestamp.month-of-year\”:[\“3\”],\“request.ad\”:[\“sgda:r1a-ad-
1\”],\“request.user.id\”:[\“ocid1.instance.dev..aaaaaaaaxxxxxxxx\”],\“target.tenant.name\”:[\“dp_s
ecurity_test_henosis\”],\“request.principal.id\”:[\“ocid1.instance.dev..aaaaaaaaxxxxxxxx\”],\“requ
est.utc-timestamp\”:[\“1711670247581\”],\“request.principal.domain.tag.oracle-
tags.updatedon\”:[\“2026-02-
03t16:55:40.652z\”],\“request.principal.type\”:[\“instance\”],\“request.principal.group.tag.oracle-
tags.updatedby\”:[\“user@email.com\”],\“target.compartment.name\”:[\“dp_security_test_henosis
\”],\“request.instance.id\”:[\“ocid1.instance.dev..aaaaaaaaxxxxxxxx\”],\“request.principal.group.ta
g.oracle-tags.updatedon\”:[\“2026-02-07t17:11:15.352z\”,\“2026-02-18t10:46:50.647z\”,\“2026-
02-03t23:09:28.498z\”,\“2026-02-18t10:26:52.038z\”],\“request.principal.domain.tag.oracle-
tags.createdby\”:[\“user@email.com\”],\“request.dynamicgroup.name\”:[\“dgforiptest\”,\“ghtppoy
cqhznslsvbjykcpcufiggvvjjhy0gv\”,\“test_dg\”,\“jr2shovnfik7mewbwkm4jj9q7rn904ukxndhg\”],\
“request.permission\”:[\“db_connect\”],\“target.tenant.id\”:[\“ocid1.tenancy.region1..aaaaaaaagye
a2mtsppyg63nj6mcubnd56hgbzvpquackp7gcwoy5yqqrepyq\”],\“request.tenancy.id\”:[\“ocid1.ten
ancy.region1..aaaaaaaagyea2mtsppyg63nj6mcubnd56hgbzvpquackp7gcwoy5yqqrepyq\”],\“reque
st.region\”:[\“r1a\”],\“request.principal.compartment.id\”:[\“ocid1.compartment.dev..ooooooocom
p\”],\“request.principal.domain.tag.oracle-tags.updatedby\”:[\“user@email.com\”] }“,
“ZprEnforceDebugContext”: ”{\“request.principal.group.tag.oracle-tags.createdon\”:[\“2026-02-
07t17:11:15.352z\”,\“2026-02-18t10:46:50.647z\”,\“2026-02-03t23:09:28.498z\”,\“2026-02-
18t10:26:52.038z\”],\“request.dynamicgroup.id\”:[\“ocid1.dynamicgroup.region1..aaaaaaaayu3t4
3ah234egxdv2raavjf5myr43nn4jr7po6wlin6cl2ww3sya\”,\“ocid1.dynamicgroup.region1..aaaaaaa
ahfhmo2x3gwa54smipob6paxlc7suhmanjm5x3ntukyisk3feevwa\”,\“ocid1.dynamicgroup.region1
..aaaaaaaad3p6a5tos7x3g3xxwupnihma5j3xya7qfa5xodm746qp3jjyhiza\”,\“ocid1.dynamicgroup.
region1..aaaaaaaa3gxibu4yoahcipla3zxlo7tgawqsm3rnmij614uvlqvktifjdyka\”],\“target.resource.c
ompartment.tag.dp-test.test-ct-tag-
ns\”:[\“true\”],\“request.domain.name\”:[\“default\”,\“testdomain01\”],\“request.utc-
timestamp.time-of-
day\”:[\“86247581\”],\“request.domain.id\”:[\“ocid1.domain.region1..aaaaaaaa2gxbiffrte5nbo34z
h4ba3xvss4axxyr7qxg4oq7swpwgpdnazva\”,\“ocid1.domain.region1..aaaaaaaaficovtccskvqkp5g
b4kgup4t3xq23unkdsmutohe56tfe4wqtdga\”],\“request.utc-timestamp.day-of-
week\”:[\“thursday\”],\“request.networksource.ipaddr\”:[\“172.24.72.226\”],\“request.principal.do
main.tag.oracle-tags.createdon\”:[\“2026-02-
03t16:55:40.652z\”],\“target.compartment.id\”:[\“ocid1.tenancy.region1..aaaaaaaagyea2mtsppyg6
3nj6mcubnd56hgbzvpquackp7gcwoy5yqqrepyq\”],\“operation.association.reviewed\”:[\“true\”],\
“request.principal.group.tag.oracle-
tags.createdby\”:[\“user@email.com\”],\“request.instance.compartment.id\”:[\“ocid1.compartmen
t.dev..ooooooocomp\”],\“request.networksource.type\”:[\“public\”],\“request.utc-timestamp.day-
of-month\”:[\“28\”],\“request.utc-timestamp.month-of-year\”:[\“3\”],\“request.ad\”:[\“sgda:r1a-ad-
1\”],\“request.user.id\”:[\“ocid1.instance.dev..aaaaaaaaxxxxxxxx\”],\“target.tenant.name\”:[\“dp_s
ecurity_test_henosis\”],\“request.principal.id\”:[\“ocid1.instance.dev..aaaaaaaaxxxxxxxx\”],\“requ
est.utc-timestamp\”:[\“1711670247581\”],\“request.principal.domain.tag.oracle-
tags.updatedon\”:[\“2026-02-
03t16:55:40.652z\”],\“request.principal.type\”:[\“instance\”],\“request.principal.group.tag.oracle-
tags.updatedby\”:[\“user@email.com\”],\“target.compartment.name\”:[\“dp_security_test_henosis
\”],\“request.instance.id\”:[\“ocid1.instance.dev..aaaaaaaaxxxxxxxx\”],\“request.principal.group.ta
g.oracle-tags.updatedon\”:[\“2026-02-07t17:11:15.352z\”,\“2026-02-18t10:46:50.647z\”,\“2026-
02-03t23:09:28.498z\”,\“2026-02-18t10:26:52.038z\”],\“request.principal.domain.tag.oracle-
tags.createdby\”:[\“user@email.com\”],\“request.dynamicgroup.name\”:[\“dgforiptest\”,\“ghtppoy
cqhznslsvbjykcpcufiggvvjjhy0gv\”,\“test_dg\”,\“jr2shovnfik7mewbwkm4jj9q7rn904ukxndhg\”],\
“request.permission\”:[\“db_connect\”],\“target.tenant.id\”:[\“ocid1.tenancy.region1..aaaaaaaagye
a2mtsppyg63nj6mcubnd56hgbzvpquackp7gcwoy5yqqrepyq\”],\“request.tenancy.id\”:[\“ocid1.ten
ancy.region1..aaaaaaaagyea2mtsppyg63nj6mcubnd56hgbzvpquackp7gcwoy5yqqrepyq\”],\“reque
st.region\”:[\“r1a\”],\“request.principal.compartment.id\”:[\“ocid1.compartment.dev..ooooooocom
p\”],\“request.principal.domain.tag.oracle-tags.updatedby\”:[\“user@email.com\”] }“,
“ZprAuditPermissionGrantedBy”: {
“ocid1.tenancy.region1..aaaaaaaazdfs44q47i6u2zjbdxrt2jfapanjhtkk5yq6ib4uz6ohsfwefwvq”: [
“ALLOW-Customer-
ocid1.tenancy.region1..aaaaaaaazdfs44q47i6u2zjbdxrt2jfapanjhtkk5yq6ib4uz6ohsfwefwvq-
SECRET-SERVICE-MANAGE-NAMESPACE-ocfwra.5”, “ALLOW-Customer-
ocid1.compartment.region1..aaaaaaaazdfdxrt2jfap5yq6ib4uzs44q47i6u2zjb6ohsfwefwvqanjhtkk-
SECRET-SERVICE-MANAGE-NAMESPACE-ocfwra.5” ],
“ocid1.tenancy.region1..aaaaaaaazd44q47i6u2zjb6ohsfwefwvqanjhtkkfdxrt2jfap5yqzjbdxrt”: [
“ALLOW-Customer-
ocid1.compartment.region1..aaaaaaaazdfdxrt2jfap5yq6ib4uzs44q47i6u2zjb6ohsfwefwvqanjhtkk-
SECRET-SERVICE-MANAGE-NAMESPACE-ocfwra.5” ] },
“ZprEnforcePermissionGrantedBy”: {
“ocid1.tenancy.region1..aaaaaaaazdfs44q47i6u2zjbdxrt2jfapanjhtkk5yq6ib4uz6ohsfwefwvq”: [
“ALLOW-Customer-
ocid1.tenancy.region1..aaaaaaaazdfs44q47i6u2zjbdxrt2jfapanjhtkk5yq6ib4uz6ohsfwefwvq-
SECRET-SERVICE-MANAGE-NAMESPACE-ocfwra.5”, “ALLOW-Customer-
ocid1.compartment.region1..aaaaaaaazdfdxrt2jfap5yq6ib4uzs44q47i6u2zjb6ohsfwefwvqanjhtkk-
SECRET-SERVICE-MANAGE-NAMESPACE-ocfwra.5” ],
“ocid1.tenancy.region1..aaaaaaaazd44q47i6u2zjb6ohsfwefwvqanjhtkkfdxrt2jfap5yqzjbdxrt”: [
“ALLOW-Customer-
ocid1.compartment.region1..aaaaaaaazdfdxrt2jfap5yq6ib4uzs44q47i6u2zjb6ohsfwefwvqanjhtkk-
SECRET-SERVICE-MANAGE-NAMESPACE-ocfwra.5” ] },
“ZprEnforceAuthorizedPermissions”: [ “permissionA”, “permissionB” ],
“ZprAuditAuthorizedPermissions”: [ “permissionA”, “permissionB”, “permissionC” ],
“ZprRequestedPermissions”: [ “permissionA”, “permissionB”, “permissionC”, “permissionD” ]
},
//end of msg field
“request”: { },
“opc-request-id”:
}

FIG. 10A shows an example of a graphical user interface (“GUT”) for visualizing enforcement of ZPR policy by a visualization service, according to some examples of the present disclosure. The GUI 1000 exemplifies an interface that may be provided by the visualization service 802 and accessed using the device 622. The GUI 1000 illustrates a resource for visualizing enforcement of ZPR policy.

The GUI 1000 shows a recent activity view of flows of a customer to/from ZPR tagged resources. The GUI 1000 allows a customer to view actual data flows, troubleshoot ZPR policies, and to be able to identify when to change to a ZPR enforce mode. As illustrated, visualizer 1010 includes UI elements 1002A-1002L. UI elements 1002 illustrate ZPR tagged resources (1002A, 1002C-1002L). In the example illustrated, the UI elements 1002A, 1002D, 1002G, and 1002J-1002L are tagged as “AUD1T” and UI elements 1002C, 1002E, 1002F, 1002H, and 1002I are tagged as “ENFORCE”.

Referring to UI element 1002A a checkmark vector is illustrated that indicates “communication as per policy”. The checkmark vector is also illustrated between UI element 1002C and 1002E, and 1002C to 1002H. An audio mode violation is illustrated between UI element 1002D and 1002G. An audit mode violation indicates that there was at least one violation or “communication against the policy”.

In some examples, the UI elements 1002A-1002L can be selected to show information about the individual resources associated with a specific UI element. For example, in response to UI element 1002A being selected, a view (not shown) can be presented that illustrates information about the insurance resources.

FIG. 10B shows an example of a graphical user interface (“GUI”) for visualizing enforcement of ZPR policy by a visualization service, according to some examples of the present disclosure. The GUI 1050 exemplifies an interface that may be provided by the visualization service 802 and accessed using the device 622. The GUI 1050 illustrates a resource for visualizing enforcement of ZPR policy.

The GUI 1050 highlights where data in AUD1T tagged resources could move against policy and/or where no policy is defined. The GUI 1050 allows a customer to review potential communication between resources in audit mode where no ZPR policy exists. A user may also add policy and/or change resources to enforce mode to protect the resources from unwanted communication.

As illustrated, visualizer 1010 includes UI elements 1002M-1002R. UI elements 1002 illustrate ZPR tagged resources (1002M-1002R). In the example illustrated, the UI elements 1002M-1002R are tagged as “AUD1T” and UI element 1002M are untagged resources.

Referring to UI element 1002M an X indicator is illustrated that indicates that it is possible that an untagged resource may be able to communicate with a ZPR tagged resources. Between the other UE elements 1002 illustrated in GUI 1050, dotted lines are illustrated with an indicator 1052 that indicates that there may be communications that may happen against intent. A user can select the UI element to see the policy for the the different resources associated with the UI element.

In some examples, the UI elements 1002M-1002R can be selected to show information about the individual resources associated with a specific UI element. For example, in response to UI element 1002M being selected, a view (not shown) can be presented that illustrates information about the insurance resources.

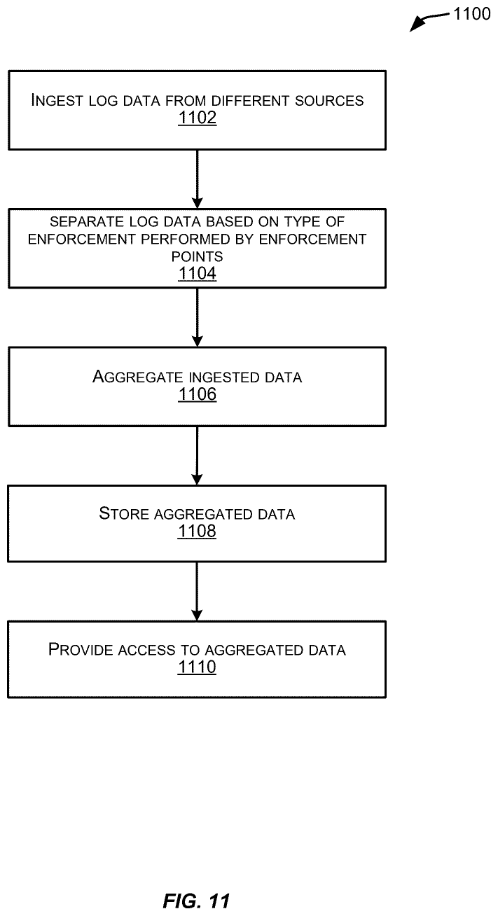

FIG. 11 illustrates an example method for ingesting and aggregating log data from different sources, according to aspects. The method 11000 may be performed by one or more components of the FIGs. A computer-readable storage medium comprising computer-readable instructions that, upon execution by one or more processors of a computing device, cause the computing device to perform the method 1100. The method 1100 may performed in any suitable order. It should be appreciated that the method 1100 may include a greater number or a lesser number of steps than that depicted in FIG. 11.

At 1102, log data is ingested from different sources. As discussed above, the log data can be generated/obtained from different components within one or more networks (e.g., a pod, a VNIC, an EP, a data store, or some other component). In some examples, the log data is obtained from EPs in the network flow between the source of the packet and a destination of the packet.

At 1104, the log data is separated based on the type of enforcement performed by the EPs 610. As discussed above, different EPs 610 can be configured to perform different processing, such as L4 processing and/or L7 processing. Instead of only relying on a receiving device to enforce a network policy, any/all EPs 610 or some other component/device involved in the transmission of the packet may determine whether a packet should be sent to the next hop/destination or prevented from being sent to the next hop/destination. Data can be obtained from each of the different EPs 610.

At 1106, the ingested log data can be aggregated. As discussed above, the aggregation service 802 can generate output logs 910 that can be used by the visualization service 806 to generate one or more to generate one or more views relating to the enforcement of one or more ZPR policies.

At 1108, the aggregated data can be stored. As discussed above, the aggregation service 802 can store the aggregated data 808B in a data store, such as data store 608.

At 1110, access to the aggregated data 808B is provided. As discussed above, access to the aggregated data 808B can be provided to an authorized service, such as the visualization service 806 and/or some other authorized component/user.

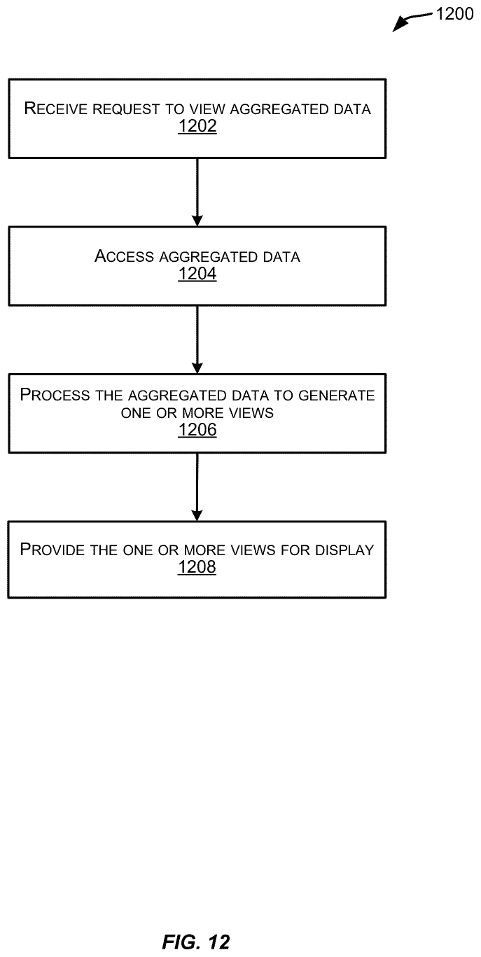

FIG. 12 illustrates an example method for visualizing ZPR enforcement, according to aspects. The method 1200 may be performed by one or more components of the illustrated FIGs. A computer-readable storage medium comprising computer-readable instructions that, upon execution by one or more processors of a computing device, cause the computing device to perform the method 1200. The method 1200 may performed in any suitable order. It should be appreciated that the method 1200 may include a greater number or a lesser number of steps than that depicted in FIG. 12.

At 1202, a request to view the aggregated data is received. As discussed above, the request may be received by a user interface provided by the visualization service 806 and/or received by some other component/device.

At 1204, the aggregated data is accessed. As discussed above, in some examples, the visualization service 806 requests the aggregated data related to one or more ZPR policies via an API, and/or accesses the data from a data store that stores the aggregated data.

At 1206, the aggregated data is processed to generate one or more view. As discussed above, according to some configurations, the visualization service 806 can generate different views based on the aggregated data.

At 1208, one or more views are provided for display. As discussed above, in some configurations, the visualization service 806 can provide a view on a display.

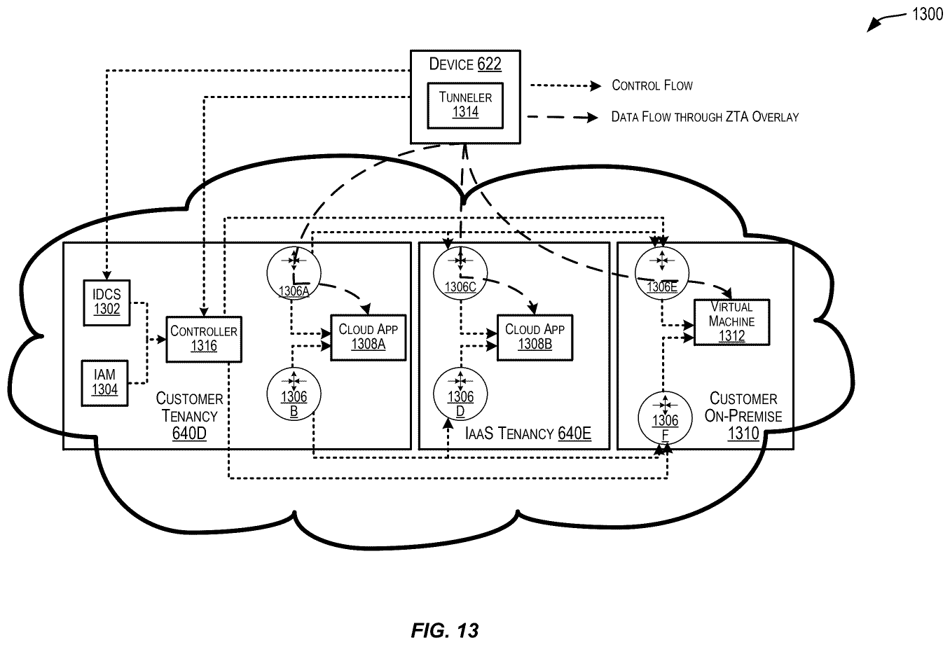

FIG. 13 illustrates a zero-trust network 1300. The zero-trust network 1300 is a software-defined network that operates on top of an existing cloud infrastructure, enabling secure and policy-driven communication between clients, services, and routers. It is designed to implement zero-trust principles, helping to ensure that network interactions are authenticated, authorized, and encrypted to enhance security and access control. In some examples, ZTA zero-trust networks can span multiple environments, including public clouds, private data centers, and on-premises locations, providing a flexible and secure network foundation for various applications and services.

Network 1300 depicted in FIG. 13 is merely an example and is not intended to unduly limit the scope of claimed embodiments. Many variations, alternatives, and modifications are possible. For example, in some implementations, environment 1300 may have more or fewer systems or components than those shown in FIG. 13, may combine two or more systems, or may have a different configuration or arrangement of systems. The systems, subsystems, and other components depicted in FIG. 13 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

As illustrated, the controller 1306 within customer tenancy 640D serves as a central hub of the zero-trust network 1300. In some configurations, the controller 1316 is responsible for configuration, identity management, authentication, and authorization of network connections. According to some examples, the controller 1316 uses a configured public key infrastructure (PKI) to establish secure, mutually authenticated TLS (mTLS) connections between network components. The controller 1316 can use a provided PKI or support third-party PKIs if an operator prefers to reuse an existing one. Example configuration fields for a controller 1316 include fields such as identity, control, edge, and possibly web, or some other field. Identity is a PKI (internal/external) for establishing a mutual transport layer security (mTLS) connection between two ZTA components. Control defines how the controller 1316 listens for incoming connections from routers 1306. This includes the protocol(s) used for router connections and how those connections are managed. Edge instructs the controller 1316 to start edge components and includes features associated with identities (e.g. identity enrollment), 3rd Party CAs, policies, edge router connections, posture checks, and more. The optional Web field defines webListeners that are hosted by the controller 1316. Each webListener can host many APIs and be bound to many bind ports.

Routers 1306 are components of the zero-trust network 1300 that securely and efficiently routing traffic within one or more networks. In some examples, routers 1306, such as routers 1306A-1306F form a mesh network, and continuously/periodically optimize traffic paths for speed and reliability. This dynamic monitoring enables active failover, ensuring a resilient network connection, even in the event of a node failure. The tunneler 1314 is software that is configured to connect applications and securely move data within network 1300.

According to some configurations, the controller 1316 provides the configuration plane. In some examples, the controller 1316 configures services and manages the identities used by users, devices and the nodes making up the network 1300. For instance, the controller 1316 may perform authentication and authorization for each connection in the network 1300.

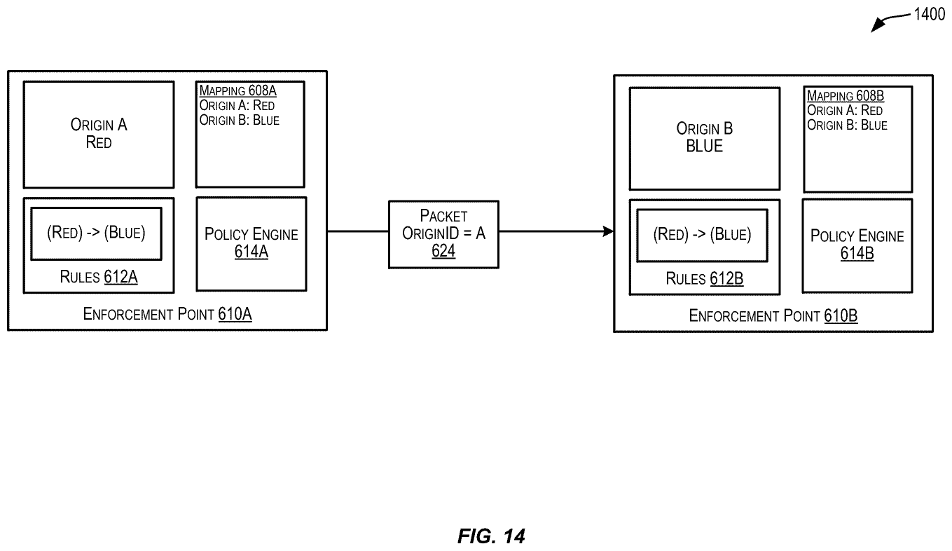

FIG. 14 is a simplified block diagram of an environment 1400 illustrating two enforcement points 610 enforcing rules associated with a ZPR policy, according to certain embodiments. Environment 1400 comprises multiple systems communicatively coupled to each other. The systems in FIG. 14 include enforcement points 610A and 610B.

Environment 1400 depicted in FIG. 14 is merely an example and is not intended to unduly limit the scope of claimed embodiments. Many variations, alternatives, and modifications are possible. For example, in some implementations, environment 1400 may have more or fewer systems or components than those shown in FIG. 14, may combine two or more systems, or may have a different configuration or arrangement of systems. The systems, subsystems, and other components depicted in FIG. 14 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

In the embodiments depicted in FIG. 14, enforcement point 610A includes a policy engine 614, mapping 608A, and rules 612A. Enforcement point 610B includes a policy engine 614B, mapping 608B, and rules 612B. Enforcement point 610A has an assigned origin ID of A and is associated with tag “RED”. Enforcement point 610B has an assigned origin ID of B and is associated with tag “Blue”.

In the example of FIG. 14, the rule (Red)-> (Blue) indicated in rules 612A are based on a ZPL policy statement that allows network-actors that are tagged “red” to send to endpoints that are tagged “blue”. In this example, enforcement point 610A determines if there are any mappings between the source and destination based on the Origin IDs of the enforcement points 610A and 610B. In this case, the mapping 608A indicates that packet 624 is from a source tag of Red and is destined for origin B that is tagged Blue. In this case, the policy engine 614A determines that the rule for “Red to Blue” is allowed and therefore transmits the packet 624 to EP 610B. In this example, since EP 610A is the first hop, the policy engine 614A injects the origin ID of A into a field of the packet 624 before being transmitted.

When packet 624 is received by EP 610B, policy engine 614B applies the rules 612B that are associated with packets received from Origin A. In this case, the policy engine 614B determines that the source OriginID=A is identified in the packet 624 and the mapping 608B indicates that Origin A is Red. Since EP 610A is tagged “red”, and EP 610B is Blue, the packet is allowed to be received. In some examples, return packets from EP 610B to EP 610A are allowed since packet 624 passed the security checks.

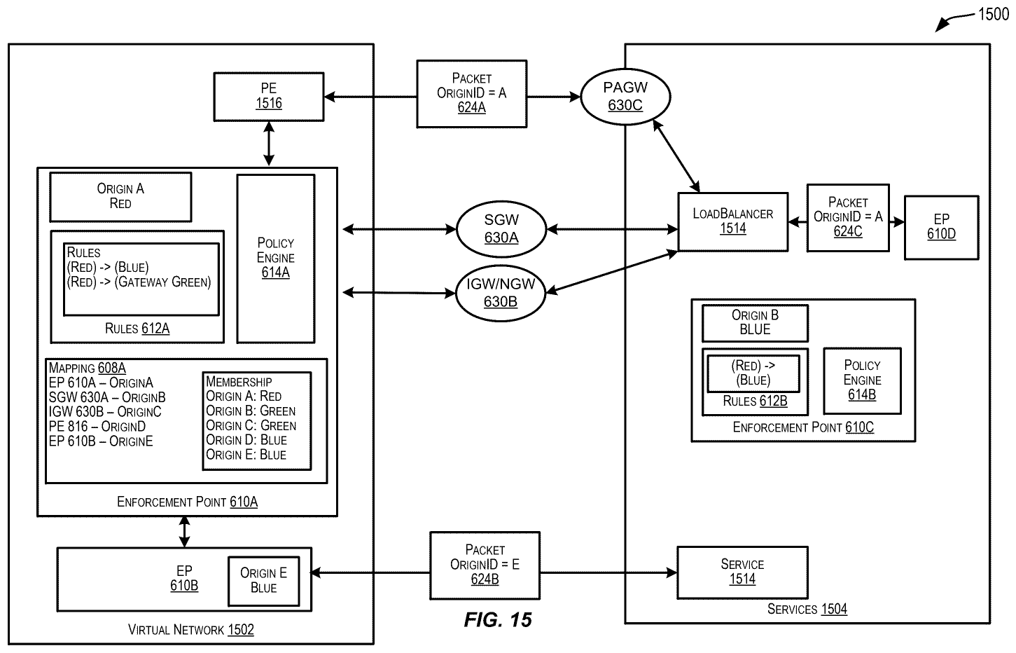

FIG. 15 is a simplified block diagram of an environment 1500 illustrating accessing a cloud-based service from a virtual network (e.g., a tenancy) using ZPR policy, according to certain embodiments. Environment 1500 comprises multiple systems communicatively coupled to each other. The systems in FIG. 15 includes virtual network 1502 (e.g., a customer tenancy of a cloud network), enforcement points that include EP 610A, EP 610B, EP 610C, EP 610D, SGW 630A, IGW 630B, and PAGW 630C.

Environment 1500 depicted in FIG. 15 is merely an example and is not intended to unduly limit the scope of claimed embodiments. Many variations, alternatives, and modifications are possible. For example, in some implementations, environment 1500 may have more or fewer systems or components than those shown in FIG. 15, may combine two or more systems, or may have a different configuration or arrangement of systems. The systems, subsystems, and other components depicted in FIG. 15 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

In the embodiments depicted in FIG. 15, one or more resources within VN 1502 are attempting to access one or more resources of services 1504. In the current example, assume that the policy can be expressed as “Allow network-actors red to access resource blue on network green” and “Allow network-actors red to access endpoints blue on network green”. The policy statement “Allow network-actors red to access resource blue on network green allows resources tagged “red” to access resources tagged “blue” within services 1504. In some examples, the ZTA service 602 is unable to determine the services within services 1504 contain blue resources, so, instead of providing access to specific services with blue resource, this rule can be interpreted as “allow all red network-actors to access all services capable of doing ZPR authentication”. In this way, the final access check performed at the service will correctly verify that only blue resources are accessed within service 1504.

In some examples, EP 610A may access services 1504 using SGW 630A, or IGW 630B, or some other gateway (not shown). According to some cases, users send packets to the public VIP of the load balancer 1514, which are routed through one of the gateway types based on the routing configuration of the user.

In the example illustrated in FIG. 15, services 1504 may also be accessed through private endpoint (PE 1516). According to some examples, a PE, such as PE 1516, instantiates a VNIC in the customer virtual network 1502 that has a private IP address from the customer's VCN space. The customer sends packets to this private address, which is then forwarded to the service providers tenancy.

In some examples, services are reached through SGW 630A. According to some configurations, SGW can be tagged with a classification label by customers. In the current example, EP 610A performs an egress check before transmitting a packet to the SGW 630A. The egress check verifies that traffic is allowed to the SGW classification by an on-network clause (e.g., green in this example) in the ZPR policy. In some examples, when the on-network clause then packets are only allowed through SGWs in the local tenancy.

When an authorized gateway, such as SGW 630A receives the packet, the SGW 630A performs a check to determine if the destination service is allowed by the ZPR policy. In some examples, when the packet is authorized to be transmitted to service 1504, the SGW injects the Origin ID via IP options as described above. In addition to the Origin, when gateways are in the path to the service, a “network classifier” option is be added to IP options in addition to the Origin ID. The network classifier will contain the actual classification labels associated with the gateway path. Services available through a SGW 630A can also be available through IGWs and NGWs using the same/similar techniques as described with regard to SGW 630A.

In this scenario, the service is running on an instance in the service tenancy which is accessed directly from an instance, such as EP 610B created in the customer tenancy, such as virtual network 1502. In this example, the service 1514 ensures that the data classification labels for resources available via the service are propagated to the EP 610B in the customer tenancy (in this example the label Blue) and the customer provides a specific “endpoint” policy as described above.

Assuming these constraints are satisfied, the enforcement of ZPR policy is the same as the host-to-host case of FIG. 14. For the service to do further authorization, however, the Origin ID (e.g., E in this case) via PPv2 in the packet stream sent to the host by the SmartNIC associated with EP 610B.

In the PE 1516 case, packets are forwarded from the PE 1516 to the PAGW 630C that bridges access between the customer tenancy, such as virtual network 1502, the and service provider tenancy, such as services 1504. The PE 1516 inherits the classification labels from the service it fronts and performs ingress enforcement as is done in the Host to Host and Direct VNIC cases. The PE 1516 also preserves the Origin ID on the packet when forwarding from the customer to PAGW. In some cases, the PAGW 630C injects the Origin ID into IP options on an overlay packet when forwarding to the service provider load balancer 1514. The load balancer 1514 then injects the Origin ID into the packet flow.

As briefly discussed above, it may not be possible to readily determine which services are enabled by a particular policy. In these examples, the service receiving the request performs a final check of the full ZPR policy, including a check that the origin of the packet and the network used along the way are allowed to access the requested resource.

The return packet from the service back to the customer also includes an Origin ID. In the PE 1516 or the direct EP 610B access cases, the return Origin ID is the origin of the PE 1516, or EP 610B. In gateway cases, the Origin ID may be an Origin ID in a service tenancy (for an overlay service onboarded to ZPR) or it may be the Origin ID of the gateway for substrate services. In either case, the customer may not have specific policy allowing the return packet based on the classification of the Origin ID. However, rules accessing resources in ZPR can be stateful, which ensures the packet is allowed at the calling EP 610 based on the standard 5-tuple used for stateful flow tracking. In some cases, gateways evaluating the rules associated with ZPR policies do not perform connection tracking and instead do a stateful to stateless conversion. In these cases, the converted rules permit return packets from services through gateways.

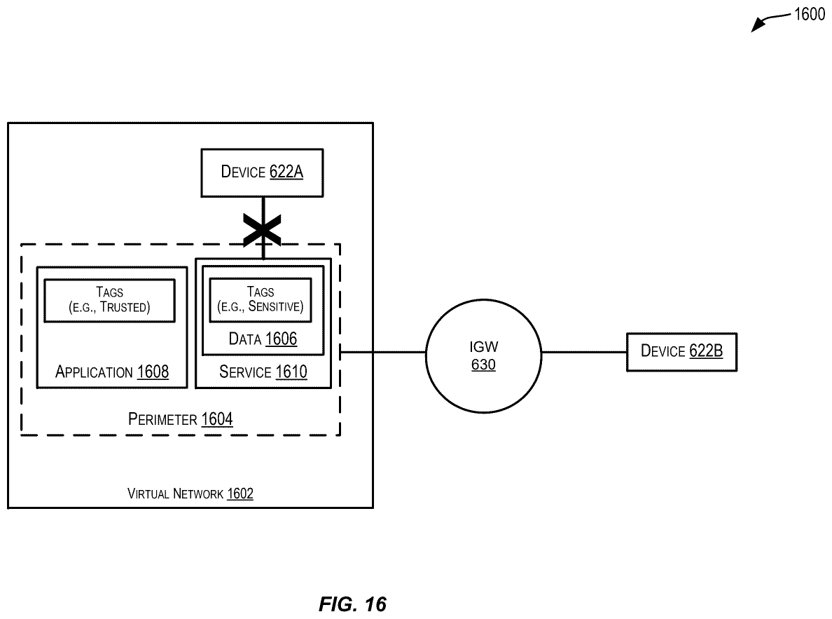

FIG. 16 is a simplified block diagram of an environment 1600 illustrating protecting data using ZPR, according to certain embodiments. Environment 1600 comprises multiple systems communicatively coupled to each other. The systems in FIG. 16 include service 1610 and IGW 630.

Environment 1600 depicted in FIG. 16 is merely a simplified example and is not intended to unduly limit the scope of claimed embodiments. Many variations, alternatives, and modifications are possible. For example, in some implementations, environment 1600 may have more or fewer systems or components than those shown in FIG. 16, may combine two or more systems, or may have a different configuration or arrangement of systems. The systems, subsystems, and other components depicted in FIG. 16 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

In the embodiments depicted in FIG. 16, a perimeter 1604 is created by tagging data 1606 and application 1608 and associating a ZPR policy. As discussed above, the tagging can be performed automatically and/or manually. In some cases, data within a customer tenancy, are automatically tagged such that data is protected without interaction from a customer. To protect the data, the ZPR policy statement can be “Allow trusted hosts to send-receive sensitive data over internal networks”.

In the example of FIG. 16, a non-trusted device 622A (e.g., an internal attacker) attempts to access sensitive data 1606 within service 1610. When service 1610 receives the request from 622A, the service 1610 evaluates the rules (e.g., “Allow trusted hosts to send-receive sensitive data over internal networks”) and drops the request since device 622A is not trusted.

As another example, a non-trusted device 622B (e.g., an external attacker) attempts to access sensitive data 1606 within service 1610. When IGW 630 receives the request from 622B, the IGW 630 evaluates the rules (e.g., “Allow trusted hosts to send-receive sensitive data over internal networks”) and drops the request since device 622B is external to the internal network where data 1606 is located and device 622B is not trusted.

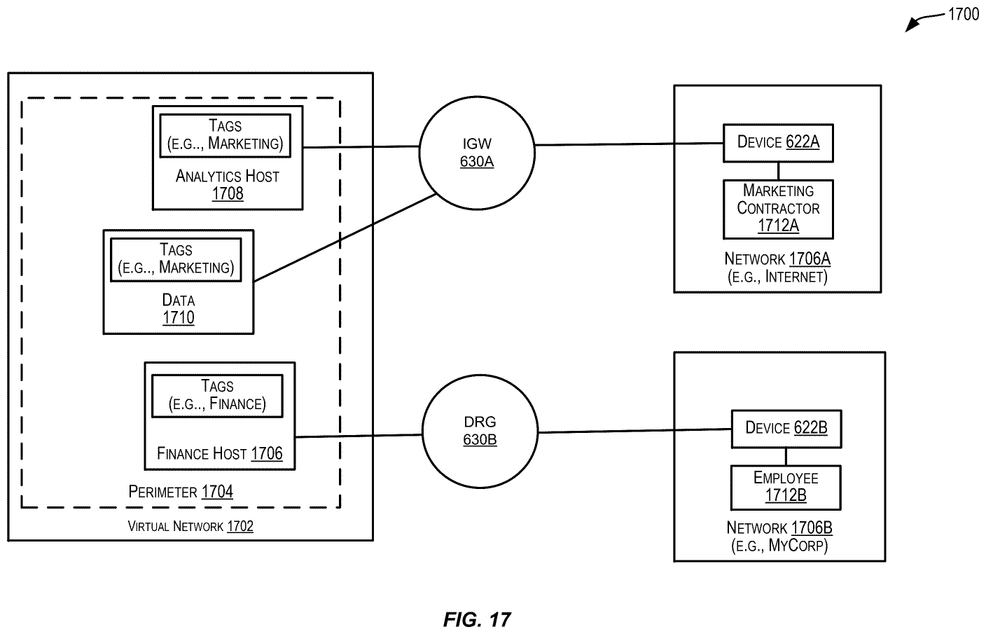

FIG. 17 is a simplified block diagram of an environment 1700 illustrating protecting data using ZPR, according to certain embodiments. Environment 1700 comprises multiple systems communicatively coupled to each other. The systems in FIG. 17 include IGW 630A, DRG 630B, device 622A, device 622B, finance host 1706, analytics host 1708, and data 1710.

Environment 1700 depicted in FIG. 17 is merely a simplified example and is not intended to unduly limit the scope of claimed embodiments. Many variations, alternatives, and modifications are possible. For example, in some implementations, environment 1700 may have more or fewer systems or components than those shown in FIG. 17, may combine two or more systems, or may have a different configuration or arrangement of systems. The systems, subsystems, and other components depicted in FIG. 17 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

In the embodiments depicted in FIG. 17, a perimeter 1704 is created by tagging hosts 1706, 1708, data 1710, and users 1712A and 1712B and associating a ZPR policy. As discussed above, the tagging can be performed automatically and/or manually. To protect the data, the ZPR policy statement can be “Allow marketing_contractor users to access Marketing data over mycorp networks” and “Allow employee users to access Finance data over mycorp networks”.

In the example of FIG. 17, a device 622A associated with a marketing_contractor user 1712A attempts to access data 1710. When IGW 630A receives the request from 622A, the IGW 630A evaluates the rules and drops the request since the network is “Internet” and not the mycorp network.

As another example, a device 622B associated with an employee user 1712A attempts to access data 1710. When DRG 630B receives the request from 622B, the DRG 630B evaluates the rules and allows the request since the network is “mycorp”, the user is an employee, and the request is for the finance data. As can be seen by the above examples, a user does not need to configure rules for each of the different devices. Instead, a simple human-readable policy can be created and stored in one place.

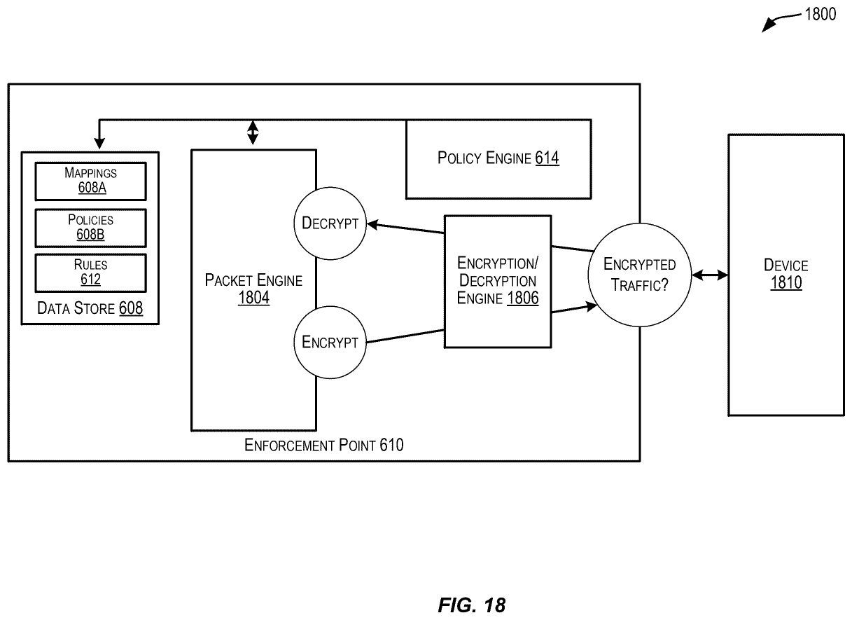

FIG. 18 is a simplified block diagram of an environment 1800 including an enforcement point 610 to enforce network policies/rules in one or more networks, according to embodiments. Environment 1800 comprises multiple systems communicatively coupled to each other. The systems in FIG. 18 include EP 610, and device 1810. EP 610 includes a policy engine 614, and packet engine 1804.

Environment 1800 depicted in FIG. 18 is merely an example and is not intended to unduly limit the scope of claimed embodiments. Many variations, alternatives, and modifications are possible. For example, in some implementations, environment 1800 may have more or fewer systems or components than those shown in FIG. 18, may combine two or more systems, or may have a different configuration or arrangement of systems. The systems, subsystems, and other components depicted in FIG. 18 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

According to some configurations, an EP 610 can be configured to perform many different functions based on the policy that EP 610 is enforcing. In some examples, policy engine 614 is configured to manage enforcement of policies/rules associated with received packets. In the examples depicted in FIG. 18, EP 610 can run on virtual or physical devices that includes computing resources sufficient to perform at least a portion of the processing associated with enforcement of one or more policies/rules. In some configurations, EP 610 is associated with smartNICs and gateways throughout a network. In some configurations, one or more EPs 610 may be associated with a device/component. For instance, an EP 610 may be associated with compute instances within a cloud environment. In some examples, the ZTA service 602 may determine what devices/components are to include an EP 610 based on available resources of the devices/components, whether the devices/components is/will be involved in enforcement of one or more policies, and the like. In some configurations, the ZTA service 602 deploys/activates an EP 610 with any instance/device that will process packets associated with one or more policies/rules.

As illustrated, EP 610 receives/sends packets from/to devices, such as device 1810. In some cases, the received packets may be encrypted. According to some configurations, EP 610 is configured to decrypt and encrypt traffic as it flows using encryption/decryption engine 1806. In some examples, a user/customer of the network authorizes EP 610 to decrypt/encrypt traffic. In these cases, EP 610 may have access to private KEYs to encrypt/decrypt the packets.

The packet engine 1804 is coupled to the policy engine 614. The policy engine 614 may communicate with the ZTA service 602 to receive the mappings 608A, policies 608B and/or rules 612 associated with enforcement of one or more ZPR policies. For example, ZTA service 602, distribution engine 604, or some other component/device may instruct an EP 610 within a smartNIC. Gateway, or some other component device to perform rules 612 associated with one o or more ZPR policies.

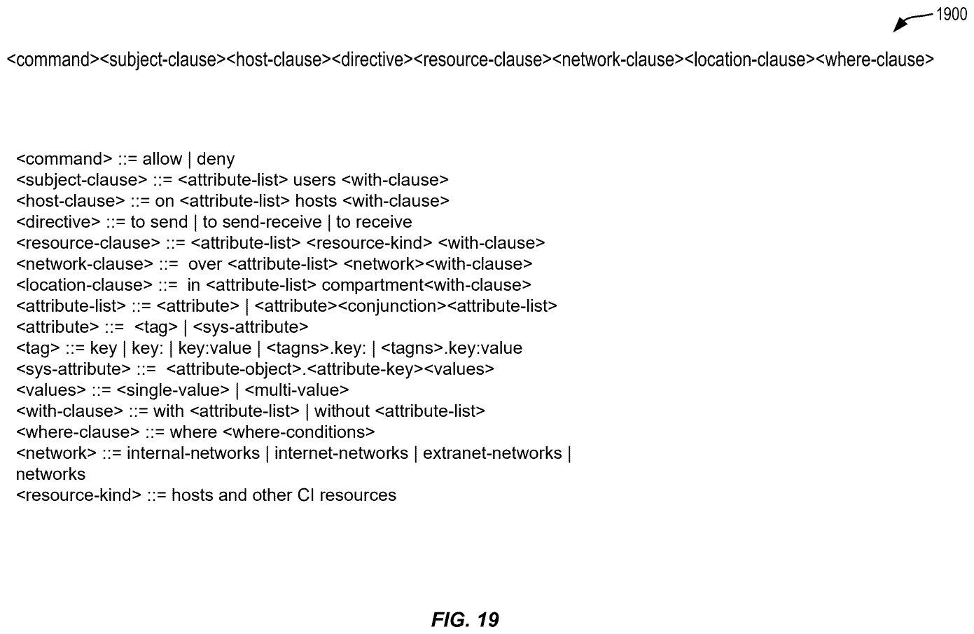

FIG. 19 is a simplified diagram of a syntax 1900 for defining ZPR polices using ZPL, according to embodiments. Syntax 1900 depicted in FIG. 19 is merely an example and is not intended to unduly limit the scope of claimed embodiments. Many variations, alternatives, and modifications are possible.

In some examples, a single policy that is both simple and easy to understand can protect the flow of data throughout one or more networks. As discussed above, ZPL can be used to define policy that specifies who (e.g., users, computing resources) can access data and where that data is allowed to go throughout one or more networks. ZPL allows users to write data-centric, intent-based policies to control data flow thereby protecting data and communications at the network level.

As an example, policy statements can be as simple as “Allow ‘red’ hosts to read ‘blue’ data”, “Allow ‘biz-analysts’ users to use buckets in ‘Analysis’ compartments”, “Allow ‘Business-Analyst’ users on ‘HR-Apps’ hosts to read ‘HR-App-Data’ data over corp-internal network” allows Business-Analyst users on the HR-Apps hosts to read any resource with HR-App-Data tag.

ZPL policy statements are focused on allowing resources (users, compute instances, . . . ) that are tagged, which may be referred to herein as a “ZPR-tag”, to access data that is also tagged. A policy statement may also use multiple tags for example, “allow any (any-ZPR tag, no-ZPR tag) users to manage any (any-ZPR tag,no-ZPR tag) virtual-network-family in compartment c1”, or “allow all (HIPPA, confidential: secret) hosts to use ‘Biz-Analysis’ buckets”.

According to some examples, ZPL integrates with existing policy languages (IAM, NSG, NAP, etc.) by deferring to existing IAM and NSG policy statements. For example, you can have the ZPR statement “allow biz-analysts users on appl hosts to access customer-PII data” and an IAM statement “allow group biz-analysts to use buckets in compartment c1”. The ZPR policy statement allows the network traffic to occur and the IAM policy grants the user permission to the buckets.

According to some configurations, a policy statement can be in the form of: <command><tag><subject>on<tag>hosts to <verb><tag><resource-type>over <tag>network in <location>where any | all {condition}. The command, such as allow | deny specifies whether to allow access or deny access to a resource. The <tag> is used to identify the data, the resources, and users. The <subject> is the principal making the call (e.g., users, dynamic-groups, . . . ). The hosts is a key word for the originating device of the call (e.g., a compute-instance or function). The <Verb> is a meta-verb allowed (e.g., send-receive). The <resource-type> is the resource being accessed (e.g., bucket, database). The <network> is a keyword to restrict the access over only certain gateways (e.g., service gateways (SGW), internet gateways (IGW), . . . ). Generally, any resource can be tagged with one or more tags. For example, a user, a group of users, a computing resource, a group of computing resources, a storage device, a group of storage devices, data, and the like.

The syntax 1900 focuses on having the <tag>before base names (subject, <hosts>, <network>, etc.). (allow | deny)<tag><subject>with <attribute>on<tag>hosts with <tag> to <verb><tag><resource-type>with <attribute>over <tag><network>with <tag>where <where clause>. Tags may be defined by the user and/or be created automatically for different resources. As packets are routed through a network, each node within a network can enforce, at Layer 4 and/or Layer 7, ZPR policy defined using ZPL.

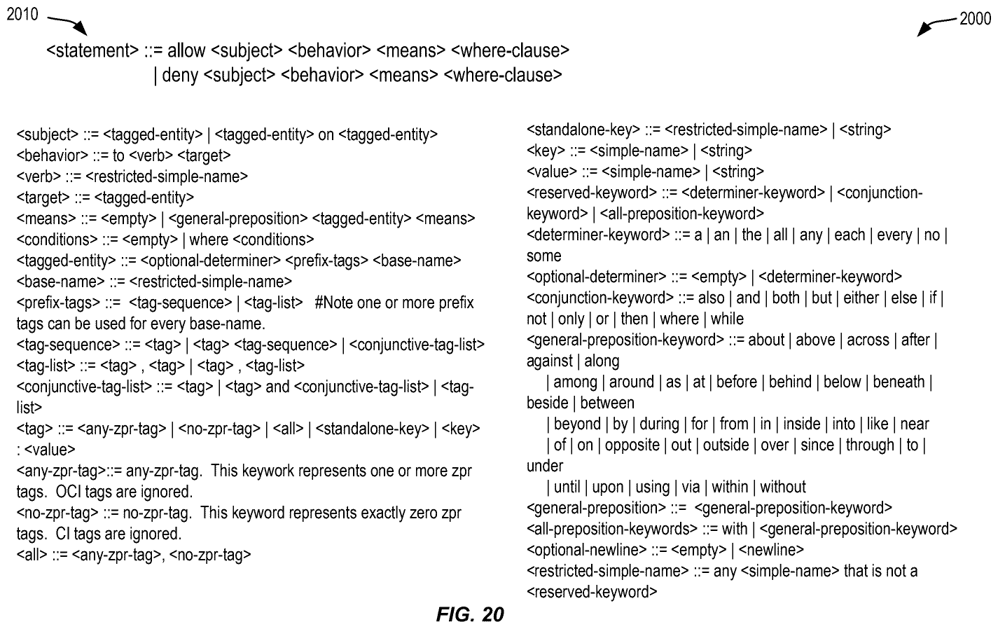

FIG. 20 is a simplified diagram of a syntax 2000 for defining ZPR polices using ZPL, according to embodiments. Syntax 2000 depicted in FIG. 20 is merely an example and is not intended to unduly limit the scope of claimed embodiments. Many variations, alternatives, and modifications are possible.

In some examples, a policy statement, such as <statement>2010 can specify to either allow or deny access to one or more resources based on the content of the statement. As briefly discussed above, ZPL is an easy-to-understand language that is written as a sentence using simple names.

In some configurations, the following English words may be treated as reserved keywords in certain contexts.

### Prepositions:

about above across after against along among around as at before behind below beneath beside between beyond by during for from in inside into like near of on opposite out outside over since through to under until upon using via with within without

### Conjunctions and Related Words:

also and both but either else if not only or then where while

### Determiners:

a an the all any each every no some

In some examples, some simple names may be treated specially (e.g., by rules engine 606 in certain contexts “, which may be referred to herein as “contextual keywords”). A simple name can used as a command, verb, standalone key, or base name if and only if that simple name is not a reserved keyword. Any simple name can be used as the key in a key-value pair or the value in a key-value pair, even if that simple name is a reserved keyword. Any string may be used as a standalone key, even if its content looks like a reserved keyword. Any string may be used as either the key or the value of a key-value pair, even if its content looks like a reserved keyword. In some examples, tags may be limited to reduce memory usage (e.g., VNICs have very limited memory). For instance, if more than a specified number of tags is detected, the compiler will throw an error.

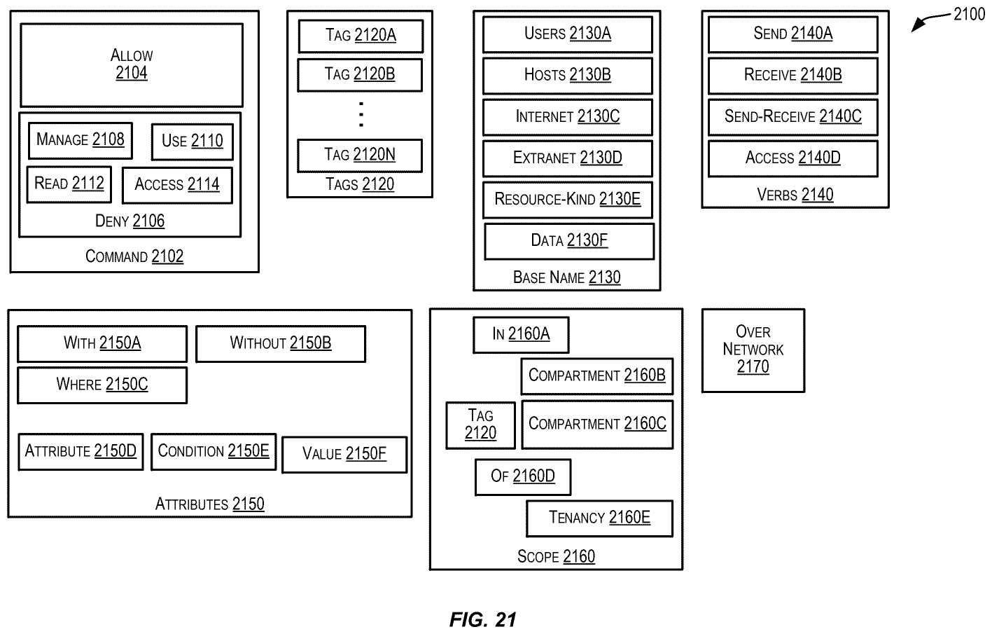

In BNF (Backus-Naur Form) angle brackets surround names of non-terminals (“meta-variables”), the symbol “:: =” means “may be replaced by any of the following alternatives”, and “|” separates alternatives. For clarity, the non-terminal <empty>can be used to make explicit the fact that an alternative may consist of no tokens at all; it is defined by the BNF rule <empty>:: =(which has one alternative, namely no tokens at all). More details regarding different syntax of ZPL is provided with regard to FIG. 21.

FIG. 21 is a simplified diagram that illustrates different components that can be included in a policy statement using ZPL. As discussed above, a policy statement can be in the form of: <command><subject-clause><host-clause><directive><resource-clause><network-clause><location-clause><where-clause>, <command><subject><behavior><means><where-clause>, and the like.

According to some examples, command 2102 includes an allow command 2104 and a deny command 2106. The allow command 2104 specifies to allow access to a resource. The deny command 2106 specifies to deny access to a resource. A deny command 2106 can assist in delegation of duties, deny access to resources, control the flow of traffic within one or more networks, and the like. In some configurations, the deny command 2106 cannot be overridden by other ZPL, IAM, or other networking policy. Existing network security techniques, such as Network Access Protection (NAP) and Identity and Access Management (IAM policy) are not able to do this today. According to some configurations, evaluation of ZPL statements occurs in the following order, deny command 2106, allow command 2104, other policy (e.g., IAM policy (not shown).

Deny command 2106 explicitly denies permissions that are not overridden by other policy statements. Deny commands 2106 follow the same syntax as allow statements. In some configurations, deny commands 2106 are evaluated before any allow commands are evaluated (following the same tree scoping behavior as allow commands). A benefit of evaluating deny commands 2106 before allow commands 2104, is that deny commands 2106 allow users to delegate policy writing to subcompartments without the fear of a subcompartment overriding the intent of the root administrator. Stated another way, when ZPL is used to delegate, the delegator can widen the ZPL allow policy, but they cannot override the deny commands (written in a parent compartment, even if written as IAM policy).

Today, using IAM policy, an IAM statement could say “Allow group x to use buckets in tenancy, but a sub-compartment administrator could write “allow group X to manage buckets in compartment c1 which will grant the manage permission, but only in c1.” In contrast, using ZPL a user can write “deny all users to manage all buckets in tenancy” in the root compartment. A sub-compartment administrator could write the statement “allow group X to manage buckets in compartment c1”, but the enforcement of the policies will never grant the permission “allow group X to manage buckets in compartment c1” because the deny statement 2106 created at the root will deny the request before the allow statement created by the sub-compartment administrator is evaluated.

As another example, assume that an administrator does not want delegates to be able to create or change VCNs or other network resources. A deny commands 2106 such as “deny all users to manage all virtual-network-family in compartment with name=′c1”′ can be used to achieve this restriction. An allow command 2104, such as “allow policy-delegate users to manage all data in compartment c1” could be used to grant the delegates any other operations, except for what is specified in the deny command 2106.

According to some examples, a deny command includes meta-verbs used to determine how to interpret the permissions denied. If customers want to deny only some permissions (e.g, manage) they also write an allow policy as deny would not grant any permissions. The manage meta-verb 2108 does not block inspect, use, and read but denies use and manage. For example, the deny command 2106 “deny all users to manage all virtual-network-family in compartment c1”, would still use an allow command such as “allow blue users to use all virtual-network-family in compartment c1.” The use meta-verb 2110 does not block inspect and read but denies use and manage. The read meta-verb 2112 does not block inspect but denies read, use, and manage. The access meta-verb 2114 grants no access, and prevents other policies (e.g., IAM) from granting any access.

As discussed above, one or more tags 2120 can be used to label resources. For example, a user, a group of users, a computing resource, a group of computing resources, a storage device, a group of storage devices, data, and the like. In some configurations, tags and attributes (e.g. name) can be evaluated at layer 4 by smartNIC EPs, and L7 attributes (including but not limited to: Path, Request Cookies, Request header, URL query, Request Method, Country/Region, Source IP addresses, Target IP address) can be evaluated at a target service or an egress proxy (e.g, a gateway). A policy statement may also use multiple tags 2120 for example, “allow any (any-ZPR tag, no-ZPR tag) users to manage any (any-ZPR tag,no-ZPR tag) virtual-network-family in compartment c1”, or “allow all (HIPPA,confidential: secret) hosts to use ‘Biz-Analysis’ buckets”.

Tags may be defined by the user and/or be created automatically for different resources. A_tag_may be either a_standalone key_or a_key-value pair_. A_key-value pair has the form “key: value”. Whether whitespace appears before the “:” is optional. Whether whitespace appears after the “:” is optional. The term_tagged entity_refers to the combination of a base name and a (possibly empty) set of tags. In some examples, tags may be limited to reduce memory usage (e.g., smartNICS can have limited memory). For instance, if more than a specified number of tags is detected, the rules engine/compiler will throw an error.

If a single tag appears before a base name, the tag is written before the base name with no additional syntax (other than separating whitespace). Examples “red networks”, “region: Europe networks”, “Big Cheese′ users”, “location: ‘New York’ users”. If more than one tag appears before a base name, the tags can be written in sequence, separated by commas, before the base name. Examples: “approved, red networks”, “approved, blue, region: Europe networks”, “authorized, ‘Big Cheese’ users”, “authorized, department: sales, location: ‘New York’ users”. In some examples, a tag means the same thing whether it appears before or after the base name, and the overall order of tags does not matter.

A tagged entity refers to a subset of the class of entities identified by the base name, namely those that have, for every tag listed, an attribute that matches the tag. Thus “authorized, ‘High Priority’, ‘Big Cheese’ users” refers to exactly those users that have attributes matching all of the following tags: authorized, ‘High Priority’, and ‘Big Cheese’. Many tag namespaces may be marked as ZPR tag namespaces. To reference a tag from the non-default tag namespace (ORG-ZPR), a user prefixes the tag namespace name and a period. For example, if the tag namespace “my AuthTags” is marked as a ZPR tag namespace, and it has a tag called clearance, then that tag would be referred to as myAuthtags.clearance. For example, “allow myAuthtags.clearance: secret users to read myAuthtags.clearance buckets”. In some configurations, a tag may be referenced by its key and may or may not include a value. For example, for the tag key “colors”, to reference a specific value of the colors key, the tag may be referenced as “colors: red”. According to some configurations, multiple tags can be referenced by a comma or whitespace as the separator and logically and′d together. Tags may also be conjoined using the with clause with tags prefixing the object. For example, “tag 1, tag2 users with tag3” means users with all three tags tag 1, tag2, and tag3. As another example “authorized ‘High Priority’, ‘Big Cheese’ users” refers to those users that have attributes matching all of the tags authorized, ‘High Priority’, and ‘Big Cheese’.

The base name 2130 refers to a simple name (e.g., a “word”) that may have associated tags. According to some configurations, base name 2130 may include, but are not limited to users 2130A (e.g., “authorized users”), hosts 2130B (e.g., “blue hosts”), internet 2130C (e.g., “all internet networks”), extranet 2130D, resource-kind 2130E (e.g., endpoints, “Customer-app-2′ endpoint”, and data 2130F (e.g., “PII data”).

According to some examples, the verbs 2140 include but are not limited to send 2140A, receive 2140B, send-receive 2140C, and access 2140D. Send 2140A allows for initiating connections (in a stateful networking sense). In some examples, send 2140A defers to IAM and other network policy. Receive 2140B allows for receiving connections (in the stateful networking sense), and in some examples defers to IAM and other network policy. Send-Receive 2140C allows for sending and receiving data (in the stateless networking sense), and in some examples defers to IAM and other network policy. Access 2140D defers to IAM policy and acts like a send-receive as it only allows a L4 connection to be made and does not grant L7 permissions.

Attributes 2150 can be associated with different clauses in ZPL. In some examples, attributes 2150 are supported on users, and data (target resource-kinds & endpoint). An attribute 2150 may be referenced in with clauses 2150A, without clauses 1450B, and where clauses 1450C. Attributes 2150 are referenced in the with clause 2150A by using the attribute name followed by an equals sign and a string (e.g. name= ‘mygroup’). Multiple values my that are logically or′d together may be referenced by using the keyword in, e.g. name in (‘mygroup’, ‘yourgroup’). Some network specific attributes examples include CIDR (v4 & v6), example: cidr= ‘10.10.10.10/12’, IP address (v4 & v6)), example: ip=′140.160.240.12′, Port, example port in (443, 557). And Protocol, example protocol= ‘ICMP’.

Different attributes can be associated with different resources. For instance, example object bucket resource attributes can include, but are not limited to approxmiateCount (int), number of objects, approximateSize (int), autoTiering String, isReadOnly, publicAccessType (string): NoPublicAccess, ObjectRead, ObjectReadWithoutList, StorageTier (String): Standard, Archive, and Versioning: String (Enabled, Suspended, Disabled). Example compute Instance Attributes include, but are not limited to agentConfig, availabilityConfig, availabilityDomain, capacityReservatinold, compartmentID, dedicatedMHostID, displayName, extendedMetadata (object), faultDomain, imageID, instanceOptions (object: areLegacyImdsEndpointsDisabled, (Boolean)), Opc-request-id, ipxeScript, launchMode, aunchOptions (object) (bootValueType, firmware, isConsistent VolumeNamingEnabled, isPvEncryptionInTransitEnabled, networkType, remoteData VolueType), lifecycleState (Moving, Provisingk Running, Stopped, etc.), metadata, platformConfig, preemptibleIsntanceconifg, region, shape, shapeConfig (object), sourceDetails (object), timeCreated, and timeMaintenanceRebootDue).

Attributes are referenced using name=′value′ or name in (<set>) convention. Note that values are string literals and appear within single quotes. For example, attribute= ‘value’ or attribute in (‘value1’, ‘value2’) which is an OR condition.

When referencing an attribute in a where clause 2150C, a more fully qualified name can be used. In some examples, any context variable form IAM policy is also allowed to be used as in a ZPL where clause 2150C. A user can also use attributes (only from users and data (endpoints, resource-kinds) as part of a where clause. The clauses may also support any (or) & all (and) statements The clauses are designed to let users define complex and advanced policy. Syntax for a single condition: variable=|!=value Syntax for multiple conditions: any|all {<condition>,<condition>, . . . } BNF Form:

<where-clause> ::= <condition> | <complex-where-statement>
<condition> ::= <attribute> <operation> <value>
<attribute> ::= <string> | <simple-name>
<operation> ::= = | !=
<value> ::= <string>
<complex-where-statement> ::= <any-all> { <condition-list> }
<any-all> ::= any | all
<condition-list> ::= < condition> | <condition> , <condition-list>

A with clause means those attributes that are applicable to the <base-name>. A without clause has the opposite effect where those attributes must not be on the <base-name>. Some examples include “deny developer users to access development servers without status=′reserved”, “deny developer without k: v”, “deny developer without key”.

The scope 2160 identifies a scope of the policy statement. Scopes can include an In identifier 2160A (e.g., “in compartment c1”), a compartment identifier 2160B (e.g., “in compartment c1”), an Of identifier 2160D (e.g., “of tenancy <tenancy name>” that can be used for admit/endorse for cross tenancy cases), and a tenancy identifier 2160E (e.g., “in tenancy c1”). Some examples include “allow <tag>users to manage <tag>buckets in all compartment c1”, allow <tag>users to manage <tag>buckets in <tag>tenancy “, allow <tag>users to manage <tag>buckets in <tag>compartment c1”, and “allow <tag>users to manage <tag>buckets in <tag>compartment c1: c1.1: c1.1.1”.

The over network clause 2170 within ZPL allows users to specify network locations that can be used for packet flow. In some examples, the network locations are a customer-controlled cloud infrastructure resource that represent a set of network devices. The Over Network Clause 2170 allows users to differentiate their internet traffic from internal cloud infrastructure traffic, and from their extranet traffic and the ability to require traffic goes through SGWs (instead of over the internet). These network devices may include entire VCNs, Corporate Networks, or they may include a specific set of gateways (IGW, SGW, etc) on a particular VCN. They are used in the over network clause to represent a set of network devices. From ZPL's point of view a network location represents just a set of network resources. For example, “allow any-zpr-tag users to manage colors: blue buckets over colors: blue networks in compartment c23” allows any users on any network actor to manage blue buckets, but only if the traffic flows over VCNs and gateways that are in a network location with the blue tag.

In some configurations, users can also write network focused policy using ZPL without IAM/According to some examples, the resource-kind endpoints can be used. Endpoints represent a target host endpoint (e.g., an IP address and port) that default to allowing access to all protocols/ports if they aren't explicitly specified. However, if the resource-kind is internet ZPL will throw an error if a port/protocol is not specified in the statement and fail to save the policy because opening all protocols to the internet is not a secure default. Customer may write policy like this: allow ‘Customer-app-l’ hosts to send-receive ‘Customer-app-2’ endpoint. This allows ‘Customer-app-l’ to talk over any protocol with ‘Customer-app-2’. If they wanted to be a bit more specific, they could write this policy: allow ‘Customer-app-l’ hosts to send-receive ‘Customer-app-2’ endpoint with protocol in (‘HTTP’, ‘SQL’). This further restricts communications to just the HTTP and SQL protocols.

An advantage ZPL is that it is data focused and unifies networking policy and IAM policy. Users can write data centric high-level policy that protects the data from lower-level (NSG, FW, Networking) misconfigurations. Users do not have to keep both L4 and L7 policies in synchronization. Using ZPL a user can define policy that evaluate the host's tag (L4), evaluate the gateway's tag (e.g. network clause), evaluate the port/protocol for egress/ingress protection (L4), protect data from exfil to internet (L4), protect data from exfil to other tenancies (via multi-tenant end points) (L7), write a unified data focused statement that covers L4 & L7 auth (L7), evaluate the target's tag (e.g. database, bucket) (L7), evaluate the user's group tags (L7), evaluate resource-kinds (e.g. database, bucket), enabled data keyword (L7), evaluate OCI L7 permissions (inspect, read, use, manage) (L7), evaluate other context variables (name, etc.) (L7), evaluate location (i.e. compartment) and other scopes (L7), Evaluate L7 attributes (Path, cookies, etc.) (L7), and engress protection based on user/tag target (L7).

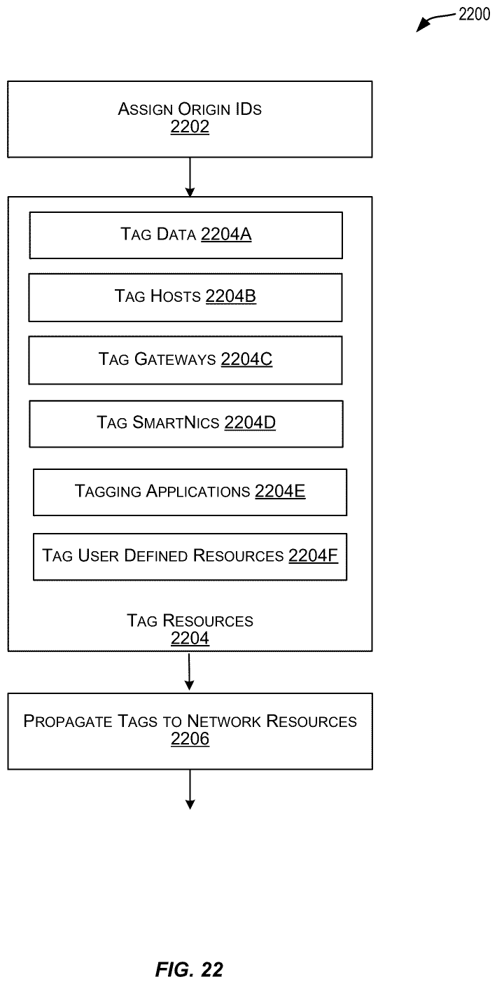

FIG. 22 illustrates an example method 2200 for preparing resources for enforcement of ZPR policy, according to aspects. The method 2200 may be performed by one or more components of FIGS. 1-14 and 27-31. A computer-readable storage medium comprising computer-readable instructions that, upon execution by one or more processors of a computing device, cause the computing device to perform the method 2200. The method 2200 may performed in any suitable order. It should be appreciated that the method 2200 may include a greater number or a lesser number of steps than that depicted in FIG. 22.

At 2202, Origin IDs are assigned to resources within one or more networks. In some configurations, the Data Security Control Plane (DSCP) assigns Origin IDs to each enforcement point within one or more networks. As discussed above, the EPs may include VNICs (e.g., smartNICs), gateways 630, and other resources involved in the transmission of packets in one or more networks.

At 2204, resources are tagged. As discussed above, data and other resources are tagged. Generally, resources can automatically be tagged using data discovery and/or manually by a user. In some examples, users tag resources such as but not limited to client applications (compute instances), IAM principals (groups & dynamic groups), networking gateways, data stored in storage services (e.g., databases, object storage buckets, . . . ), and the like.

In some configurations, users tag resources 2204 such as but not limited to tagging data 2204A stored in storage services (e.g., databases, object storage buckets, . . . ), tagging hosts 2204B, tagging gateways 2204C, tagging smartNICs 2204D, tagging other enforcement points 610 (not shown), tagging applications 2204E (e.g., compute instances), tagging IAM principals (groups & dynamic groups), tagging client defined resources 2204, and the like. As discussed above, resources may have one or more associated tags that include zero or more attributes.

At 2206, the tags are propagated to the network resources. As discussed above, after resources are tagged (e.g., automatically/manually), the tags are propagated by services down to the network resources associated with them. For example, customers may tag a compute instance with a data classification label, and the ZTA service 602 and/or some other device/component propagate these tags to the attached EPs (e.g., VNICs). In some examples, a service may expose an endpoint. In these cases, data classification tags on the service resources can result in VNICs inheriting the data classification label such that L4 network policy implemented at the VNIC results in appropriate enforcement of ZPR policy. Higher level services assign tags to the VNICs they own using one of the Virtual Networking CP APIs.

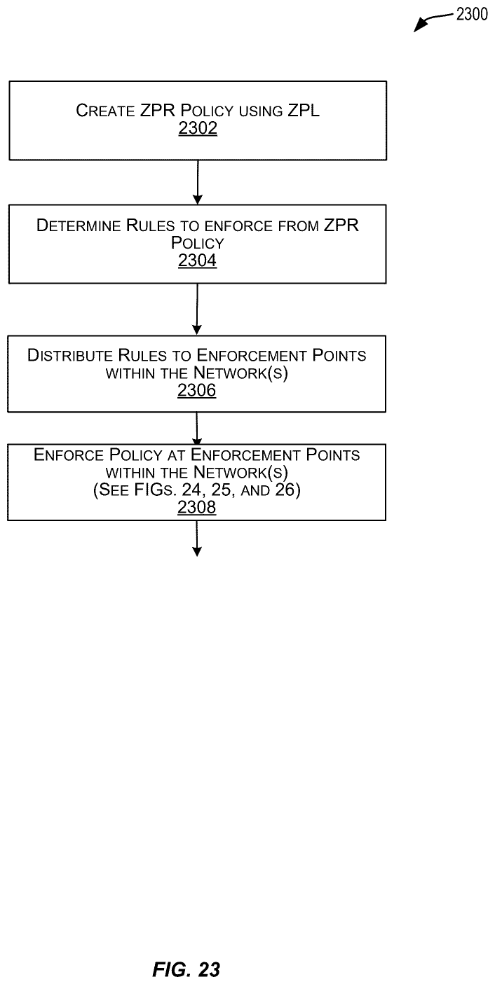

FIG. 23 illustrates an example method 2300 for using ZPL for zero trust packet routing, according to aspects. The method 2300 may be performed by one or more components of FIGS. 1-14 and 27-31. A computer-readable storage medium comprising computer-readable instructions that, upon execution by one or more processors of a computing device, cause the computing device to perform the method 2300. The method 2300 may performed in any suitable order. It should be appreciated that the method 2300 may include a greater number or a lesser number of steps than that depicted in FIG. 23.

At 2302, the ZPR policy is created using ZPL As discussed above, the ZPR policy includes policy statements that use ZPL to declare the security intent for associated with the tagged resources. ZPL can be used to define policy that specifies who (e.g., users, computing resources) can access data and where that data is allowed to go throughout one or more networks. The use of ZPL allows users to write data-centric, intent-based policies to control data flow thereby protecting data and communications at the network level. For example, policy statements can be as simple as “Allow ‘red’ hosts to read ‘blue’ data”, “Allow ‘biz-analysts’ users to use buckets in ‘Analysis’ compartments”, “Allow ‘Business-Analyst’ users on ‘HR-Apps’ hosts to read ‘HR-App-Data’ data over corp-internal network” allows Business-Analyst users on the HR-Apps hosts to read any resource with HR-App-Data tag. According to some configurations, a policy statement can be in the form of: (allow | deny) alert-mode <tag><subject>on<tag>hosts to <verb><tag><resource-type>over <tag>network in <location>where any | all {condition}.

At 2304, the rules to enforce are determined. As discussed above, a rules engine 606 associated with the ZTA service 602 can access a ZPR policy from policies 608B and determine the rules to enforce from an analysis of the policy.

At 2306, the rules are distributed to different enforcement points 610. As discussed above, after determining the rules, the distribution engine 604 can provide and/or make available the rules 612 to the different enforcement points 610 within one or more networks (e.g., smartNICs, gateways, . . . ).

At 2308, the rules are enforced by the enforcement points 610. As discussed above, the rules 612 determined from the policy is enforced at the enforcement points 610 within the one or more network(s). Generally, any resource (e.g., user, application, . . . ) is not allowed to access tagged data unless that resource is also tagged. For example, if the tag “PII” is applied to data stored in object store buckets and databases, then that tagged PII data is protected from any access from the internet and any unTagged users and clients. In some examples, even a user with IAM privileges to the data cannot access the data in any manner if that user does not also have the “PII” tag. Enforcement of the policy rules helps to ensure that only those clients with the appropriate “PII” Tag may access data with the PII Tag. When a client makes a request to the application servers, the packets will have the Origin-ID which the intermediate SmartNICs and the destination services map into the appropriate ZPR-Tags by calling the data classification service.

As the packets route through the network, each of the enforcement points can check the source and destination ZPR Tags against the ZPL policy and either block the packet or sends the packet to the next hop based on the policy. When the packet reaches a gateway, the gateway can perform an additional check and only permits the packets if they are being routed to a resource that includes an EP 610. The EP associated with that resource (e.g., a service) then verifies that the packet originated from an instance with a specific tag is allowed by policy.

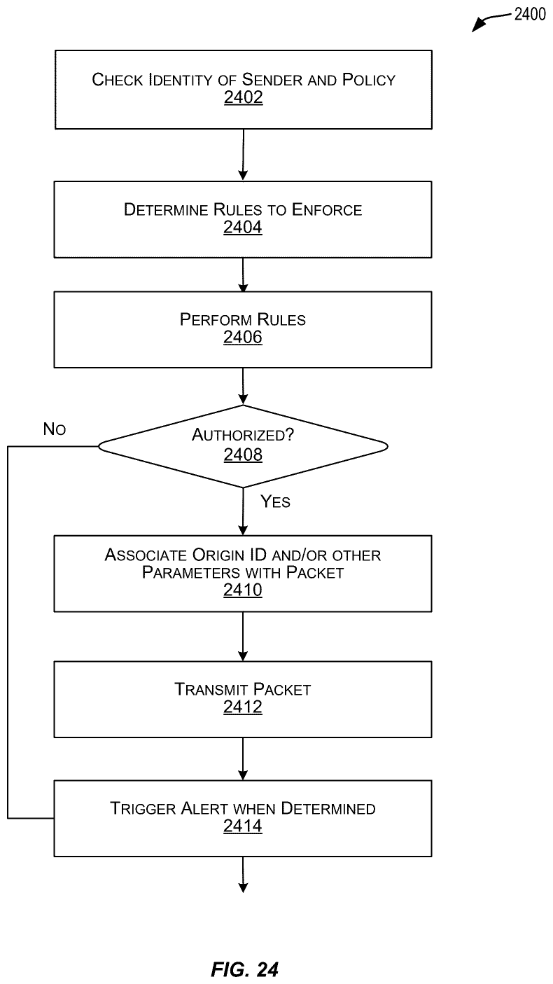

FIG. 24 illustrates an example method 2402 for performing ZPR at a sending EP 610, according to aspects. The method 2400 may be performed by one or more components of FIGS. 1-14 and 27-31. A computer-readable storage medium comprising computer-readable instructions that, upon execution by one or more processors of a computing device, cause the computing device to perform the method 2400. The method 2400 may performed in any suitable order. It should be appreciated that the method 2400 may include a greater number or a lesser number of steps than that depicted in FIG. 24.

At 2402, the identity of the sender is checked along with the policy to enforce. As discussed above, instead of relying on a receiving device to enforce a network policy, the first EP 610 involved in the transmission of the packet may determine whether a packet should be sent to the next hop/destination or prevented from being sent to the next hop/destination.

At 2404, the rules to enforce are determined. As discussed above, the rules 612 may be received from ZTA service 602, the distribution engine 604, and/or from some other device component. As discussed above, the rules 612 are associated with controlling the flow of traffic through the one or more networks. The EP 610 may also receive mappings 608A that indicates tag(s) that are associated with different origins, and what the Origin IDs are for specific component/devices that are configured as EPs 610.

At 2406, the rules are performed. As discussed above, the EP 610 can use policy engine 614 to perform each of the rules associated with the policy. For example, the policy engine 614 can determine if the receiving device at the destination is allowed to receive the packet, if the user/device submitting the request is authorized to send the request, and the like.

At 2408, a determination is made as to whether the EP 610 is authorized to transmit the packet to the next hop/destination. As discussed above, if the EP 610 determines that each of the rules performed passed the specified conditions, then the process flows to 2410. When one or more of the rules do not pass the specified conditions, the process flows to 2414.

At 2410, the sending EP 610 associates the Origin ID and/or one or more other parameters with the packet. As discussed above, the EP 610 may inject the Origin ID of the sending EP 610 into a header of the packet. As an example of other parameters that can be associated with the packet include but are not limited to tags associated with one or more resources, a type of device that is sending the packet, an identifier that indicates a network used to access the EP 610, and the like.

At 2412, the packet is transmitted. As discussed above, in some examples, the EP 610 transmits the packet when authorized based on the policy.

At 2414, an alert may be triggered when determined. As discussed above, in some examples, an alert mode can be used to determine what packets will be allowed/denied without actually preventing a packet from being transmitted/received.

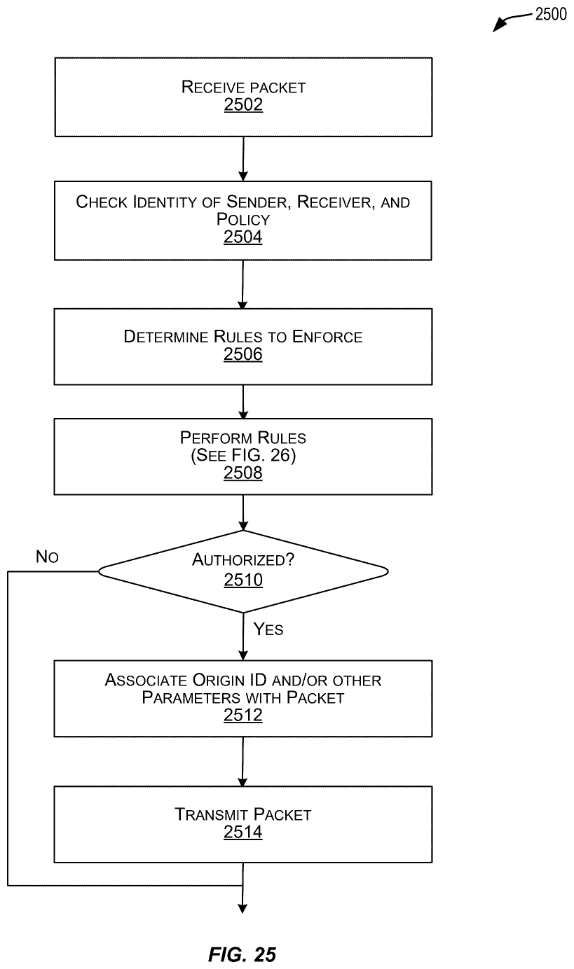

FIG. 25 illustrates an example method 2500 for performing ZPR at a receiving EP 610, according to aspects. The method 2500 may be performed by one or more components of FIGS. 1-14 and 27-31. A computer-readable storage medium comprising computer-readable instructions that, upon execution by one or more processors of a computing device, cause the computing device to perform the method 2500. The method 2500 may performed in any suitable order. It should be appreciated that the method 2500 may include a greater number or a lesser number of steps than that depicted in FIG. 25.

At 2502, a packet is received. As discussed above, the packet can be received from another EP 610 that is in the network flow between the source and destination.

At 2504, the identity of the sender, receiver, and the policy to enforce is checked. As discussed above, instead of only relying on a receiving device to enforce a network policy, any/all EPs 610 involved in the transmission of the packet may determine whether a packet should be sent to the next hop/destination or prevented from being sent to the next hop/destination.

At 2506, the rules to enforce are determined. As discussed above, the rules 612 may be received from ZTA service 602, the distribution engine 604, and/or from some other device component. As discussed above, the rules 612 are associated with controlling the flow of traffic through the one or more networks. The EP 610 may also receive mappings 608A that indicates tag(s) that are associated with different origins, and what the Origin IDs are for specific component/devices that are configured as EPs 610.

At 2508, the rules are performed. As discussed above, the EP 610 can use policy engine 614 to perform each of the rules associated with the policy. For example, the policy engine 614 can determine if the receiving device at the destination is allowed to receive the packet, if the user/device submitting the request is authorized to send the request, and the like.

At 2510, a determination is made as to whether the EP 610 is authorized to transmit the packet to the next hop/destination. As discussed above, if the EP 610 determines that each of the rules performed passed the specified conditions, then the process flows to 2512. When one or more of the rules do not pass the specified conditions, the process flows to 2514.

At 2512, the sending EP 610 associates the Origin ID and/or one or more other parameters with the packet. As discussed above, the EP 610 may inject the Origin ID of the sending EP 610 into a header of the packet. As an example of other parameters that can be associated with the packet include but are not limited to tags associated with one or more resources, a type of device that is sending the packet, an identifier that indicates a network used to access the EP 610, and the like.

At 2514, the packet is transmitted. As discussed above, in some examples, the EP 610 transmits the packet when authorized based on the policy.

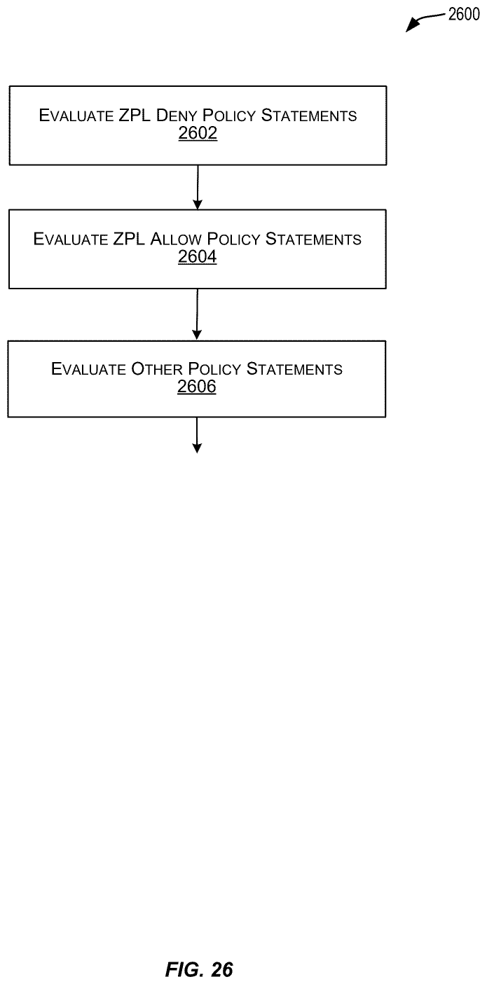

FIG. 26 illustrates an example method 2600 for evaluating ZPL policy statements and other policy statements, according to aspects. The method 2600 may be performed by one or more components of FIGS. 1-14 and 27-31. A computer-readable storage medium comprising computer-readable instructions that, upon execution by one or more processors of a computing device, cause the computing device to perform the method 2600. The method 2600 may performed in any suitable order. It should be appreciated that the method 2600 may include a greater number or a lesser number of steps than that depicted in FIG. 26.

At 2602, the deny policy ZPL statements are evaluated. As discussed above, the rules 612 may be received from ZTA service 602, the distribution engine 604, and/or from some other device component. The EP 610 may also receive mappings 608A that indicates tag(s) that are associated with different origins, and what the Origin IDs are for specific component/devices that are configured as EPs 610. In some configurations, ZPL policy statements are evaluated before other policy statements (e.g., IAM or some other networking policy) such that the ZPL policy statements are enforced before the other networking policy so that the ZPL policy can't be overridden. According to some examples, the ZPL deny statements are evaluated before ZPL allow statements. A benefit of evaluating deny statements 1406 before allow commands 1404, is that deny commands 1406 allow users to delegate policy writing to subcompartments without the fear of a subcompartment overriding the intent of the root administrator.

At 2604, the allow policy ZPL statements are evaluated. As discussed above, the ZPL allow statements are evaluated next.

At 2606, other policy statements are evaluated. As discussed above, the other policy statements may be written using some other networking policy, such as IAM. By evaluating the other policy after the ZPL statements, the IAM will not override the ZPL policy statements.

### Example CSPI Architectures for Providing Cloud Services

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 27 is a block diagram 2700 illustrating an example pattern of an IaaS architecture, according to at least one embodiment. Service operators 2702 can be communicatively coupled to a secure host tenancy 2704 that can include a virtual cloud network (VCN) 2706 and a secure host subnet 2708. In some examples, the service operators 2702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 2706 and/or the Internet.

The VCN 2706 can include a local peering gateway (LPG) 2710 that can be communicatively coupled to a secure shell (SSH) VCN 2712 via an LPG 2710 contained in the SSH VCN 2712. The SSH VCN 2712 can include an SSH subnet 2714, and the SSH VCN 2712 can be communicatively coupled to a control plane VCN 2716 via the LPG 2710 contained in the control plane VCN 2716. Also, the SSH VCN 2712 can be communicatively coupled to a data plane VCN 2718 via an LPG 2710. The control plane VCN 2716 and the data plane VCN 2718 can be contained in a service tenancy 2719 that can be owned and/or operated by the IaaS provider.

The control plane VCN 2716 can include a control plane demilitarized zone (DMZ) tier 2720 that acts as a perimeter network (e.g., portions of a corporate network between the corporate intranet and external networks). The DMZ-based servers may have restricted responsibilities and help keep breaches contained. Additionally, the DMZ tier 2720 can include one or more load balancer (LB) subnet(s) 2722, a control plane app tier 2724 that can include app subnet(s) 2726, a control plane data tier 2728 that can include database (DB) subnet(s) 2730 (e.g., frontend DB subnet(s) and/or backend DB subnet(s)). The LB subnet(s) 2722 contained in the control plane DMZ tier 2720 can be communicatively coupled to the app subnet(s) 2726 contained in the control plane app tier 2724 and an Internet gateway 2734 that can be contained in the control plane VCN 2716, and the app subnet(s) 2726 can be communicatively coupled to the DB subnet(s) 2730 contained in the control plane data tier 2728 and a service gateway 2736 and a network address translation (NAT) gateway 2738. The control plane VCN 2716 can include the service gateway 2736 and the NAT gateway 2738.

The control plane VCN 2716 can include a data plane mirror app tier 2740 that can include app subnet(s) 2726. The app subnet(s) 2726 contained in the data plane mirror app tier 2740 can include a virtual network interface controller (VNIC) 2742 that can execute a compute instance 2744. The compute instance 2744 can communicatively couple the app subnet(s) 2726 of the data plane mirror app tier 2740 to app subnet(s) 2726 that can be contained in a data plane app tier 2746.

The data plane VCN 2718 can include the data plane app tier 2746, a data plane DMZ tier 2748, and a data plane data tier 2750. The data plane DMZ tier 2748 can include LB subnet(s) 2722 that can be communicatively coupled to the app subnet(s) 2726 of the data plane app tier 2746 and the Internet gateway 2734 of the data plane VCN 2718. The app subnet(s) 2726 can be communicatively coupled to the service gateway 2736 of the data plane VCN 2718 and the NAT gateway 2738 of the data plane VCN 2718. The data plane data tier 2750 can also include the DB subnet(s) 2730 that can be communicatively coupled to the app subnet(s) 2726 of the data plane app tier 2746.

The Internet gateway 2734 of the control plane VCN 2716 and of the data plane VCN 2718 can be communicatively coupled to a metadata management service 2752 that can be communicatively coupled to public Internet 2754. Public Internet 2754 can be communicatively coupled to the NAT gateway 2738 of the control plane VCN 2716 and of the data plane VCN 2718. The service gateway 2736 of the control plane VCN 2716 and of the data plane VCN 2718 can be communicatively coupled to cloud services 2756.

In some examples, the service gateway 2736 of the control plane VCN 2716 or of the data plane VCN 2718 can make application programming interface (API) calls to cloud services 2756 without going through public Internet 2754. The API calls to cloud services 2756 from the service gateway 2736 can be one-way: the service gateway 2736 can make API calls to cloud services 2756, and cloud services 2756 can send requested data to the service gateway 2736. But, cloud services 2756 may not initiate API calls to the service gateway 2736.

In some examples, the secure host tenancy 2704 can be directly connected to the service tenancy 2719, which may be otherwise isolated. The secure host subnet 2708 can communicate with the SSH subnet 2714 through an LPG 2710 that may enable two-way communication over an otherwise isolated system. Connecting the secure host subnet 2708 to the SSH subnet 2714 may give the secure host subnet 2708 access to other entities within the service tenancy 2719.

The control plane VCN 2716 may allow users of the service tenancy 2719 to set up or otherwise provision desired resources. Desired resources provisioned in the control plane VCN 2716 may be deployed or otherwise used in the data plane VCN 2718. In some examples, the control plane VCN 2716 can be isolated from the data plane VCN 2718, and the data plane mirror app tier 2740 of the control plane VCN 2716 can communicate with the data plane app tier 2746 of the data plane VCN 2718 via VNICs 2742 that can be contained in the data plane mirror app tier 2740 and the data plane app tier 2746.

In some examples, users of the system, or customers, can make requests, for example create, read, update, or delete (CRUD) operations, through public Internet 2754 that can communicate the requests to the metadata management service 2752. The metadata management service 2752 can communicate the request to the control plane VCN 2716 through the Internet gateway 2734. The request can be received by the LB subnet(s) 2722 contained in the control plane DMZ tier 2720. The LB subnet(s) 2722 may determine that the request is valid, and in response to this determination, the LB subnet(s) 2722 can transmit the request to app subnet(s) 2726 contained in the control plane app tier 2724. If the request is validated and requires a call to public Internet 2754, the call to public Internet 2754 may be transmitted to the NAT gateway 2738 that can make the call to public Internet 2754. Metadata that may be desired to be stored by the request can be stored in the DB subnet(s) 2730.

In some examples, the data plane mirror app tier 2740 can facilitate direct communication between the control plane VCN 2716 and the data plane VCN 2718. For example, changes, updates, or other suitable modifications to configuration may be desired to be applied to the resources contained in the data plane VCN 2718. Via a VNIC 2742, the control plane VCN 2716 can directly communicate with, and can thereby execute the changes, updates, or other suitable modifications to configuration to, resources contained in the data plane VCN 2718.

In some embodiments, the control plane VCN 2716 and the data plane VCN 2718 can be contained in the service tenancy 2719. In this case, the user, or the customer, of the system may not own or operate either the control plane VCN 2716 or the data plane VCN 2718. Instead, the IaaS provider may own or operate the control plane VCN 2716 and the data plane VCN 2718, both of which may be contained in the service tenancy 2719. This embodiment can enable isolation of networks that may prevent users or customers from interacting with other users′, or other customers′, resources. Also, this embodiment may allow users or customers of the system to store databases privately without needing to rely on public Internet 2754, which may not have a desired level of threat prevention, for storage.

In other embodiments, the LB subnet(s) 2722 contained in the control plane VCN 2716 can be configured to receive a signal from the service gateway 2736. In this embodiment, the control plane VCN 2716 and the data plane VCN 2718 may be configured to be called by a customer of the IaaS provider without calling public Internet 2754. Customers of the IaaS provider may desire this embodiment since database(s) that the customers use may be controlled by the IaaS provider and may be stored on the service tenancy 2719, which may be isolated from public Internet 2754.

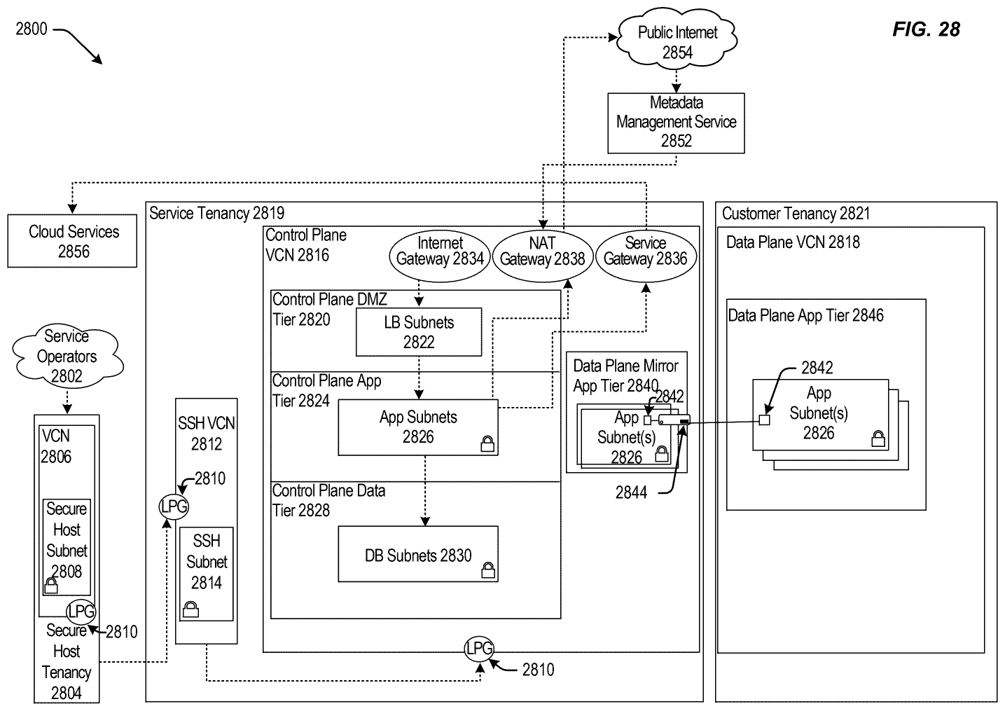

FIG. 28 is a block diagram 2800 illustrating another example pattern of an IaaS architecture, according to at least one embodiment. Service operators 2802 (e.g., service operators 2702 of FIG. 27) can be communicatively coupled to a secure host tenancy 2804 (e.g., the secure host tenancy 2704 of FIG. 27) that can include a virtual cloud network (VCN) 2806 (e.g., the VCN 2706 of FIG. 27) and a secure host subnet 2808 (e.g., the secure host subnet 2708 of FIG. 27). The VCN 2806 can include a local peering gateway (LPG) 2810 (e.g., the LPG 2710 of FIG. 27) that can be communicatively coupled to a secure shell (SSH) VCN 2812 (e.g., the SSH VCN 2712 of FIG. 27) via an LPG 2710 contained in the SSH VCN 2812. The SSH VCN 2812 can include an SSH subnet 2814 (e.g., the SSH subnet 2714 of FIG. 27), and the SSH VCN 2812 can be communicatively coupled to a control plane VCN 2816 (e.g., the control plane VCN 2716 of FIG. 27) via an LPG 2810 contained in the control plane VCN 2816. The control plane VCN 2816 can be contained in a service tenancy 2819 (e.g., the service tenancy 2719 of FIG. 27), and the data plane VCN 2818 (e.g., the data plane VCN 2718 of FIG. 27) can be contained in a customer tenancy 2821 that may be owned or operated by users, or customers, of the system.

The control plane VCN 2816 can include a control plane DMZ tier 2820 (e.g., the control plane DMZ tier 2720 of FIG. 27) that can include LB subnet(s) 2822 (e.g., LB subnet(s) 2722 of FIG. 27), a control plane app tier 2824 (e.g., the control plane app tier 2724 of FIG. 27) that can include app subnet(s) 2826 (e.g., app subnet(s) 2726 of FIG. 27), a control plane data tier 2828 (e.g., the control plane data tier 2728 of FIG. 27) that can include database (DB) subnet(s) 2830 (e.g., similar to DB subnet(s) 2730 of FIG. 27). The LB subnet(s) 2822 contained in the control plane DMZ tier 2820 can be communicatively coupled to the app subnet(s) 2826 contained in the control plane app tier 2824 and an Internet gateway 2834 (e.g., the Internet gateway 2734 of FIG. 27) that can be contained in the control plane VCN 2816, and the app subnet(s) 2826 can be communicatively coupled to the DB subnet(s) 2830 contained in the control plane data tier 2828 and a service gateway 2836 (e.g., the service gateway 2736 of FIG. 27) and a network address translation (NAT) gateway 2838 (e.g., the NAT gateway 2738 of FIG. 27). The control plane VCN 2816 can include the service gateway 2836 and the NAT gateway 2838.

The control plane VCN 2816 can include a data plane mirror app tier 2840 (e.g., the data plane mirror app tier 2740 of FIG. 27) that can include app subnet(s) 2826. The app subnet(s) 2826 contained in the data plane mirror app tier 2840 can include a virtual network interface controller (VNIC) 2842 (e.g., the VNIC of 2742) that can execute a compute instance 2844 (e.g., similar to the compute instance 2744 of FIG. 27). The compute instance 2844 can facilitate communication between the app subnet(s) 2826 of the data plane mirror app tier 2840 and the app subnet(s) 2826 that can be contained in a data plane app tier 2846 (e.g., the data plane app tier 2746 of FIG. 27) via the VNIC 2842 contained in the data plane mirror app tier 2840 and the VNIC 2842 contained in the data plane app tier 2846.

The Internet gateway 2834 contained in the control plane VCN 2816 can be communicatively coupled to a metadata management service 2852 (e.g., the metadata management service 2752 of FIG. 27) that can be communicatively coupled to public Internet 2854 (e.g., public Internet 2754 of FIG. 27). Public Internet 2854 can be communicatively coupled to the NAT gateway 2838 contained in the control plane VCN 2816. The service gateway 2836 contained in the control plane VCN 2816 can be communicatively coupled to cloud services 2856 (e.g., cloud services 2756 of FIG. 27).

In some examples, the data plane VCN 2818 can be contained in the customer tenancy 2821. In this case, the IaaS provider may provide the control plane VCN 2816 for each customer, and the IaaS provider may, for each customer, set up a unique compute instance 2844 that is contained in the service tenancy 2819. Each compute instance 2844 may allow communication between the control plane VCN 2816, contained in the service tenancy 2819, and the data plane VCN 2818 that is contained in the customer tenancy 2821. The compute instance 2844 may allow resources, that are provisioned in the control plane VCN 2816 that is contained in the service tenancy 2819, to be deployed or otherwise used in the data plane VCN 2818 that is contained in the customer tenancy 2821.

In other examples, the customer of the IaaS provider may have databases that live in the customer tenancy 2821. In this example, the control plane VCN 2816 can include the data plane mirror app tier 2840 that can include app subnet(s) 2826. The data plane mirror app tier 2840 can reside in the data plane VCN 2818, but the data plane mirror app tier 2840 may not live in the data plane VCN 2818. That is, the data plane mirror app tier 2840 may have access to the customer tenancy 2821, but the data plane mirror app tier 2840 may not exist in the data plane VCN 2818 or be owned or operated by the customer of the IaaS provider. The data plane mirror app tier 2840 may be configured to make calls to the data plane VCN 2818 but may not be configured to make calls to any entity contained in the control plane VCN 2816. The customer may desire to deploy or otherwise use resources in the data plane VCN 2818 that are provisioned in the control plane VCN 2816, and the data plane mirror app tier 2840 can facilitate the desired deployment, or other usage of resources, of the customer.

In some embodiments, the customer of the IaaS provider can apply filters to the data plane VCN 2818. In this embodiment, the customer can determine what the data plane VCN 2818 can access, and the customer may restrict access to public Internet 2854 from the data plane VCN 2818. The IaaS provider may not be able to apply filters or otherwise control access of the data plane VCN 2818 to any outside networks or databases. Applying filters and controls by the customer onto the data plane VCN 2818, contained in the customer tenancy 2821, can help isolate the data plane VCN 2818 from other customers and from public Internet 2854.

In some embodiments, cloud services 2856 can be called by the service gateway 2836 to access services that may not exist on public Internet 2854, on the control plane VCN 2816, or on the data plane VCN 2818. The connection between cloud services 2856 and the control plane VCN 2816 or the data plane VCN 2818 may not be live or continuous. Cloud services 2856 may exist on a different network owned or operated by the IaaS provider. Cloud services 2856 may be configured to receive calls from the service gateway 2836 and may be configured to not receive calls from public Internet 2854. Some cloud services 2856 may be isolated from other cloud services 2856, and the control plane VCN 2816 may be isolated from cloud services 2856 that may not be in the same region as the control plane VCN 2816. For example, the control plane VCN 2816 may be located in “Region 1,” and cloud service “Deployment 11,” may be located in Region 1 and in “Region 2.” If a call to Deployment 11 is made by the service gateway 2836 contained in the control plane VCN 2816 located in Region 1, the call may be transmitted to Deployment 11 in Region 1. In this example, the control plane VCN 2816, or Deployment 11 in Region 1, may not be communicatively coupled to, or otherwise in communication with, Deployment 11 in Region 2.

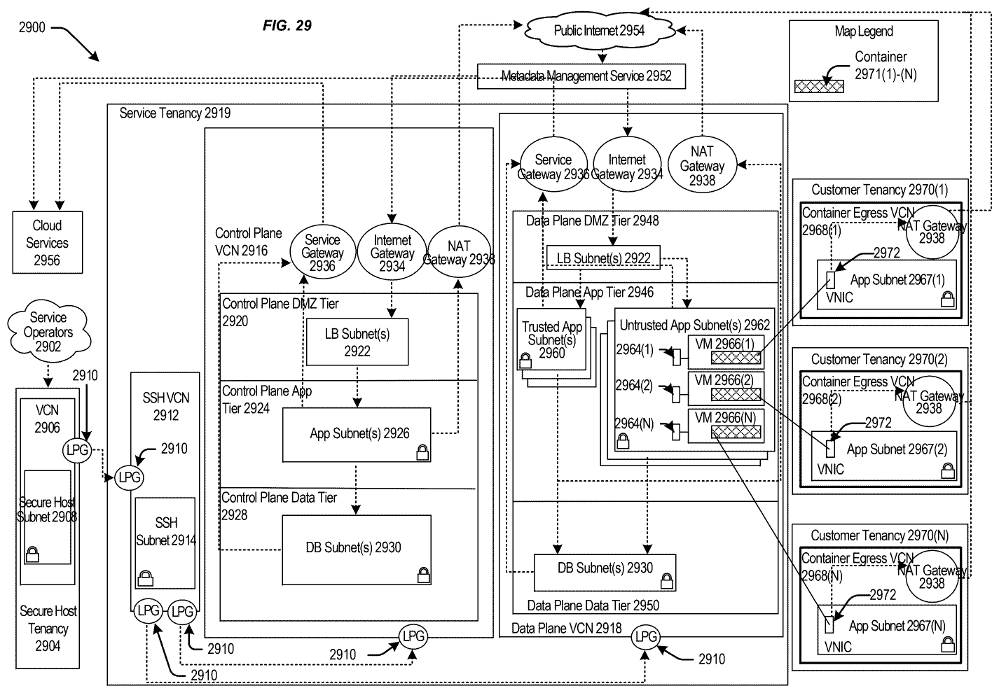

FIG. 29 is a block diagram 2900 illustrating another example pattern of an IaaS architecture, according to at least one embodiment. Service operators 2902 (e.g., service operators 2702 of FIG. 27) can be communicatively coupled to a secure host tenancy 2904 (e.g., the secure host tenancy 2704 of FIG. 27) that can include a virtual cloud network (VCN) 2906 (e.g., the VCN 2706 of FIG. 27) and a secure host subnet 2908 (e.g., the secure host subnet 2708 of FIG. 27). The VCN 2906 can include an LPG 2910 (e.g., the LPG 2710 of FIG. 27) that can be communicatively coupled to an SSH VCN 2912 (e.g., the SSH VCN 2712 of FIG. 27) via an LPG 2910 contained in the SSH VCN 2912. The SSH VCN 2912 can include an SSH subnet 2914 (e.g., the SSH subnet 2714 of FIG. 27), and the SSH VCN 2912 can be communicatively coupled to a control plane VCN 2916 (e.g., the control plane VCN 2716 of FIG. 27) via an LPG 2910 contained in the control plane VCN 2916 and to a data plane VCN 2918 (e.g., the data plane 2718 of FIG. 27) via an LPG 2910 contained in the data plane VCN 2918. The control plane VCN 2916 and the data plane VCN 2918 can be contained in a service tenancy 2919 (e.g., the service tenancy 2719 of FIG. 27).

The control plane VCN 2916 can include a control plane DMZ tier 2920 (e.g., the control plane DMZ tier 2720 of FIG. 27) that can include load balancer (LB) subnet(s) 2922 (e.g., LB subnet(s) 2722 of FIG. 27), a control plane app tier 2924 (e.g., the control plane app tier 2724 of FIG. 27) that can include app subnet(s) 2926 (e.g., similar to app subnet(s) 2726 of FIG. 27), a control plane data tier 2928 (e.g., the control plane data tier 2728 of FIG. 27) that can include DB subnet(s) 2930. The LB subnet(s) 2922 contained in the control plane DMZ tier 2920 can be communicatively coupled to the app subnet(s) 2926 contained in the control plane app tier 2924 and to an Internet gateway 2934 (e.g., the Internet gateway 2734 of FIG. 27) that can be contained in the control plane VCN 2916, and the app subnet(s) 2926 can be communicatively coupled to the DB subnet(s) 2930 contained in the control plane data tier 2928 and to a service gateway 2936 (e.g., the service gateway of FIG. 27) and a network address translation (NAT) gateway 2938 (e.g., the NAT gateway 2738 of FIG. 27). The control plane VCN 2916 can include the service gateway 2936 and the NAT gateway 2938.

The data plane VCN 2918 can include a data plane app tier 2946 (e.g., the data plane app tier 2746 of FIG. 27), a data plane DMZ tier 2948 (e.g., the data plane DMZ tier 2748 of FIG. 27), and a data plane data tier 2950 (e.g., the data plane data tier 2750 of FIG. 27). The data plane DMZ tier 2948 can include LB subnet(s) 2922 that can be communicatively coupled to trusted app subnet(s) 2960 and untrusted app subnet(s) 2962 of the data plane app tier 2946 and the Internet gateway 2934 contained in the data plane VCN 2918. The trusted app subnet(s) 2960 can be communicatively coupled to the service gateway 2936 contained in the data plane VCN 2918, the NAT gateway 2938 contained in the data plane VCN 2918, and DB subnet(s) 2930 contained in the data plane data tier 2950. The untrusted app subnet(s) 2962 can be communicatively coupled to the service gateway 2936 contained in the data plane VCN 2918 and DB subnet(s) 2930 contained in the data plane data tier 2950. The data plane data tier 2950 can include DB subnet(s) 2930 that can be communicatively coupled to the service gateway 2936 contained in the data plane VCN 2918.

The untrusted app subnet(s) 2962 can include one or more primary VNICs 2964 (1)-(N) that can be communicatively coupled to tenant virtual machines (VMs) 2966 (1)-(N). Each tenant VM 2966(1)-(N) can be communicatively coupled to a respective app subnet 2967(1)-(N) that can be contained in respective container egress VCNs 2968(1)-(N) that can be contained in respective customer tenancies 2970(1)-(N). Respective secondary VNICs 2972(1)-(N) can facilitate communication between the untrusted app subnet(s) 2962 contained in the data plane VCN 2918 and the app subnet contained in the container egress VCNs 2968(1)-(N). Each container egress VCNs 2968(1)-(N) can include a NAT gateway 2938 that can be communicatively coupled to public Internet 2954 (e.g., public Internet 2754 of FIG. 27). The Internet gateway 2934 contained in the control plane VCN 2916 and contained

in the data plane VCN 2918 can be communicatively coupled to a metadata management service 2952 (e.g., the metadata management system 2752 of FIG. 27) that can be communicatively coupled to public Internet 2954. Public Internet 2954 can be communicatively coupled to the NAT gateway 2938 contained in the control plane VCN 2916 and contained in the data plane VCN 2918. The service gateway 2936 contained in the control plane VCN 2916 and contained in the data plane VCN 2918 can be communicatively coupled to cloud services 2956.

In some embodiments, the data plane VCN 2918 can be integrated with customer tenancies 2970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 2946. Code to run the function may be executed in the VMs 2966(1)-(N), and the code may not be configured to run anywhere else on the data plane VCN 2918. Each VM 2966(1)-(N) may be connected to one customer tenancy 2970. Respective containers 2971(1)-(N) contained in the VMs 2966(1)-(N) may be configured to run the code. In this case, there can be a dual isolation (e.g., the containers 2971(1)-(N) running code, where the containers 2971(1)-(N) may be contained in at least the VM 2966(1)-(N) that are contained in the untrusted app subnet(s) 2962), which may help prevent incorrect or otherwise undesirable code from damaging the network of the IaaS provider or from damaging a network of a different customer. The containers 2971(1)-(N) may be communicatively coupled to the customer tenancy 2970 and may be configured to transmit or receive data from the customer tenancy 2970. The containers 2971(1)-(N) may not be configured to transmit or receive data from any other entity in the data plane VCN 2918. Upon completion of running the code, the IaaS provider may kill or otherwise dispose of the containers 2971(1)-(N).

In some embodiments, the trusted app subnet(s) 2960 may run code that may be owned or operated by the IaaS provider. In this embodiment, the trusted app subnet(s) 2960 may be communicatively coupled to the DB subnet(s) 2930 and be configured to execute CRUD operations in the DB subnet(s) 2930. The untrusted app subnet(s) 2962 may be communicatively coupled to the DB subnet(s) 2930, but in this embodiment, the untrusted app subnet(s) may be configured to execute read operations in the DB subnet(s) 2930. The containers 2971(1)-(N) that can be contained in the VM 2966(1)-(N) of each customer and that may run code from the customer may not be communicatively coupled with the DB subnet(s) 2930.

In other embodiments, the control plane VCN 2916 and the data plane VCN 2918 may not be directly communicatively coupled. In this embodiment, there may be no direct communication between the control plane VCN 2916 and the data plane VCN 2918. However, communication can occur indirectly through at least one method. An LPG 2910 may be established by the IaaS provider that can facilitate communication between the control plane VCN 2916 and the data plane VCN 2918. In another example, the control plane VCN 2916 or the data plane VCN 2918 can make a call to cloud services 2956 via the service gateway 2936. For example, a call to cloud services 2956 from the control plane VCN 2916 can include a request for a service that can communicate with the data plane VCN 2918.

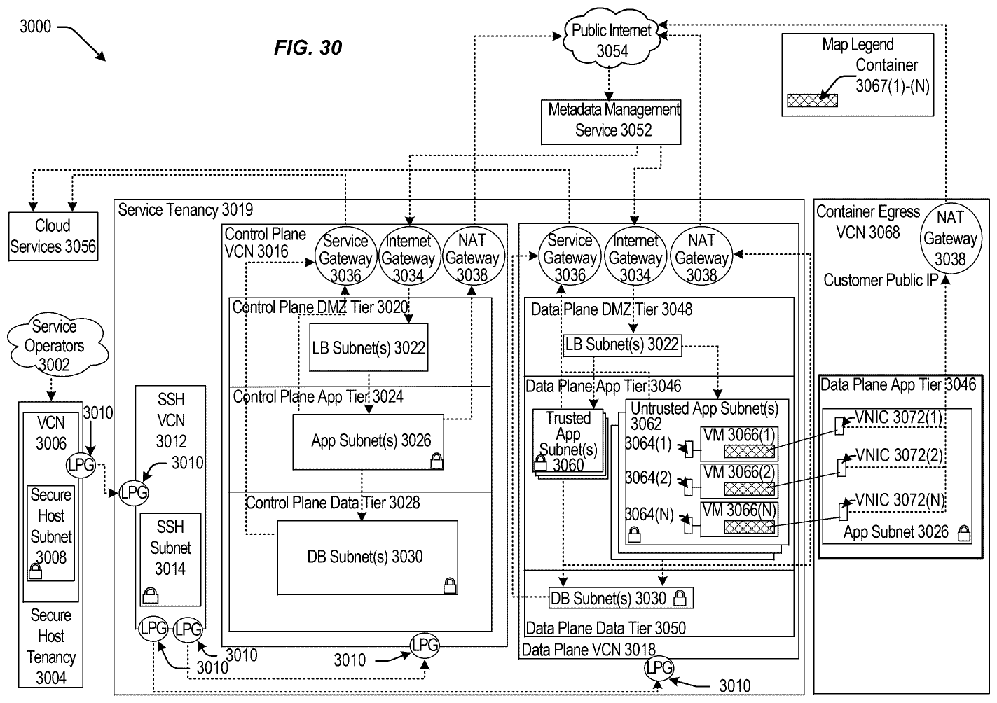

FIG. 30 is a block diagram 3000 illustrating another example pattern of an IaaS architecture, according to at least one embodiment. Service operators 3002 (e.g., service operators 2702 of FIG. 27) can be communicatively coupled to a secure host tenancy 3004 (e.g., the secure host tenancy 2704 of FIG. 27) that can include a virtual cloud network (VCN) 3006 (e.g., the VCN 2706 of FIG. 27) and a secure host subnet 3008 (e.g., the secure host subnet 2708 of FIG. 27). The VCN 3006 can include an LPG 3010 (e.g., the LPG 2710 of FIG. 27) that can be communicatively coupled to an SSH VCN 3012 (e.g., the SSH VCN 2712 of FIG. 27) via an LPG 3010 contained in the SSH VCN 3012. The SSH VCN 3012 can include an SSH subnet 3014 (e.g., the SSH subnet 2714 of FIG. 27), and the SSH VCN 3012 can be communicatively coupled to a control plane VCN 3016 (e.g., the control plane VCN 2716 of FIG. 27) via an LPG 3010 contained in the control plane VCN 3016 and to a data plane VCN 3018 (e.g., the data plane 2718 of FIG. 27) via an LPG 3010 contained in the data plane VCN 3018. The control plane VCN 3016 and the data plane VCN 3018 can be contained in a service tenancy 3019 (e.g., the service tenancy 2719 of FIG. 27).

The control plane VCN 3016 can include a control plane DMZ tier 3020 (e.g., the control plane DMZ tier 2720 of FIG. 27) that can include LB subnet(s) 3022 (e.g., LB subnet(s) 2722 of FIG. 27), a control plane app tier 3024 (e.g., the control plane app tier 2724 of FIG. 27) that can include app subnet(s) 3026 (e.g., app subnet(s) 2726 of FIG. 27), a control plane data tier 3028 (e.g., the control plane data tier 2728 of FIG. 27) that can include DB subnet(s) 3030 (e.g., DB subnet(s) 2930 of FIG. 29). The LB subnet(s) 3022 contained in the control plane DMZ tier 3020 can be communicatively coupled to the app subnet(s) 3026 contained in the control plane app tier 3024 and to an Internet gateway 3034 (e.g., the Internet gateway 2734 of FIG. 27) that can be contained in the control plane VCN 3016, and the app subnet(s) 3026 can be communicatively coupled to the DB subnet(s) 3030 contained in the control plane data tier 3028 and to a service gateway 3036 (e.g., the service gateway of FIG. 27) and a network address translation (NAT) gateway 3038 (e.g., the NAT gateway 2738 of FIG. 27). The control plane VCN 3016 can include the service gateway 3036 and the NAT gateway 3038.

The data plane VCN 3018 can include a data plane app tier 3046 (e.g., the data plane app tier 2746 of FIG. 27), a data plane DMZ tier 3048 (e.g., the data plane DMZ tier 2748 of FIG. 27), and a data plane data tier 3050 (e.g., the data plane data tier 2750 of FIG. 27). The data plane DMZ tier 3048 can include LB subnet(s) 3022 that can be communicatively coupled to trusted app subnet(s) 3060 (e.g., trusted app subnet(s) 2960 of FIG. 29) and untrusted app subnet(s) 3062 (e.g., untrusted app subnet(s) 2962 of FIG. 29) of the data plane app tier 3046 and the Internet gateway 3034 contained in the data plane VCN 3018. The trusted app subnet(s) 3060 can be communicatively coupled to the service gateway 3036 contained in the data plane VCN 3018, the NAT gateway 3038 contained in the data plane VCN 3018, and DB subnet(s) 3030 contained in the data plane data tier 3050. The untrusted app subnet(s) 3062 can be communicatively coupled to the service gateway 3036 contained in the data plane VCN 3018 and DB subnet(s) 3030 contained in the data plane data tier 3050. The data plane data tier 3050 can include DB subnet(s) 3030 that can be communicatively coupled to the service gateway 3036 contained in the data plane VCN 3018.

The untrusted app subnet(s) 3062 can include primary VNICs 3064(1)-(N) that can be communicatively coupled to tenant virtual machines (VMs) 3066(1)-(N) residing within the untrusted app subnet(s) 3062. Each tenant VM 3066(1)-(N) can run code in a respective container 3067(1)-(N), and be communicatively coupled to an app subnet 3026 that can be contained in a data plane app tier 3046 that can be contained in a container egress VCN 3068. Respective secondary VNICs 3072(1)-(N) can facilitate communication between the untrusted app subnet(s) 3062 contained in the data plane VCN 3018 and the app subnet contained in the container egress VCN 3068. The container egress VCN can include a NAT gateway 3038 that can be communicatively coupled to public Internet 3054 (e.g., public Internet 2754 of FIG. 27).

The Internet gateway 3034 contained in the control plane VCN 3016 and contained in the data plane VCN 3018 can be communicatively coupled to a metadata management service 3052 (e.g., the metadata management system 2752 of FIG. 27) that can be communicatively coupled to public Internet 3054. Public Internet 3054 can be communicatively coupled to the NAT gateway 3038 contained in the control plane VCN 3016 and contained in the data plane VCN 3018. The service gateway 3036 contained in the control plane VCN 3016 and contained in the data plane VCN 3018 can be communicatively coupled to cloud services 3056.

In some examples, the pattern illustrated by the architecture of block diagram 3000 of FIG. 30 may be considered an exception to the pattern illustrated by the architecture of block diagram 2900 of FIG. 29 and may be desirable for a customer of the IaaS provider if the IaaS provider cannot directly communicate with the customer (e.g., a disconnected region). The respective containers 3067(1)-(N) that are contained in the VMs 3066(1)-(N) for each customer can be accessed in real-time by the customer. The containers 3067(1)-(N) may be configured to make calls to respective secondary VNICs 3072(1)-(N) contained in app subnet(s) 3026 of the data plane app tier 3046 that can be contained in the container egress VCN 3068. The secondary VNICs 3072(1)-(N) can transmit the calls to the NAT gateway 3038 that may transmit the calls to public Internet 3054. In this example, the containers 3067(1)-(N) that can be accessed in real-time by the customer can be isolated from the control plane VCN 3016 and can be isolated from other entities contained in the data plane VCN 3018. The containers 3067(1)-(N) may also be isolated from resources from other customers.

In other examples, the customer can use the containers 3067(1)-(N) to call cloud services 3056. In this example, the customer may run code in the containers 3067(1)-(N) that requests a service from cloud services 3056. The containers 3067(1)-(N) can transmit this request to the secondary VNICs 3072(1)-(N) that can transmit the request to the NAT gateway that can transmit the request to public Internet 3054. Public Internet 3054 can transmit the request to LB subnet(s) 3022 contained in the control plane VCN 3016 via the Internet gateway 3034. In response to determining the request is valid, the LB subnet(s) can transmit the request to app subnet(s) 3026 that can transmit the request to cloud services 3056 via the service gateway 3036.

It should be appreciated that IaaS architectures 2700, 2800, 2900, 3000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

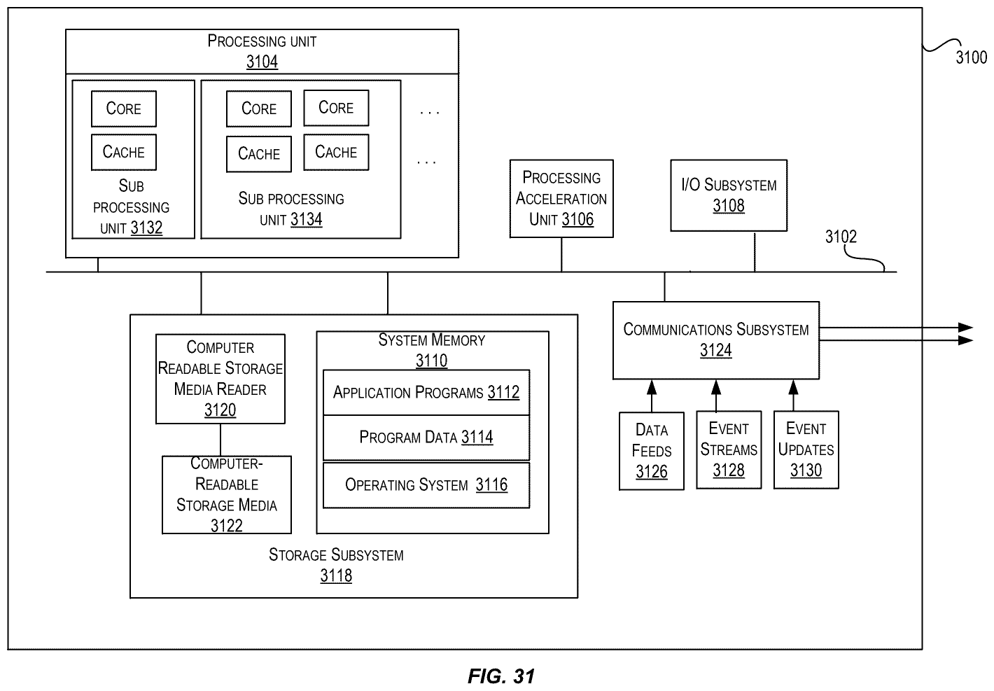

FIG. 31 illustrates an example computer system 3100, in which various embodiments may be implemented. The system 3100 may be used to implement any of the computer systems described above. As shown in the figure, computer system 3100 includes a processing unit 3104 that communicates with a number of peripheral subsystems via a bus subsystem 3102. These peripheral subsystems may include a processing acceleration unit 3106, an I/O subsystem 3108, a storage subsystem 3118 and a communications subsystem 3124. Storage subsystem 3118 includes tangible computer-readable storage media 3122 and a system memory 3110.

Bus subsystem 3102 provides a mechanism for letting the various components and subsystems of computer system 3100 communicate with each other as intended. Although bus subsystem 3102 is shown schematically as a single bus, alternative embodiments of the bus subsystem may utilize multiple buses. Bus subsystem 3102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 3104, which can be implemented as one or more integrated circuits (e.g., a conventional microprocessor or microcontroller), controls the operation of computer system 3100. One or more processors may be included in processing unit 3104. These processors may include single core or multicore processors. In certain embodiments, processing unit 3104 may be implemented as one or more independent processing units 3132 and/or 3134 with single or multicore processors included in each processing unit. In other embodiments, processing unit 3104 may also be implemented as a quad-core processing unit formed by integrating two dual-core processors into a single chip.

In various embodiments, processing unit 3104 can execute a variety of programs in response to program code and can maintain multiple concurrently executing programs or processes. At any given time, some or all of the program code to be executed can be resident in processor(s) 3104 and/or in storage subsystem 3118. Through suitable programming, processor(s) 3104 can provide various functionalities described above. Computer system 3100 may additionally include a processing acceleration unit 3106, which can include a digital signal processor (DSP), a special-purpose processor, and/or the like.

I/O subsystem 3108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google GlassR blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MID1 keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 3100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 3100 may comprise a storage subsystem 3118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 3104 provide the functionality described above. Storage subsystem 3118 may also provide a repository for storing data used in accordance with the present disclosure.

As depicted in the example in FIG. 31, storage subsystem 3118 can include various components including a system memory 3110, computer-readable storage media 3122, and a computer readable storage media reader 3120. System memory 3110 may store program instructions that are loadable and executable by processing unit 3104. System memory 3110 may also store data that is used during the execution of the instructions and/or data that is generated during the execution of the program instructions. Various different kinds of programs may be loaded into system memory 3110 including but not limited to client applications, Web browsers, mid-tier applications, relational database management systems (RDBMS), virtual machines, containers, etc.

System memory 3110 may also store an operating system 3116. Examples of operating system 3116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS. Windows® Phone, Android® OS, BlackBerry® OS, and Palm® OS operating systems. In certain implementations where computer system 3100 executes one or more virtual machines, the virtual machines along with their guest operating systems (GOSs) may be loaded into system memory 3110 and executed by one or more processors or cores of processing unit 3104.

System memory 3110 can come in different configurations depending upon the type of computer system 3100. For example, system memory 3110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 3110 may include a basic input/output system (BIOS) containing basic routines that help to transfer information between elements within computer system 3100, such as during start-up.

Computer-readable storage media 3122 may represent remote, local, fixed, and/or removable storage devices plus storage media for temporarily and/or more permanently containing, storing, computer-readable information for use by computer system 3100 including instructions executable by processing unit 3104 of computer system 3100.

Computer-readable storage media 3122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 3122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 3122 may include, but is not limited to, Zip® drives, flash memory cards, universal serial bus (USB) flash drives, secure digital (SD) cards, DVD disks, digital video tape, and the like. Computer-readable storage media 3122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 3100.

Machine-readable instructions executable by one or more processors or cores of processing unit 3104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 3124 provides an interface to other computer systems and networks. Communications subsystem 3124 serves as an interface for receiving data from and transmitting data to other systems from computer system 3100. For example, communications subsystem 3124 may enable computer system 3100 to connect to one or more devices via the Internet. In some embodiments communications subsystem 3124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 3124 can provide wired network connectivity (e.g., Ethernet) in addition to or instead of a wireless interface.

In some embodiments, communications subsystem 3124 may also receive input communication in the form of structured and/or unstructured data feeds 3126, event streams 3128, event updates 3130, and the like on behalf of one or more users who may use computer system 3100.

By way of example, communications subsystem 3124 may be configured to receive data feeds 3126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 3124 may also be configured to receive data in the form of continuous data streams, which may include event streams 3128 of real-time events and/or event updates 3130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 3124 may also be configured to output the structured and/or unstructured data feeds 3126, event streams 3128, event updates 3130, and the like to one or more databases that may be in communication with one or more streaming data source computers coupled to computer system 3100.

Computer system 3100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 3100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising.” “having.” “including.” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z.” unless specifically stated otherwise, is intended to be understood within the context as used in general to present that an item, term, etc., may be either X. Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method to use a zero-trust packet routing policy architecture to perform zero trust packet routing operations in one or more networks, the method comprising:
aggregating log data associated with a flow of traffic within one or more networks;
accessing rules associated with a policy that specifies how the flow of traffic is enforced between enforcement points within the one or more networks, wherein the policy includes one or more layer 4 rules and one or more layer 7 rules;
determining, based on the rules associated with the policy, an enforcement of flow of traffic;
generating a visualization of an enforcement of the flow of traffic between different enforcement points; and
presenting the visualization for display within a user interface.

2. The method of claim 1, further comprising ingesting the log data from different sources, wherein the different sources include an identity dataplane source, a networking data source, and a Kubernetes source.

3. The method of claim 1, wherein the log data includes log data generated by first enforcement points that enforce layer 4 rules and second enforcement points that enforce layer 7 rules.

4. The method of claim 3, wherein aggregating the log data comprises separating the log data into first log data that is obtained from the first enforcement points and into second log data that is obtained from the second enforcement points.

5. The method of claim 1, wherein generating the visualization comprises including a user interface element within a graphical user interface that indicates a violation of the policy.

6. The method of claim 5, wherein generating the visualization comprises including user interface elements within the graphical user interface that indicate tagged resources and untagged resources.

7. The method of claim 1, wherein generating the visualization comprises including a first user interface (UI) element that represents one or more resources associated with a first tag and a second UI element that represents one or more resources associated with a second tag.

8. The method of claim 1, further comprising accessing second rules associated with a second policy that specifies how traffic flows between at least a portion of the enforcement points.

9. A system, comprising:
one or more networks that include enforcement points;
a policy that specifies a policy that includes rules that specify how a flow of traffic is enforced between different enforcement points within the one or more networks, wherein the policy includes one or more layer 4 rules and one or more layer 7 rules and wherein the rules reference tags associated with resources of the one or more networks;
one or more processors; and
non-transitory computer-readable medium storing a set of instructions, the set of instructions when executed by the one or more processors cause processing to be performed comprising:
aggregating log data associated with a flow of traffic within one or more networks;
accessing rules associated with a policy that specifies how the flow of traffic is enforced between enforcement points within the one or more networks, wherein the policy includes one or more layer 4 rules and one or more layer 7 rules;
determining, based on the rules associated with the policy, an enforcement of flow of traffic;
generating a visualization of an enforcement of the flow of traffic between different enforcement points; and
presenting the visualization for display within a user interface.

10. The system of claim 9, wherein the processing to be performed further comprises ingesting the log data from different sources, wherein the different sources include an identity dataplane source, a networking data source, and a Kubernetes source.

11. The system of claim 9, wherein the log data includes log data generated by first enforcement points that enforce layer 4 rules and second enforcement points that enforce layer 7 rules.

12. The system of claim 11, wherein aggregating the log data comprises separating the log data into first log data that is obtained from the first enforcement points and into second log data that is obtained from the second enforcement points.

13. The system of claim 9, wherein generating the visualization comprises including a user interface element within a graphical user interface that indicates a violation of the policy.

14. The system of claim 13, wherein generating the visualization comprises including user interface elements within the graphical user interface that indicate tagged resources and untagged resources.

15. The system of claim 9, wherein generating the visualization comprises including a first user interface (UI) element that represents one or more resources associated with a first tag and a second UI element that represents one or more resources associated with a second tag.

16. The system of claim 9, wherein the processing to be performed further comprises accessing second rules associated with a second policy that specifies how traffic flows between at least a portion of the enforcement points.

17. A computer-readable medium comprising instructions that when executed, cause one or more processors to perform operations including:
aggregating log data associated with a flow of traffic within one or more networks;
accessing rules associated with a policy that specifies how the flow of traffic is enforced between enforcement points within the one or more networks, wherein the policy includes one or more layer 4 rules and one or more layer 7 rules;
determining, based on the rules associated with the policy, an enforcement of flow of traffic;
generating a visualization of an enforcement of the flow of traffic between different enforcement points; and
presenting the visualization for display within a user interface.

18. The computer-readable medium of claim 17, wherein the instructions that when executed, cause the one or more processors to perform further operations comprising ingesting the log data from different sources, wherein the different sources include an identity dataplane source, a networking data source, and a Kubernetes source.

19. The computer-readable medium of claim 17, wherein the log data includes log data generated by first enforcement points that enforce layer 4 rules and second enforcement points that enforce layer 7 rules.

20. The computer-readable medium of claim 17, wherein generating the visualization comprises including a user interface element within a graphical user interface that indicates a violation of the policy.
